(19) United States
(12) Patent Application Publication
(10) Pub. No.: US 2007/0219292 A1
(43) Pub. Date: Sep. 20, 2007

(54) INK SET FOR INK-JET RECORDING, POLYMERIZATION METHOD AND IMAGE FORMING METHOD

(75) Inventors: Kimihiko Ookubo, Tokyo (JP); Norio Miura, Kanagawa (JP); Takeshi Kurata, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/575,970

(22) PCT Filed: Sep. 21, 2005
(86) PCT No.: PCT/JP05/17336

§ 371 Date: Mar. 24, 2007

(30) Foreign Application Priority Data
Oct. 1, 2004 (JP) 2004-289858

(51) Int. Cl. C09D 11/00

(52) U.S. Cl. 523/160; 523/161

(57) ABSTRACT

An ink set for ink-jet recording comprising a yellow ink composition for ink-jet recording containing one or more types of yellow color materials, a magenta ink composition for ink-jet recording containing one or more types of magenta color materials, and a cyan ink composition for ink-jet recording conditioning one or more types of cyan color materials, wherein each ink composition contains one or more of a) a compound having one or more polymerizable groups, b) an infrared absorbing agent, and c) a polymerization initiator, and further, the infrared absorbing agent contained in the yellow ink composition for ink-jet recording differs from the infrared absorbing agent contained in the cyan ink composition for ink-jet recording.

### FIELD OF THE INVENTION

The present invention relates to an ink set for ink-jet recording including a yellow ink composition, magenta ink composition and cyan ink composition, a polymerization method of the ink set for ink-jet recording to apply infrared rays and/or ultraviolet rays to each ink composition, and an image forming method.

### BACKGROUND OF THE INVENTION

The ultraviolet curing technique exhibiting excellent curability is continuously gaining importance in the field of coating agents of materials, as well as various fields of inks, paints and printing materials. Especially in the application of ultraviolet curing of ink, there has been a growing demand for further improvement in ink curability.

Various attempts to enhance curability by use of radiant heat are known. For example, when ultraviolet rays are applied to an acrylate composition containing a photo-polymerization initiator and a multifunctional (meth)acryloyl group, this step is then followed by heating (please refer to Patent Document 1). In another method, light is applied to a paint composition used in conjunction with thermally curable resin and photo-polymerizable composition and this composition, thereby promoting thermal curing (Patent Document 2). In these methods, not only the paint composition but also the substrate are heated simultaneously, and the substrate is after coated for automotive steel plates. In this case, the substrate that can be used is restricted only to steel plates.

To improve the curability of the UV curable composition, a powerful ultraviolet light source is used. Unfortunately, heat is generated by this ultraviolet light source, which may adversely affects the substrate. When using a flexible synthetic resin substrate, the substrate may suffer thermal deformation. Even if the usual ultraviolet irradiation device is provided with some means to remove heat emitted from the light source, more heat will be generated by any increase in the amount of ultraviolet rays being applied. This may results in a problem of thermal deformation in this conventional art.

Recent ink-jet recording methods provide simple and economical image formation, and have been used in a great variety of the fields of printing, including photography, various forms of printing, marking, and special printing of color filters. Excellent image quality comparable to that of the silver halide photography has been ensured particularly by a recording apparatus where minute dots are emitted and controlled, an ink characterized by improvements in color reproduction area, image durability and emission suitability, and exclusive paper characterized by marked improvements in ink absorbance, color development of the color material and surface luster. Improvement of image quality in recent ink-jet recording systems can be achieved only when the recording apparatus, ink, exclusive paper have all achieved a certain technological level.

However, the ink-jet system requiring exclusive paper results in a problem in that a restriction is imposed on the type of recording medium, which results in higher costs. To overcome this problem, attempts have been made to record on a transfer medium different from said exclusive paper using an ink-jet method. More specifically, the methods used in such attempts include a phase change ink-jet method using a wax ink, being a solid at room temperature, a solvent based ink-jet method using an ink made up mainly of a fast-drying organic solvent, and a UV ink-jet method where crosslinking is provided by ultraviolet rays (UV) following recording.

Among these, the UV ink-jet method is capturing the spotlight in appropriate industries, because it emits a less offensive odor compared to the solvent based ink-jet method, and is characterized by rapid curability and the capability of recording on a recording medium of low ink absorbance (please refer to Patent Documents 3 and 4).

Known UV inks are mainly a radical polymerization type ink or a cation polymerization type ink.

In the ultraviolet ray curable ink-jet recording method, image quality, namely, the diameter of deposited ink droplets, depends on such factors as irradiation timing subsequent to ink particles contacting the recording medium, intensity of irradiation, energy, ink droplet size, ink sensitivity, surface energy, viscosity, wettability of the substrate, order of ink contacting the recording medium, and error diffusion pattern. The factors exhibiting adverse impact to image quality are ink sensitivity, viscosity, surface tension, wettability of the substrate and exposure conditions. Of these, ink sensitivity essentially depends on the property of polymerization of the polymerizable monomer used as a solvent in the liquid ink. To improve the property of polymerization, a method of heating after irradiation, as in the above Patent Document 1, is known as a radical polymerization type ultraviolet ray curable ink, and the method of heating the ink having been deposited on the recording medium (Patent Document 5) is known as a cation polymerization type ultraviolet ray curable ink. However, the heating mechanism is not totally satisfactory, from the viewpoint of printer cost, and application to substrates vulnerable to heat. Another known device is a printer equipped with a flash drying mechanism (Patent Document 6). However, it employs only the difference of absorption between that of the substrate and of the liquid ink. This does not allow the liquid ink to reach the sufficiently high temperature. Further, the method of heating varies depending on the color tone of the liquid ink. This has raised the problem of causing variations in the temperatures reached by different colors of ink.

[Patent Document 1] Unexamined Japanese Patent Application Publication No. (hereinafter referred to as JP-A) 64-11169 (Examples 1-5)

[Patent Document 2] JP-A 2004-190015 (Examples 5-9)

[Patent Document 3] JP-A 6-200204 (Example)

[Patent Document 4] Japanese Translation of PCT International Application Publication No. 2000-504778) (Examples 1-5)

[Patent Document 5] JP-A 2002-137375 (Preferred Embodiment of the Invention)

[Patent Document 6] JP-A 2000-272101 (Claims)

### DISCLOSURE OF INVENTION

### Problems to be Solved by the Invention

The present invention was achieved in view of the above situations. An object of this invention is to provide an ink set for ink-jet recording which satisfies high levels of both color reproduction and ink curability, and exhibits a high degree of adhesion to a substrate, and high-definition image formation without bleeding, as well as a polymerization method, and an image forming method using this ink set for ink-jet recording.

### MEANS TO SOLVE THE PROBLEMS

Concentrated study efforts of the present invention by the inventors to achieve the stated object, found the following: In the ink set for ink-jet recording consisting of a yellow ink composition, magenta ink composition and cyan ink composition, each ink composition contains a compound having one or more polymerizable groups, an infrared absorbing agent and a polymerization initiator, and of the ink compositions, the yellow ink composition and the cyan ink composition contain different infrared absorbing agents. When using a polymerization method in which infrared rays are applied to this ink set for ink-jet recording, in which high level compatibility between color reproducibility and ink curability is ensured and excellent adhesion to the substrate, whereby high-definition images are provided. These findings have lead to the present invention.

The above object of the present invention is achievable by the following embodiments.

(1) An ink set for ink-jet recording including a yellow ink composition for ink-jet recording containing one or more types of yellow color materials, a magenta ink composition for ink-jet recording containing one or more types of magenta color materials, and a cyan ink composition for ink-jet recording containing one or more types of cyan color materials, wherein each ink composition contains one or more of the following a), b) and c), and further, the infrared absorbing agent contained in the yellow ink composition for ink-jet recording differs from the infrared absorbing agent contained in the cyan ink composition for ink-jet recording:

a) a compound having one or more polymerizable groups,

b) an infrared absorbing agent, and

c) a polymerization initiator.

(2) The ink set for ink-jet recording described in embodiment (1), wherein the aforementioned compound having one or more polymerizable groups exhibits cation-polymerizing capability.

(3) The ink set for ink-jet recording described in embodiment (1) or (2), wherein the above polymerization initiator is a polymerization initiator to generate active species by irradiation of active rays.

(4) The ink set for ink-jet recording described in any one of embodiments (1)-(3), wherein viscosity at 30° C. of each ink composition for ink-jet recording is within the range of 10-500 mPa·s.

(5) The ink set for ink-jet recording described in any one of embodiments (1)-(4), wherein the above infrared absorbing agent has the maximum absorption wavelength of 760-1,500 nm.

(6) The ink set for ink-jet recording described in any one of embodiments (1)-(5), wherein the infrared absorbing agent contained in the yellow ink composition for ink-jet recording is an infrared absorbing agent which has at most an absorbance of 0.15 in 630-690 nm assuming that an absorbance of this infrared absorbing agent at a maximum absorption wavelength in the ink is 1, and the infrared absorbing agent contained in the cyan ink composition for ink-jet recording is an infrared absorbing agent which has at most an absorbance of 0.15 in 410-460 nm assuming that an absorbance of this infrared absorbing agent at a maximum absorption wavelength in the ink is 1.

(7) An image forming method comprising the steps of:

(a) ejecting the ink compositions for ink-jet recording of the ink set for ink-jet recording described in any one of embodiments (1)-(6) on a recording medium using a recording head having one or more nozzles, each capable of controlling ejection of the ink droplets on a selective basis, and (b) curing the deposited ink by irradiation of infrared and ultraviolet rays after the ink droplets landed on the recording medium.

(8) The image forming method described in embodiment (7), wherein the inks are cured by simultaneous irradiation of infrared and ultraviolet rays.

### PREFERRED EMBODIMENT OF THE INVENTION

The present invention will be described in detail as below. The number of polymerizable groups in the compound having one or more polymerizable groups (hereinafter also referred to as “polymerizable compound of the present invention”) of the present invention is preferably 1-6, more preferably 1-4, and still more preferably 1 or 2. The compound having one or more polymerizable groups may be a polymerizable monomer, a polymerizable oligomer formed by polymerization of a plurality of polymerizable monomers, or a polymerizable pre-polymer of high molecular weight. Specifically, the polymerizable compound has a radical polymerizable group or a cation polymerizable group.

(Radical Polymerizable Compound)

As a radical polymerizable compound, specifically listed are an aliphatic (metha)acrylate, an alicyclic (meth)acrylate, an aromatic (meth)acrylate, an ether based (meth)acrylate, a vinyl based monomer and a (meth)acryl amide. It should be noted that a (meth)acrylate is a compound containing at least one acrylate or methacrylate.

The examples of the compound containing the radical polymerizable ethylenic unsaturated bond include an unsaturated carboxylic acid such as acrylic acid, methacrylic acid, itaconic acid, crotonic acid, isocrotonic acid or maleic acid, and its salt; and a radical polymerizable compound such as, ester, urethane, amide, anhydride, acrylonitrile, styrene, various types of unsaturated polyesters, unsaturated polyether, unsaturated polyamide and unsaturated urethane. Specifically, listed are acrylic acid derivatives such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxy polyethoxyphenyl) propane, neopentyl glycol diacrylate, 1,6-hexan diol diacrylate, ethylene glycol diacrylate, diethylene glycol diacrylate, tri ethylene glycol diacrylate, tetra ethylene glycol diacrylate, polyethylene glycol diacrylate, polypropylene glycol diacrylate, pentaerithritol triacrylate, pentaerithritol tetra acrylate, dipentaerithritol tetra acrylate, trimethylolpropane triacrylate, tetramethylol methane tetra acrylate, oligo ester acrylate, N-methylolacryl amide, diacetone acryl amide, and epoxy acrylate; methacrylic acid derivatives such as methylmethacrylate, n-butyl methacrylate, 2-ethylhexylmethacrylate, lauryl methacrylate, alylmethacrylate, glycidyl methacrylate, benzyl methacrylate, dimethyl aminomethylmethacrylate, 1,6-hexan diol dimethacrylate, ethylene glycol dimethacrylate, tri ethylene glycol dimethacrylate, polyethylene glycol dimethacrylate, polypropylene glycol dimethacrylate, trimethylol ethane trimethacrylate, trimethylolpropane trimethacrylate, and 2,2-bis(4-methacryloxy polyethoxyphenyl) propane; in addition to derivatives of alyl compound such as alylglycidyl ether, dialylphthalate and trialyl trimellitate. Further, it is possible to use commercially available or industrially known radical polymerizable or cross-linking monomers, oligomers and polymers, which are described in the “Handbook of Cross-linking Agent” edited by S. Yamashita (Taiseisha, 1981); “Handbook of WV/EB Curing (Raw Material Edition)” edited by K. Kato (High Polymer Publishing Co., Ltd., 1985); “Application and Market for UV/EB Curing Technology” edited by Rad Tech Japan, pg. 79 (C. M. C., 1989); and “Handbook of Polyester Resin” by E. Takiyama (Nikkan Kogyo Shimbun Ltd. 1988).

(Cation Polymerizable Compound)

Examples of cation polymerizable compounds include an oxirane ring-containing compound (also known as an epoxy compound), an oxetane ring-containing compound, a vinyl ether group-containing compound, a propenyl ether group-containing compound, a thiirane group-containing compound, a thiethane group-containing compound, a styrene compound, a vinyl naphthalene compound and an N-vinyl compound. Preferably used compounds are an oxirane ring-containing compound, an oxytane ring-containing compound, a vinyl ether group-containing compound (also called a vinyl ether compound), and a propenyl ether group-containing compound. More preferably used compounds are the oxirane ring-containing compound, the oxytane ring-containing compound, and the vinyl ether group-containing compound.

The oxirane ring-containing compound is exemplified by a compound having one or more oxirane rings in its molecule. The compound normally used as an epoxy resin can be used in the form of any one of a monomer, oligomer or polymer. Specifically, conventionally known aromatic epoxide, alicyclic epoxide and aliphatic epoxide may be cited. In the following description, “epoxide” means a monomer or its oligomer. One or more of these compounds may be used, as appropriate.

(Aromatic Epoxide)

Examples of preferably used aromatic epoxide include di- or poly-glycidyl ether produced by the reaction between a polyvalent phenol having one or more aromatic nuclei or its alkylene oxide adduct, and epichlorohydrin. It is exemplified by the di- or poly-glycidyl ether of bisphenol A or its alkylene oxide adduct, di- or poly-glycidyl ether of hydrogenated bisphenol A or its alkylene oxide adduct, and novolak type epoxy resin. In this case, ethylene oxide and propylene oxide may be cited as the alkylene oxide.

(Alicyclic Epoxide)

The alicyclic epoxide is preferably a cyclohexene oxide or cyclopentene oxide-containing compound obtained by epoxidation of the compound containing a cycloalkane ring such as one or more cyclohexene or cyclopentene rings by an appropriate oxidizing agent such as hydrogen petroxide or peroxy acid.

(Aliphatic Epoxide)

The preferably used aliphatic epoxide is di- or poly-glycidyl ether of aliphatic polyvalent alcohol or its alkylene oxide adduct. Typical examples include diglycidyl ether of alkylene glycol such as diglycidyl ether of ethylene glycol, diglycidyl ether of propylene glycol, or diglycidyl ether of 1,6-hexan diol; polyglycidyl ether of polyvalent alcohol such as di- or tri-glycidyl ether of glycerine or its alkylene oxide adduct; diglycidyl ether of polyalkylene glycol such as diglycidyl ether of polyethylene glycol or its alkylene oxide adduct, and diglycidyl ether of polypropylene glycol or its alkylene oxide adduct. Here, the alkylene oxide is exemplified by ethylene oxide and propylene oxide, epoxidation aliphatic acid ester or epoxidation aliphatic acid glyceride (used without restriction if the epoxy group is introduced into the aliphatic acid ester, and aliphatic acid glyceride. Epoxidized aliphatic acid ester, which is, for example, produced by epoxidation of the oleic acid ester, is exemplified by epoxy methyl stearate, epoxy butylstearate and epoxy octyl stearate. The epoxidized aliphatic acid glyceride is exemplified by epoxidized oils and fats obtained by epoxidation of the oils and fats including unsaturated aliphatic acid. For example, those manufactured by epoxidation of soy bean oil, linseed oil or castor oil are exemplified by epoxidized soy bean oil, epoxidized linseed oil, epoxidized castor oil, and epoxidized safflower oil).

Of these epoxides, the aromatic epoxide and alicyclic epoxide are preferred, when consideration is given to rapid curability. The alicyclic epoxide is particularly preferred. In this invention, one of the cited epoxides may be used independently, however two or more epoxides may be used in combination.

The specifically preferred alicyclic epoxy compounds are those expressed by following General Formulas (A), and (1)-(6).

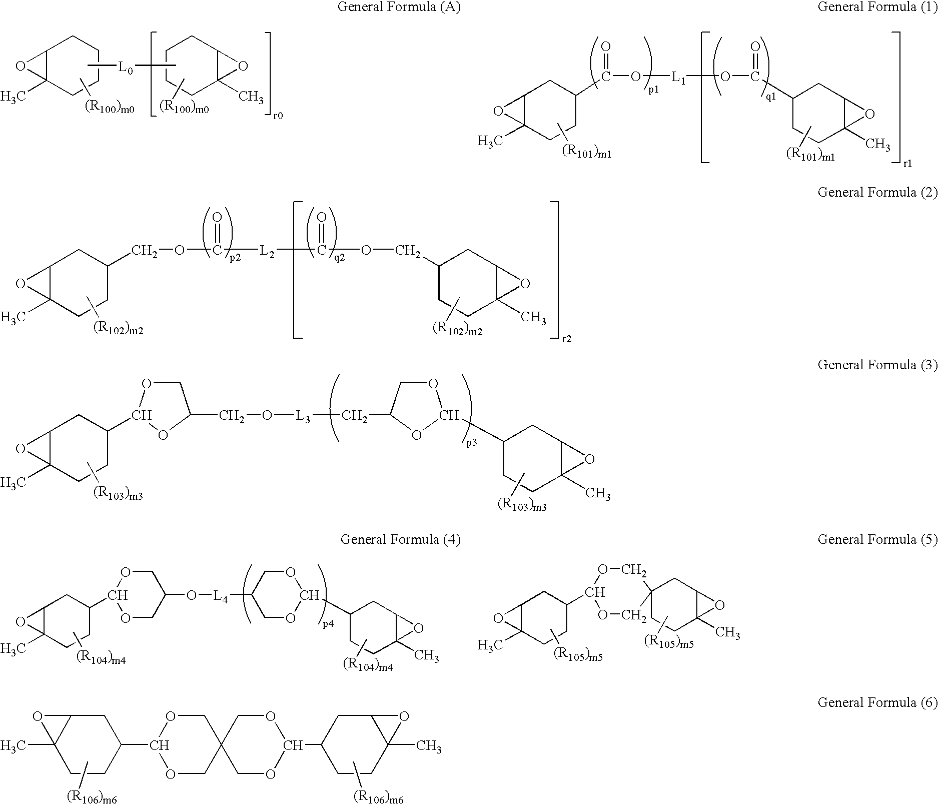

In cited General Formulas (A) and (1)-(6), R₁₀₀, R₁₀₁, R₁₀₂, R₁₀₃, R₁₀₄, R₁₀₅ and R₁₀₆ represent substituents. These substituents may, for example, be a halogen atom (chlorine, bromine, and fluorine), an alkyl group having 1-6 carbon atoms (such as a methyl, ethyl, propyl, i-propyl, and butyl group), an alkoxy group having 1-6 carbon atoms (such as a methoxy, ethoxy, propoxy, i-propoxy, butoxy, and t-butoxy group), an acyl group (such as an acetyl, propionyl, and trifluoroacetyl group), an acyloxy group (such as an acetoxy, propionyloxy, and trifluoroacetoxy group), and an alkoxy carbonyl group (such as a methoxycarbonyl, ethoxycarbonyl, and t-butoxycarbonyl group). The preferred substituents described above are an alkyl group, an alkoxy group or an alkoxy carbonyl group. m0, m1, m2, m3, m4 and m6 are each an integer of 0-2, of which 0 or 1 is preferred, while m5 is 1 or 2.

In cited General Formula (A), L₀ is a bonding group or a single bond having a valency of (r0+1) and containing 1-15 carbon atoms wherein an oxygen atom or a sulfur atom may be contained in the principal chain. In General Formula (1), L₁ is a bonding group or a single bond having a valency of (r1+1) and containing 1-15 carbon atoms wherein an oxygen atom or a sulfur atom may be contained in the principal chain. In General Formula (2), L₂ is a bonding group or a single bond having a valency of (r2+1) and containing 1-15 carbon atoms wherein an oxygen atom or a sulfur atom may be contained in the principal chain. In General Formula (3) and General Formula (4), L₃ and L₄ are each a divalent bonding group or a single bond containing 8 carbon atoms wherein an oxygen atom or a sulfur atom may be contained in the principal chain.

Examples of the divalent bonding group wherein an oxygen atom or a sulfur atom may be contained in the cited principal chain include the following groups and the groups formed by combining these groups with an —O— group, an —S— group, a —CO— group and a —CS— group, and a plurality of these groups in combinations:

A methylene group [—CH₂—], an ethylidene group [>CHCH₃], an isopropylidene group [>C(CH₃)₂], a 1,2-ethylene group [—CH₂CH₂—], a 1,2-propylene group [—CH(CH₃)CH₂—], a 1,3-propanediyl group [—CH₂CH₂CH₂—], a 2,2-dimethyl-1,3-propanediyl group [—CH₂C(CH₃)₂CH₂—], a 2,2-dimethoxy-1,3-propanediyl group [—CH₂C(OCH₃)₂CH₂—], a 2,2-dimethoxymethyl-1, 3-propanediyl group [—CH₂C(CH₂OCH₃)₂CH₂—], a 1-methyl-1,3-propanediyl group [—CH(CH₃)CH₂CH₂—], a 1,4-butanediyl group [—CH₂CH₂CH₂CH₂—], a 1,5-pentanediyl group [—CH₂CH₂CH₂CH₂CH₂—] an oxydiethylene group [—CH₂CH₂OCH₂CH₂—], a thiodiethylene group [—CH₂CH₂SCH₂CH₂—], a 3-oxothiodiethylene group [—CH₂CH₂SOCH₂CH₂—], a dioxothiodiethylene group [—CH₂CH₂SO₂CH₂CH₂—], a 1,4-dimethyl-3-oxa-1, a 5-pentanediyl group [—CH(CH₃) CH₂OCH(CH₃) CH₂—], a 3-oxopentane diyl group [—CH₂CH₂COCH₂CH₂—], a 1,5-dioxo-3-oxapentane diyl group [—COCH₂OCH₂CO—], a 4-oxa-1,7-heptanediyl group [—CH₂CH₂CH₂OCH₂CH₂CH₂—], a 3,6-dioxa-1,8-octanediyl group [—CH₂CH₂OCH₂CH₂OCH₂CH₂—], a 1,4,7-trimethyl-3,6-dioxa-1,8-octanediyl group [—CH(CH₃) CH₂OCH(CH₃) CH₂OCH(CH₃) CH₂—], a 5,5-dimethyl-3,7-dioxa-1,9-nonanediyl group [—CH₂CH₂OCH₂C(CH₃)₂CH₂OCH₂CH₂—], a 5,5-dimethoxy-3,7-dioxa-1,9 nonanediyl group [—H₂CH₂OCH₂C(OCH₃)₂CH₂OCH₂CH₂—], a 5,5-dimethoxymethyl-3,7-dioxa-1,9-nonanediyl group [—CH₂CH₂OCH₂C(CH₂OCH₃)₂CH₂OCH₂CH₂—], a 4,7-dioxo-3,8-dioxa-1,10-decanediyl group [—CH₂CH₂O—COCH₂CH₂CO—OCH₂CH₂—], a 3,8-dioxo-4,7-dioxa-1,10-decanediyl group [—CH₂CH₂CO—OCH₂CH₂O—COCH₂CH₂—], a 1,3-cyclopentanediyl group [-1,3-C₅H₈—], a 1,2-cyclohexandiyl group [-1,2-C₆H₁₀—], a 1,3-cyclohexandiyl group [-1,3-C₆H₁₀—], a 1,4-cyclohexandiyl group [-1,4-C₆H₁₀—], a 2,5-tetrahydrofurandiyl group [2,5-C₄H₆O—], a p-phenylene group [-p-C₆H₄—], a m-phenylene group [-m-C₆H₄—], an α,α′-o-xylylene group [-o—CH₂—C₆H₄—CH₂—], an α,α′-m-xylylene group [-m—CH₂—C₆H₄—CH₂—], an α,α′-p-xylylene group [-p—CH₂—C₆H₄—CH₂—], a furan-2,5-diyl-bismethylene group [2,5-CH₂—C₄H₂O—CH₂—], a thiophene-2,5-diyl-bismethylene group [2,5-CH₂—C₄H₂S—CH₂—], an isopropylidene bis-p-phenylene group [-p-C₆H₄—C(CH₃)₂-p-C₆H₄—],

Examples of trivalent or higher-valency bonding group include a group formed by removing a required number of hydrogen atoms of a desired site from the aforementioned divalent bonding group, and the groups formed by combining these groups with an —O— group, an —S— group, a —CO— group, a —CS— group in the plural.

L₀, L₁, L₂, L₃ and L₄ may have substituents. Examples of these substituents include a halogen atom (chlorine, bromine, and fluorine), an alkyl group having 1-6 carbon atoms (a methyl, ethyl, propyl, i-propyl, and butyl group), an alkoxy group having 1-6 carbon atoms (a methoxy, ethoxy, propoxy group, i-propoxy, butoxy, and t-butoxy group), an acyl group (an acetyl, propionyl, and trifluoroacetyl group), an acyloxy group (an acetoxy, propionyloxy, and trifluoroacetoxy group), and an alkoxy carbonyl group (a methoxycarbonyl, ethoxycarbonyl, and t-butoxycarbonyl group). The preferably used substituent is an alkyl group, an alkoxy group or an alkoxy carbonyl group.

L₀, L₁ and L₂ are preferably the divalent bonding groups having 1-8 carbon atoms wherein the oxygen atom or sulfur atom can be contained in the principal chain. Alternatively, L₀, L₁, L₂, L₃ and L₄ are preferably the divalent bonding groups having 1-5 carbon atoms wherein each principal chain is consisted of carbon alone.

p1 and q1 are each 0 or 1, and p1+q1 is preferably 1 or more. p2 and q2 are each 0 or 1, and each is preferably 1. p3 and p4 are each 0 or 1.

The following shows specific examples of the preferred alicyclic epoxy compound, but the present invention is not limited thereto.

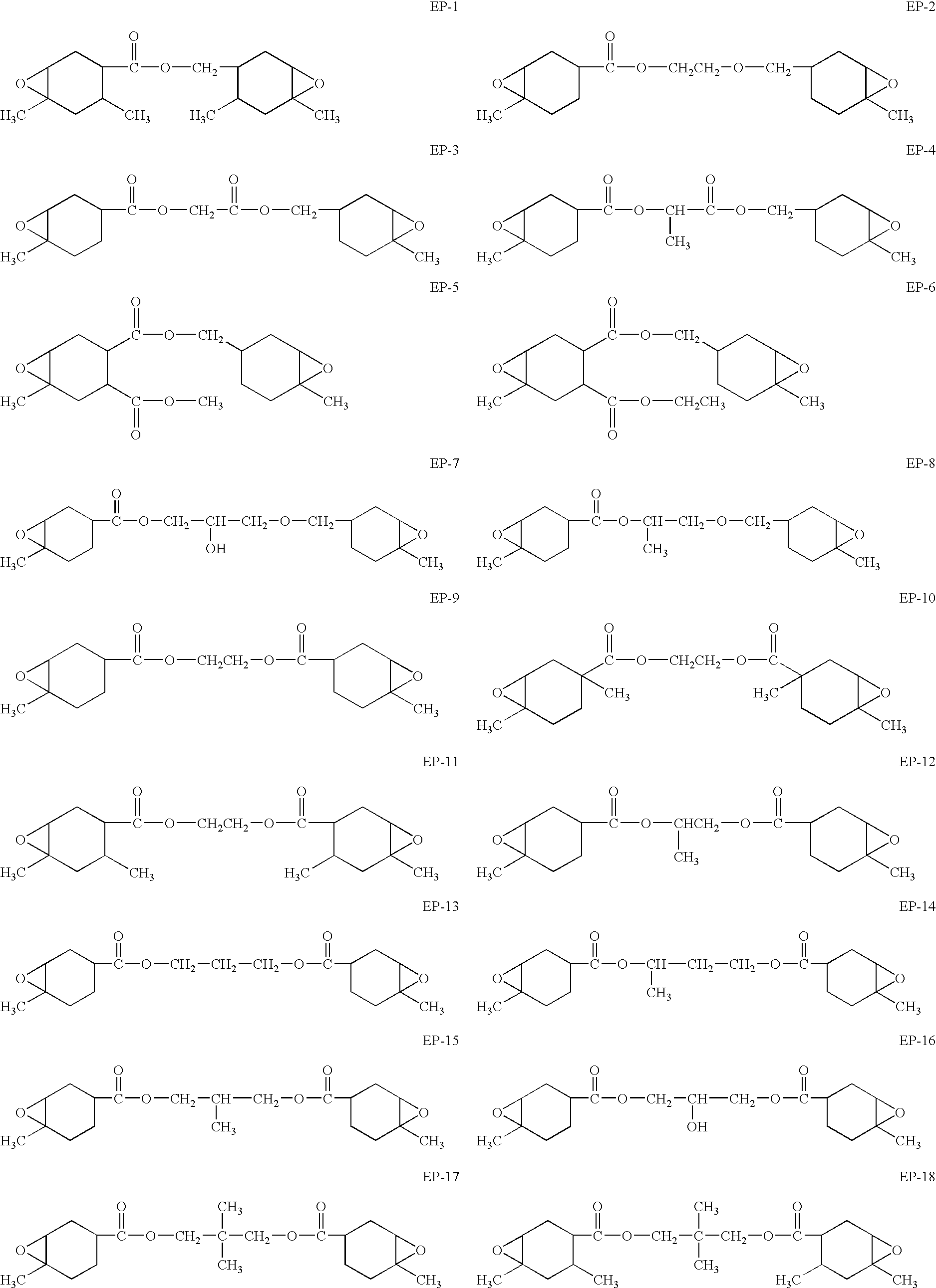

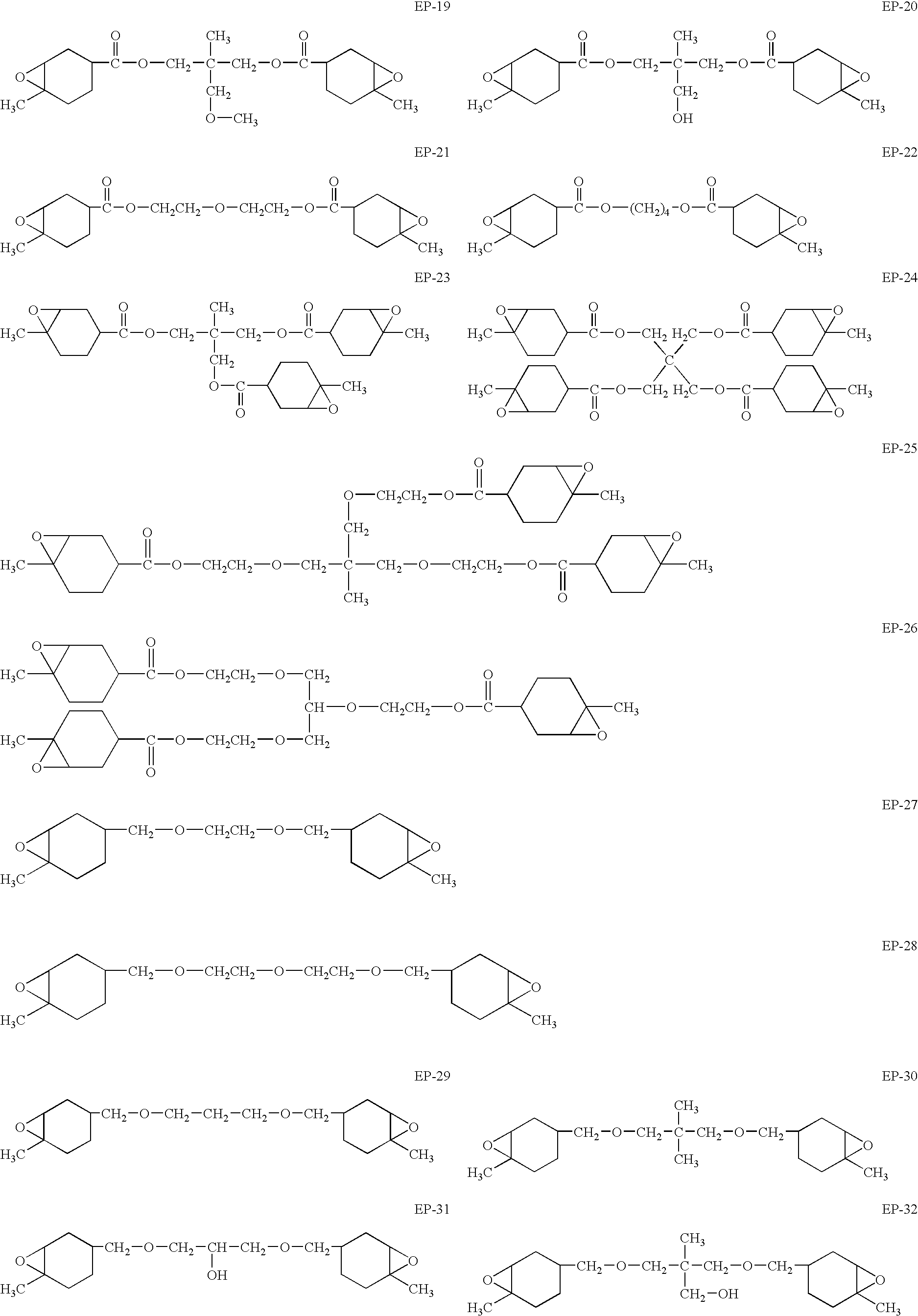

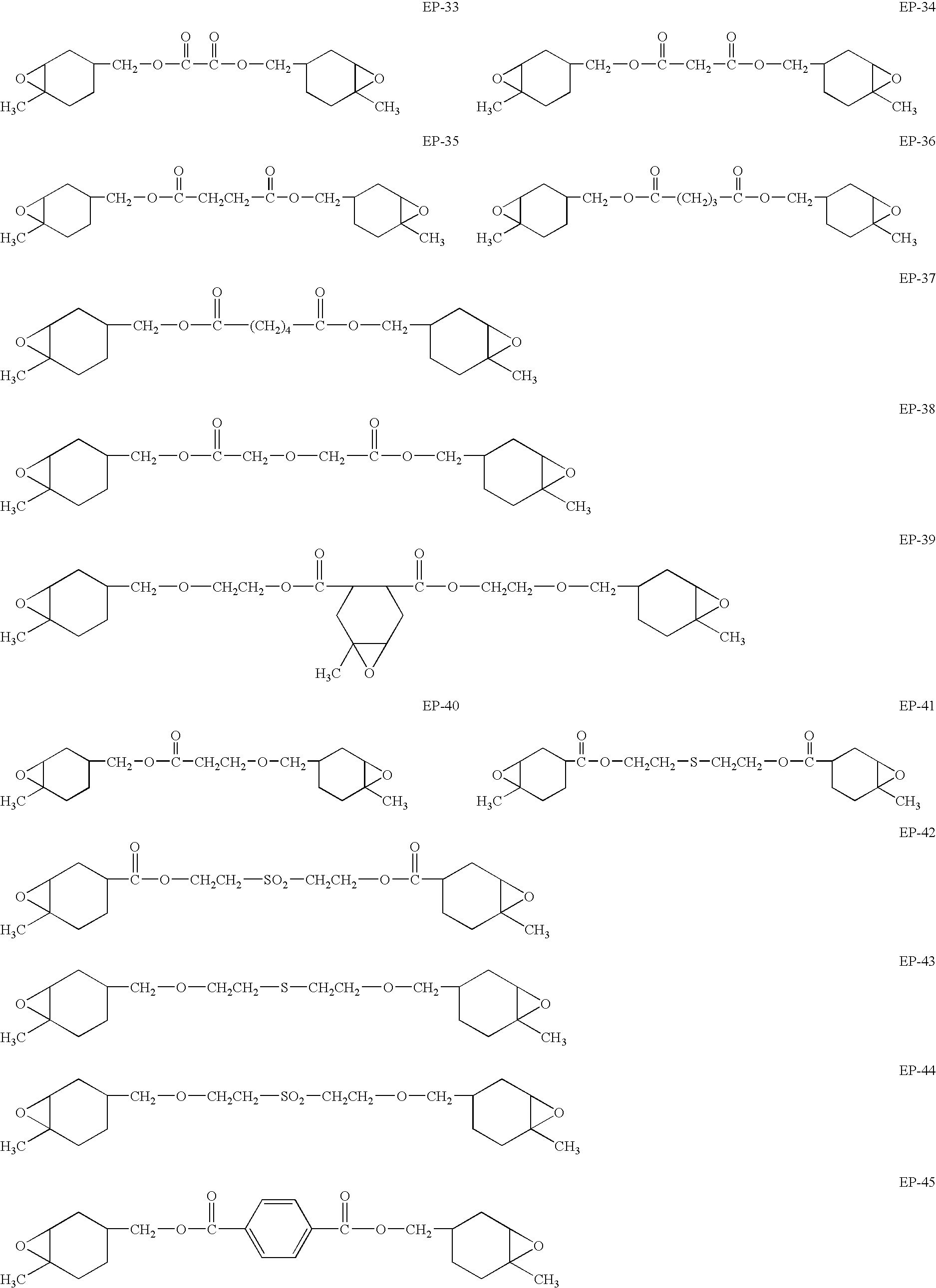

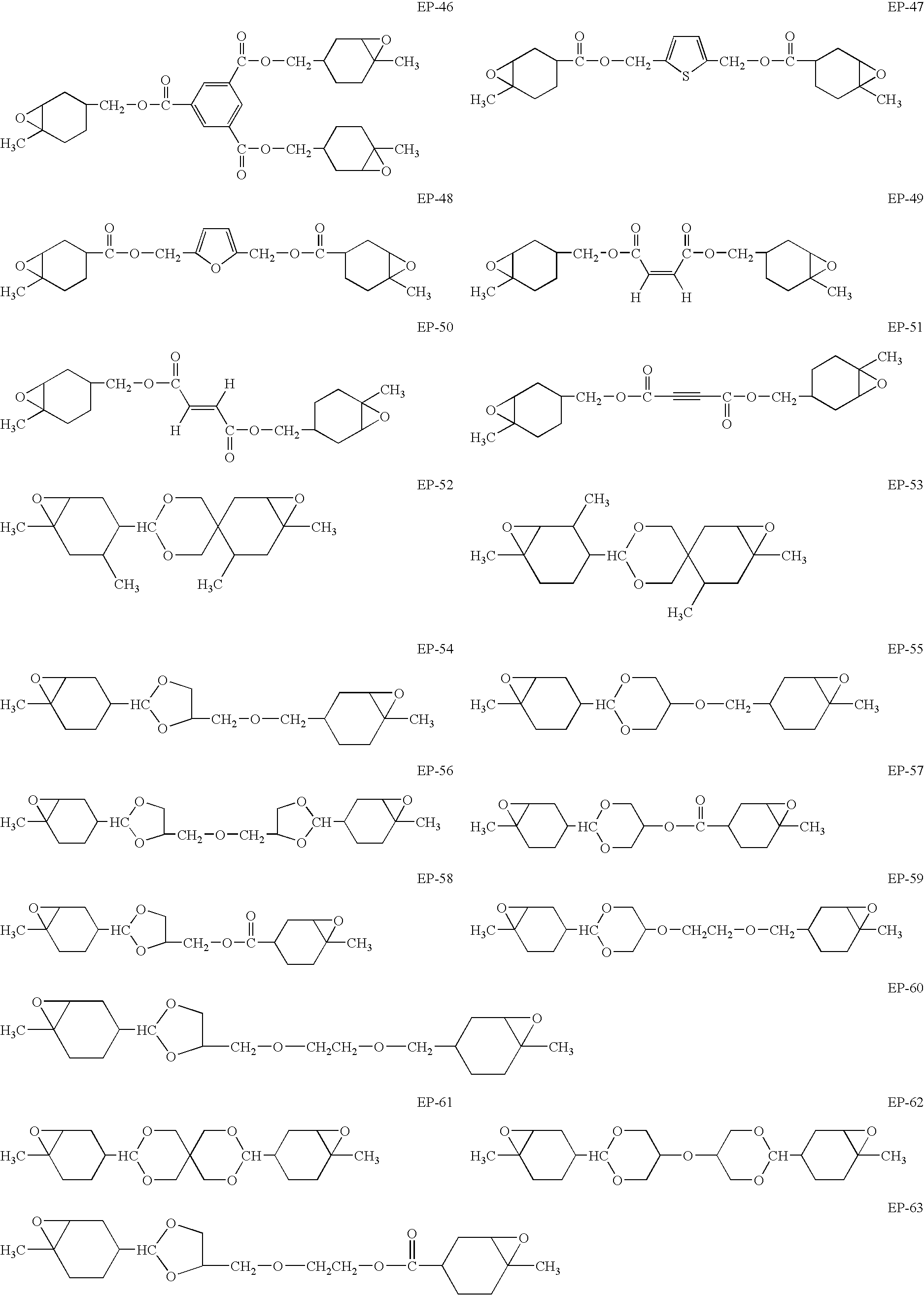

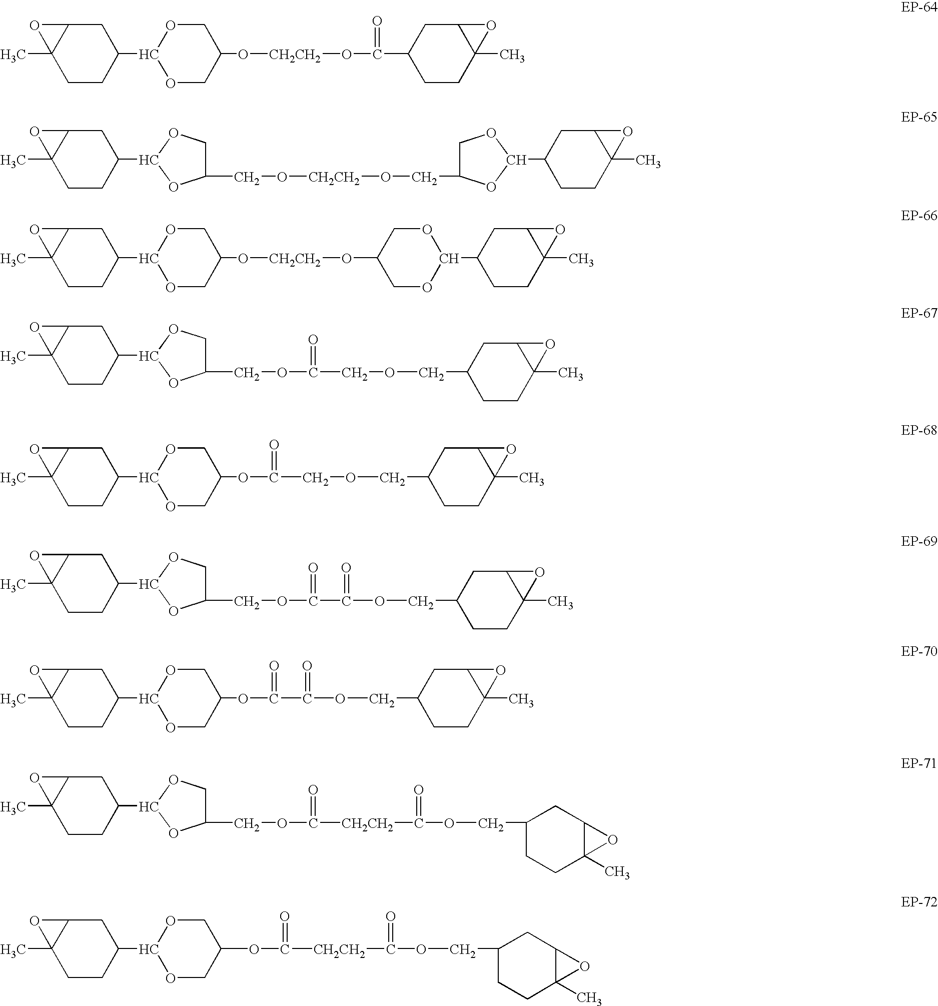

In each of the aforementioned alicyclic epoxy compounds of the present invention, the numerical value obtained by dividing the molecular weight by the total number of the epoxy group within the molecule is preferably 160-300.

The synthesis of the alicyclic epoxy compound expressed by the aforementioned General Formulas (A) and (1)-(6) can be carried out, for example, according the method described in the U.S. patents described below:

U.S. Pat. Nos. 2,745,847, 2,750,395, 2,853,498, 2,853,499, 2,863,881.

The following describes the examples of synthesis of the exemplified compounds according to the method described in the aforementioned Patents, but the synthesis methods are not limited thereto.

### SYNTHESIS EXAMPLE 1

### Exemplified compound EP-9: Synthesis of ethylene glycol-bis-(4-methyl-3,4-epoxy-cyclohexan carbonylate)

### Synthesis of methyl-(4-methyl-3-cyclohexan carbonylate)

Methyl-(4-methyl-3-cyclohexan carbonylate) was synthesized by the known Diels-Alder reaction using the isoprene and acrylic acid methyl as material. Reaction was conducted according to the reaction condition conforming to the conditions disclosed in the Document (J. Organomet. Chem., 285, 1985, 333-342; J. Phys. Chem., 95, 5, 1992, 2293-2297; Acta. Chem. Scand., 47, 6, 1993, 581-591) or U.S. Pat. No. 1,944,731. The targeted compound was obtained at a high yield rate.

### Synthesis of ethylene glycol-bis-(4-methyl-3-cyclohexan carbonylate)

1 g of toluene sulfonic acid monohydrate was added to 340 g of methyl-(4-methyl-3-cyclohexan carbonylate) (2 mol) and 62 g of ethylene glycol (1 mol), and reaction was conducted for eight hours at 80-90° C. The reaction solution washed by a sodium bicarbonate solution, and was then distilled under reduced pressure to get the targeted compound (at a yield rate of 92).

<Synthesis of Illustrated Compound EP-9>

306 g of ethylene glycol-bis-(4-methyl-3-cyclohexan carbonylate) (1 mol) was put in a 2-liter three-necked flask. With the inner temperature kept unchanged at 35-40° C., 770 g of acetone solution (192 g of peroxyacetic acid (2.5 mol)) containing 25% by mass of peroxyacetic acid was dropped for four hours. After termination of dropping, reaction was conducted four hours later at the same temperature. The reaction solution was stored overnight at −11° C. Then the remaining amount of peroxyacetic acid was checked, and 98% or more of the theoretical quantity was confirmed to have been reacted.

Then the reaction solution was diluted by 1 L of toluene. It was heated at 50° C. under reduced pressure by a water-flow aspirator, and the components of lower boiling point were distilled until there was no more distillate. The remaining reaction composition was distilled under reduced pressure to get the targeted illustrated compound EP-9 (at a yield rate of 78%).

The structure of the illustrated compound EP-9 having been obtained was confirmed by the method of NMR and MASS analysis.

1H NMR (CDCl₃) δ (ppm): 1.31 (s, 6H, CH₃—), 1.45-2.50 (m, 14H, cyclohexan ring), 3.10 (m, 2H, epoxy root), 4.10 (s, 4H, —CH₂—O—)

### SYNTHESIS EXAMPLE 2

### Synthesis of exemplified compound EP-12: propane-1,2-diol-bis-(4-methyl-3,4-epoxy-cyclohexan carbonylate)

### Synthesis of propane-1,2-diol-bis-(4-methyl-3-cyclohexan carbonylate)

1 g of toluene sulfonic acid monohydrate was added to 340 g of methyl-(4-methyl-3-cyclohexan carbonylate) (2 mol) and 76 g of propane-1,2-diol (1 mol), and reaction was carried out for four eight hours at 80-90° C. After the reaction solution had been washed in a sodium bicarbonate solution, and was then distilled under reduced pressure to get the targeted compound (at a yield rate of 90).

<Synthesis of illustrated compound EP-12>

320 g of propane-1,2-diol-bis-(4-methyl-3-cyclohexan carbonylate) (1 mol) was placed in a 2-liter three-necked flask. With the inner temperature kept unchanged at 35-40° C., 770 g of acetone solution (192 g of peroxyacetic acid (2.5 mol)) containing 25% by mass of peroxyacetic acid was dropped for four hours. After termination of dropping, reaction was conducted for four hours, with the temperature kept unchanged. The reaction solution was preserved overnight at a temperature of −11° C. Then the remaining amount of peroxyacetic acid was checked, and 98% or more of the theoretical amount was confirmed to have been reacted.

Then the reaction solution was diluted in one liter of toluene and was heated to 50° C. under reduced pressure by a water flow aspirator. The component of lower boiling point was distilled off until there was no more distillate. The remaining reaction composition was distilled under reduced pressure to get the targeted exemplified compound EP-12 (at a yield rate of 75%).

The structure of exemplified compound EP-12 having been obtained was confirmed according to the method of NMR and MASS analysis.

¹H NMR (CDCl₃) δ (ppm): 1.23 (d, 3H, CH₃—), 1.31 (s, 6H, CH₃—), 1.45-2.50 (m, 14H, cyclohexan ring), 3.15 (m, 2H, epoxy root), 4.03 (m, 1H, —O—CH₂—), 4.18 (m, 1H, —O—CH₂—), 5.15 (m, 1H, >CH—O—)

### SYNTHESIS EXAMPLE 3

### Synthesis of exemplified compound EP-17: 2,2-dimethyl-propane-1,3-diol-bis-(4-methyl-3,4-epoxy-cyclohexan carbonylate)

### Synthesis of 2,2-dimethyl-propane-1,3-diol-bis-(4-methyl-3-cyclohexan carbonylate)

1 g of toluene sulfonic acid monohydrate was added to 340 g of methyl-(4-methyl-3-cyclohexan carbonylate) (2 mol) and 104 g of 2,2-dimethyl-propane-1,3-diol (1 mol), and reaction was conducted at 80-90° C. for 12 hours. After reaction solution washed in sodium bicarbonate solution, distillation was conducted under reduced pressure to get the targeted compound (at an yield rate of 86%).

<Synthesis of Exemplified Compound EP-17>

348 g of 2,2-dimethyl-propane-1,3-diol-bis-(4-methyl-3-cyclohexan carbonylate) (1 mol) is put in a 2-liter three-necked flask. With the inner temperature kept unchanged at 40° C., 770 g of acetone solution (192 g of peroxyacetic acid (2.5 mol)) containing 25% by mass of peroxyacetic acid was dropped for four hours. After termination of dropping, reaction was conducted for four hours with the temperature kept unchanged. After the reaction solution was stored overnight at −11° C., the remaining amount of peroxyacetic acid was checked and 98% or more of the theoretical amount was confirmed to have been reacted.

Then the reaction solution was diluted in one liter of toluene, and was heated to 50° C. under reduced pressure by a water flow aspirator. The component of lower boiling point was distilled off until there was no more distillate.

The remaining reaction composition was distilled under reduced pressure to get the targeted exemplified compound EP-17 (at a yield rate of 70%).

The structure of exemplified compound EP-17 was confirmed according to the method of NMR and MASS analysis.

1H NMR (CDCl₃) δ (ppm): 0.96 (s, 6H, CH₃—), 1.31 (s, 6H, CH₃—), 1.45-2.50 (m, 14H, cyclohexan ring), 3.00 (m, 2H, epoxy root), 3.87 (s, 4H, —O—CH₂—)

### SYNTHESIS EXAMPLE 4

### Synthesis of exemplified compound EP-31: 1,3-bis-(4-methyl-3,4-epoxy-cyclohexylmethyloxy)-2-propanol

### Synthesis of 4-methyl-3-cyclohexenyl methanol

4-methyl-3-cyclohexenyl aldehyde was synthesized by the known Diels-Alder reaction using the isoprene and acrolein as material. Reaction was conducted according to the reaction condition conforming to the conditions disclosed in documents (J. Amer. Chem. Soc., 119, 15, 1997, 3507-3512, and Tetrahedron Lett., 40, 32, 1999, 5817-5822) and others. The targeted compound was obtained at a high yield rate. Then this compound was reduced to synthesize 4-methyl-3-cyclohexenyl methanol at a high yield rate.

### Synthesis of 1,2-bis-(4-methyl-3-cyclohexylmethyloxy)-2-propanol

305 g of potassium carbonate (2.2 mol) was put in one-liter of acetone solution containing 284 g of 4-methyl-3-cyclohexenyl methanol (2 mol) and 92 grams of epichlorohydrin (1 mol). Reaction was conducted for eight hours at 50° C. The salts having been precipitated were removed by filtering, and the reaction solution was concentrated under reduced pressure. After that, the remaining crude products were distilled under reduced pressure to get the targeted compound (at a yield rate of 90%).

<Synthesis of Exemplified Compound EP-31>

308 g of 1,2-bis-(4-methyl-3-cyclohexylmethyloxy)-2-propanol (1 mol) was put in a two-liter three-necked flask. With the inner temperature kept unchanged at 35-40° C., 770 g of acetone solution (192 g of peroxyacetic acid (2.5 mol)) containing 25% by mass of peroxyacetic acid was dropped for four hours. After termination of dropping, reaction was conducted four hours later at the same temperature. The reaction solution was stored overnight at −11° C. Then the remaining amount of peroxyacetic acid was checked, and 98% or more of the theoretical quantity was confirmed to have been reacted.

Then the reaction solution was diluted by 1 L of toluene. It was heated at 50° C. under reduced pressure by a water-flow aspirator, and the components of lower boiling point were distilled until there was no more distillate. The remaining reaction composition was distilled under reduced pressure to get the targeted exemplified compound EP-31 (at a yield rate of 83%).

The structure of exemplified compound EP-31 was confirmed by the method of NMR and MASS analysis.

¹H NMR (CDCl₃) δ (ppm): 1.31 (s, 6H, CH₃—), 1.4-2.0 (m, 14H, cyclohexan ring), 2.7 (s, 1H, —OH), 3.10 (m, 2H, epoxy root), 3.45 (d, 4H, —CH₂—O—), 3.50 (m, 4H, —CH₂—O—), 3.92 (m, 1H, >CH—)

### SYNTHESIS EXAMPLE 5

### Synthesis of illustrated compound EP-35: bis-(4-methyl-3,4-epoxy-cyclohexylmethyl) oxalate

### Synthesis of bis-(4-methyl-3-cyclohexenyl methyl) succisinate

5 g of toluene sulfonic acid monohydrate was added to one-liter of toluene solution including 284 g of 4-methyl-3-cyclohexenyl methanol (2 mol) and 100 g of succinic acid anhydride (1 mol). While the generated water was removed by a water separator, reaction was conducted at 110-120° C. for eight hours. The reaction solution washed in a sodium bicarbonate solution and was then concentrated under reduced pressure to distill off toluene. After that, the remaining crude products were distilled under reduced pressure to get the targeted compound (at a yield rate of 90).

<Synthesis of Exemplified Compound EP-35>

335 g of bis-(4-methyl-3-cyclohexenyl methyl) succisinate (1 mol) was put in a two-liter three-necked flask. With the inner temperature kept unchanged at 35-40° C., 770 g of acetone solution (192 g of peroxyacetic acid (2.5 mol)) containing 25%; by mass of peroxyacetic acid was dropped for four hours. After termination of dropping, reaction was conducted four hours later at the same temperature. The reaction solution was stored overnight at −11° C. Then the remaining amount of peroxyacetic acid was checked, and 98%; or more of the theoretical quantity was confirmed to have been reacted.

The reaction solution was diluted by 1 L of toluene. It was heated at 50° C. under reduced pressure by a water-flow aspirator, and the components of lower boiling point were distilled until there was no more distillate. The remaining reaction composition was distilled under reduced pressure to get targeted exemplified compound EP-35 (at a yield rate of 75%).

The structure of exemplified compound EP-35 was confirmed by the method of NMR and MASS analysis.

1H NMR (CDCl₃) δ (ppm): 1.31 (s, 6H, CH₃—), 1.4-2.0 (m, 14H, cyclohexan ring), 3.10 (m, 2H, epoxy root), 2.62 (s, 4H, —CH₂—CO—), 4.05 (d, 4H, —CH₂—O—)

Other alicyclic epoxide compounds of the present invention can be synthesized at a high yield rate in the same manner.

(Oxytane Ring-Containing Compound)

The following describes the oxytane ring-containing compound (hereinafter also referred to as “oxetane compound”). The oxetane ring denotes a circular four-membered ether structure. The oxytane ring-containing compound of the present invention is only required to contain at least one four-membered ether structure in the molecule. There is no restriction to other partial structures. The number of the oxetane rings of the oxetane compound of the present invention and other partial structures should be determined after studying the evaluation of various performances required to exhibit a function desired by the user when the present invention is actually used.

The oxetane compound expressed by the following General Formula (11) is more preferably used in the present invention.

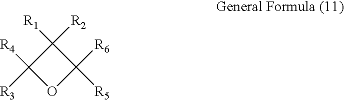

In the formula, R₁-R₆ are each a hydrogen atom or a substituent, but all of R₁-R₆ are not a hydrogen atom simultaneously.

The substituents indicated by R₁-R₆ in the General Formula (1) are an alkyl group (such as a methyl, ethyl, propyl, i-propyl, t-butyl, pentyl group, hexyl, octyl, dodecyl, tridesyl, tetradesyl, pentadesyl, cyclopentyl and cyclohexyl group), an alkenyl group (such as a vinyl, 1-propenyl, 2-propenyl, 2-butenyl and alyl group), an alkynyl group (such as an acetylenyl, 1-propinyl, 2-propinyl, 2-butynyl and propargyl group), an alkoxy group (such as a methoxy, ethoxy, propyloxy, pentyloxy, hexyloxy, octyloxy, dodecyloxy, cyclopentyloxy, and cyclohexyloxy group), an aromatic carbohydrate group (such as a phenyl, naphthyl and anthracenyl group), a complex aromatic group (such as a furyl, thienyl, pyridyl, pyridazinyl, pyrimidyl, pyrazyl, triazyl, imidazolyl, pyrazoyl, thiazolyl, benzoimidazolyl, benzooxazolyl, quinazolyl, phthalazyl, pyrrolyl, 2-quinolyl and 1-isoquinilyl group), a heterocyclic ring group (such as a pyrrolidyl, imidazolydyl, morpholyl, oxazolidyl, 2-tetrahydrofuranyl, 2-tetrahydrothienyl, 2-tetrahydropyranyl and 3-tetrahydropyranyl group), a halogen atom (such as chlorine, bromine and fluorine atom), a hydrocarbon fluoride group (such as a fluoromethyl, trifluoromethyl, pentafluoroethyl and pentafluorophenyl group). R₁ and R₂, R₃ and R₄, and R₅ and R₆ can be combined with each other to form a divalent group, and hence a ring. The substituents indicates by R₁-R₆ are preferably an alkyl group, an alkoxy group, an acyloxy group, an alkoxy carbonyl group, an aromatic carbohydrate group, a complex aromatic group, a halogen atom and a hydrocarbon fluoride group.

The groups indicated by the R₁-R₆ may further contain a substituent. Examples of the substitutable group include an alkyl group (such as a methyl, ethyl, propyl, i-propyl, t-butyl, pentyl, hexyl, octyl, dodecyl, tridesyl, tetradesyl, pentadesyl cyclopentyl, and cyclohexyl group), an alkenyl group (such as a vinyl, 1-propenyl, 2-propenyl, 2-butenyl and alyl group), an alkynyl group (such as an acetylenyl, 1-propinyl, 2-propinyl, 2-butynyl and propargyl group), an aromatic carbohydrate group (such as a phenyl, naphthyl and anthracenyl group), a complex aromatic group (such as a furyl, thienyl, pyridyl, pyridazinyl, pyrimidyl, pyrazyl, triazyl, imidazolyl, pyrazoyl, thiazolyl, benzoimidazolyl, benzooxazolyl, quinazolyl, phthalazyl, pyrrolyl, 2-quinolyl and 1-isoquinilyl group), a heterocyclic ring group (such as a pyrrolidyl, imidazolydyl, morpholyl, oxazolidyl, 2-tetrahydrofuranyl, 2-tetrahydrothienyl, 2-tetrahydropyranyl and 3-tetrahydropyranyl group), an alkoxy group (such as a methoxy, ethoxy, propoxy, pentyloxy, hexyloxy, octyloxy, dodecyloxy, cyclopentyloxy and cyclohexyloxy group), an aryloxy group (such as a phenoxy and naphthyloxy group), an alkylthio group (such as a methylthio, ethylthio, propylthio, pentylthio, hexylthio, octylthio, dodecylthio, cyclopentylthio and cyclohexylthio group), an arylthio group (such as a phenylthio and naphthylthio group), an alkoxy carbonyl group (such as a methoxycarbonyl, ethoxycarbonyl, butoxycarbonyl, octyloxycarbonyl, and dodecyloxycarbonyl group), an aryl oxycarbonyl group (such as a phenoxy carbonyl and naphthoxy carbonyl group), a sulfamoyl group (such as an aminosulfonyl, methylaminosulfonyl, dimethylaminosulfonyl, butylaminosulfonyl, hexylaminosulfonyl, cyclohexylaminosulfonyl, octylaminosulfonyl, dodecylaminosulfonyl, phenylaminosulfonyl, naphthylaminosulfonyl, and 2-pyridyl aminosulfonyl group), an acyl group (such as an acetyl, ethylcarbonyl, propylcarbonyl, pentylcarbonyl, cyclohexylcarbonyl, octylcarbonyl, 2-ethylhexylcarbonyl, dodecycarbonyl, phenylcarbonyl, naphthylcarbonyl and pyridylcarbonyl group), an acyloxy group (such as an acetyloxy, ethylcarbonyloxy, butylcarbonyloxy, octylcarbonyloxy, dodecycarbonyloxy and phenylcarbonyloxy group), an amide group (such as a methylcarbonyl amino, ethylcarbonyl amino, dimethylcarbonyl amino, propylcarbonyl amino, pentylcarbonyl amino, cyclohexylcarbonyl amino, 2-ethylhexylcarbonyl amino, octylcarbonyl amino, dodecylcarbonyl amino, phenylcarbonyl amino and naphthylcarbonyl amino group), a carbamoyl group (such as an aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl naphthylaminocarbonyl and 2-pyridylaminocarbonyl group), a ureide group (such as a methylureide, ethylureide, pentylureide, cyclohexylureide, octylureide, dodecylureide, phenylureide, naphthylureide and 2-pyridylaminoureide group), a sulfonyl group (such as a methylsulfonyl, ethylsulfonyl, butylsulfonyl, cyclohexylsulfonyl, 2-ethylhexylsulfonyl, dodecylsulfonyl, phenylsulfonyl, naphthylsulfonyl, and 2-pyridylsulfonyl), alkyl sulfonyl group (such as methylsulfonyl, ethylsulfonyl, butylsulfonyl, cyclohexylsulfonyl, 2-ethylhexylsulfonyl, and dodecylsulfonyl group), an aryl sulfonyl group (such as a phenylsulfonyl, naphthylsulfonyl and 2-pyridylsulfonyl group), an amino group (such as an amino, ethylamino, dimethylamino, butylamino, cyclopentylamino, 2-ethylhexylamino, dodecylamino, anilino, naphthylamino and 2-pyridylamino group), a halogen atom (such as fluorine, chlorine, and bromine), a hydrocarbon fluoride group (such as a fluoromethyl, trifluoromethyl, pentafluoroethyl and pentafluorophenyl group), a cyano group, a nitro group, a hydroxyl group, a mercapto group, a silyl group (such as a trimethylsilyl, tri-i-propylsilyl, triphenylsilyl and phenyldiethylsilyl group), and a carboxyl group. These substituents can be further substituted by the groups synonymous with the examples of the group which can be substituted by the substituents denoted by the aforementioned R₁-R₆. Further, a plurality of these substituents can be bonded with one another to form a ring.

The group which can preferably be substituted by the substituents denoted by the R₁-R₆ is a halogen atom, an alkyl group, an alkoxy group, an acyloxy group, an alkoxy carbonyl group, an aromatic carbohydrate group, a complex aromatic group, a hydroxyl group and a hydrocarbon fluoride group. Any one of the arbitrary position of the substituents denoted by the R₁-R₆ at a given site may contain an oxetane ring synonymous with General Formula (11) as a substituent, and may form a bifunctional or multifunctional oxetane compound.

The oxetane compound of the present invention preferably contains a substituent at the first or third position of the oxetane ring. There is no particular restriction to the substituent which can replace the second position of the oxetane ring, but it is preferably an aromatic group. The aromatic group of the present invention refers to a group synonymous with the aforementioned aromatic carbohydrate group (such as a phenyl, naphthyl and anthracenyl group), a complex aromatic group (such as a furyl, thienyl, pyridyl, pyridazinyl, pyrimidyl, pyrazyl, triazyl, imidazolyl, pyrazoyl, thiazolyl, benzoimidazolyl, benzooxazolyl, quinazolyl, phthalazyl, pyrrolyl, 2-quinolyl and 1-isoquinilyl group). The aromatic group may further have a substituent. The substituent is the group synonymous with the aforementioned halogen atom, alkyl group, alkoxy group, acyloxy group and alkoxy carbonyl group. When the substituent in the second position is an aromatic group, another substituent may be located at the third position. The preferred substituent is the group synonymous with the aforementioned alkyl group and alkoxy group. The oxetane compound having a substituent in the second position is preferably an oxetane compound expressed by the following General Formula (A) or General Formula (B).

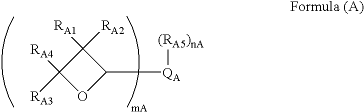

In the formula, Q_{A} is an aromatic group having a valence of (mA+nA). The R_{A1}-R_{A4} are each a hydrogen atom or a substituent. R_{A5} is a substituent and mA is a positive number of 1-3. nA is a positive number of 0-5.

The aromatic group denoted by Q_{A} is a group synonymous with the aforementioned aromatic group having a valence of (mA+nA).

Substituents denoted by R_{A1}-R_{A4} are the groups synonymous with the substituents expressed by the aforementioned R₁-R₆. Those are preferably a hydrogen atom, an alkyl group and an alkoxy group. The substituent shown by R_{A5} is a group synonymous with the substituent denoted by the aforementioned R₁-R₆. A plurality of R_{A5}s may be either the same or different from one another. They may bond with one another to form a ring. R_{A5} is preferably an alkyl group or an alkoxy group. It is more preferred that at least one of a plurality of R_{A5}s is an alkoxy group. mA is preferably a positive number of 1-2. nA is preferably a positive number of 0-3, more preferably a positive number of 0-2. (mA+nA) is preferably a positive number of 1-6, more preferably a positive number of 1-3.

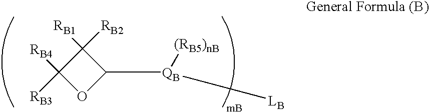

In the formula, Q_{B} is an aromatic group having a valence of (nB+2), and R_{B1}-R_{B4} are each a hydrogen atom or a substituent. R_{B5} is a substituent, L_{B} is a bonding group having a valence of mB, mB is a positive number of 2-4, and nB is a positive number of 0-4.

The aromatic group indicated by Q_{B} is a group synonymous with the aforementioned aromatic group having a valence of (nB+2).

The substituents represented by R_{B1}-R_{B4} are the groups synonymous with substituents indicated by the aforementioned R₁-R₆, preferably a hydrogen atom, an alkyl group and an alkoxy group. The substituent represented by R_{B5} is a group synonymous with the substituent represented by the aforementioned R₁-R₆. A plurality of R_{B5}s may be either the same or different with one another. They may bond with one another to form a ring. The R_{B5} is more preferably an alkyl group or an alkoxy group. The mB is preferably positive number of 2 or 3, and nB is preferably a positive number of 0-3, and more preferably a positive number of 0-2.

L_{B} is preferably a bonding group or a single bond having a valency of B and containing 0-15 carbon atoms, wherein the principal chain may contain an oxygen atom or a sulfur atom. The divalent bonding group of the principal chain containing an oxygen atom or a sulfur atom is the same bonding group as the group mentioned with reference to the L₀ and L₁-L₄ of the aforementioned General Formula (A) and General Formulas (1)-(4).

The bonding group having a valency of 3 or more is the group formed by removing the required number of the hydrogen atoms at a desired site from the aforementioned divalent bonding group, and the group formed by combining them with an —O— group, an —S— group, a —CO— group, and a —CS— group in the plural.

There is no particular limit to the method of manufacturing the aforementioned oxetane compound. A conventionally known method can be used. It is possible to use the methods disclosed in the following documents.

Hu Xianming, Richard M. Kellogg, Synthesis, 533-538, May (1995), A. O. Fitton, J. Hill, D. Ejane, R. Miller, Synth., 12, 1140 (1987); Toshiro Imai and Shinya Nishida, Can. J. Chem. Vol. 59, 2503-2509 (1981); Nobujiro Shimizu, Shintaro Yamaoka and Yuho Tsuno, Bull. Chem. Soc. Jpn., 56, 3853-3854 (1983); Walter Fisher and Cyril A. Grob, Helv. Chim. Acta., 61, 2336(1978); Chem. Ber. 101, 1850 (1968); “Heterocyclic Compounds with Three- and Four-membered Rings”, Part 2, Chapter IX, Interscience Publishers, John Wiley & Sons, New York (1964); Bull Chem. Soc. Jpn., 61, 1653(1988); I: Pure Appl. Chem., A29(10), 915(1992); Pure Appl. Chem., A30 (2 & amp; 3), 189(1993); JP-A 6-16804 and German Patent No. 1,021,858

The following describes the examples of the oxetane compound expressed by the General Formula (11), General Formula (A) and General Formula (B), but the present invention is not limited thereto.

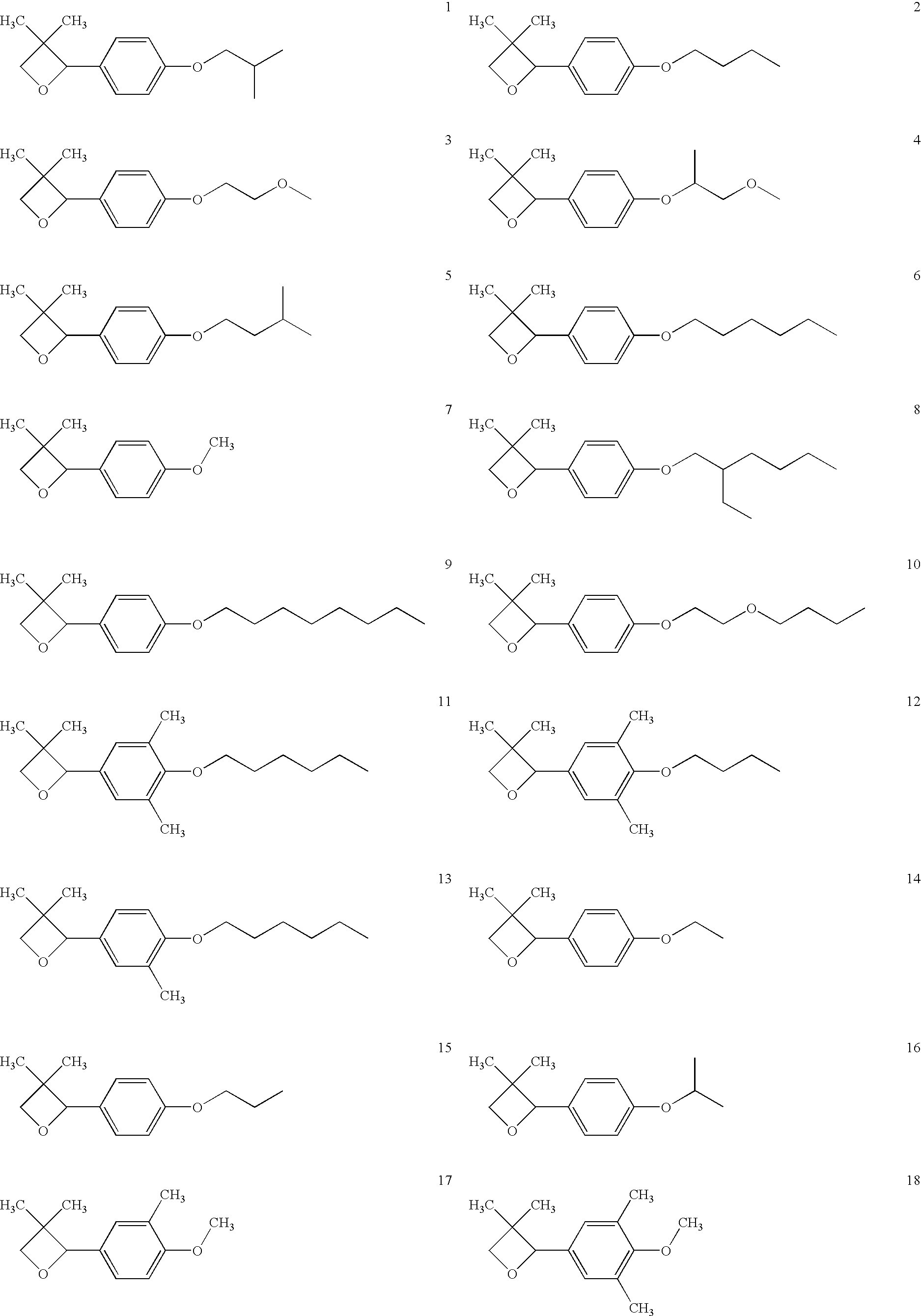

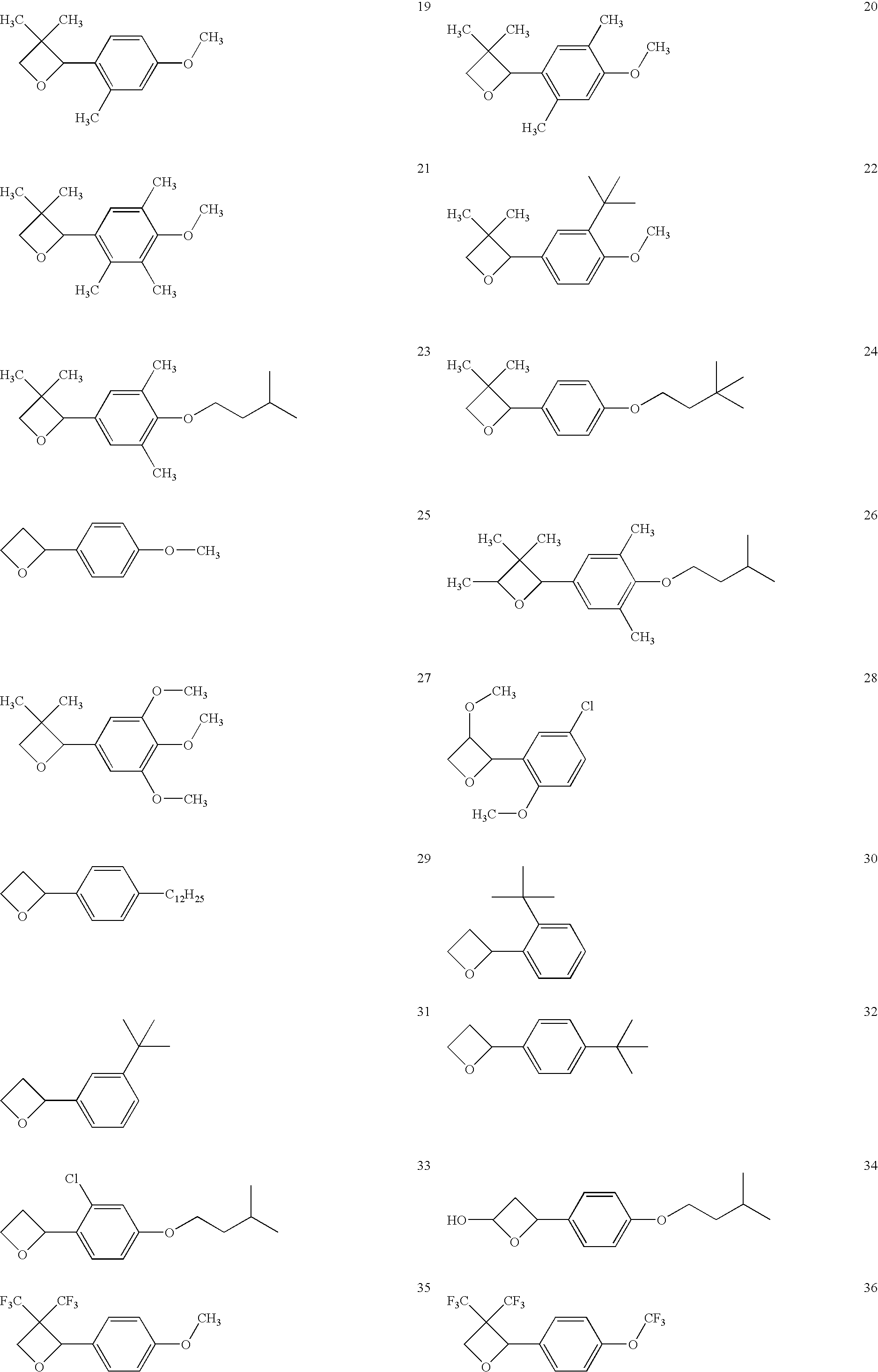

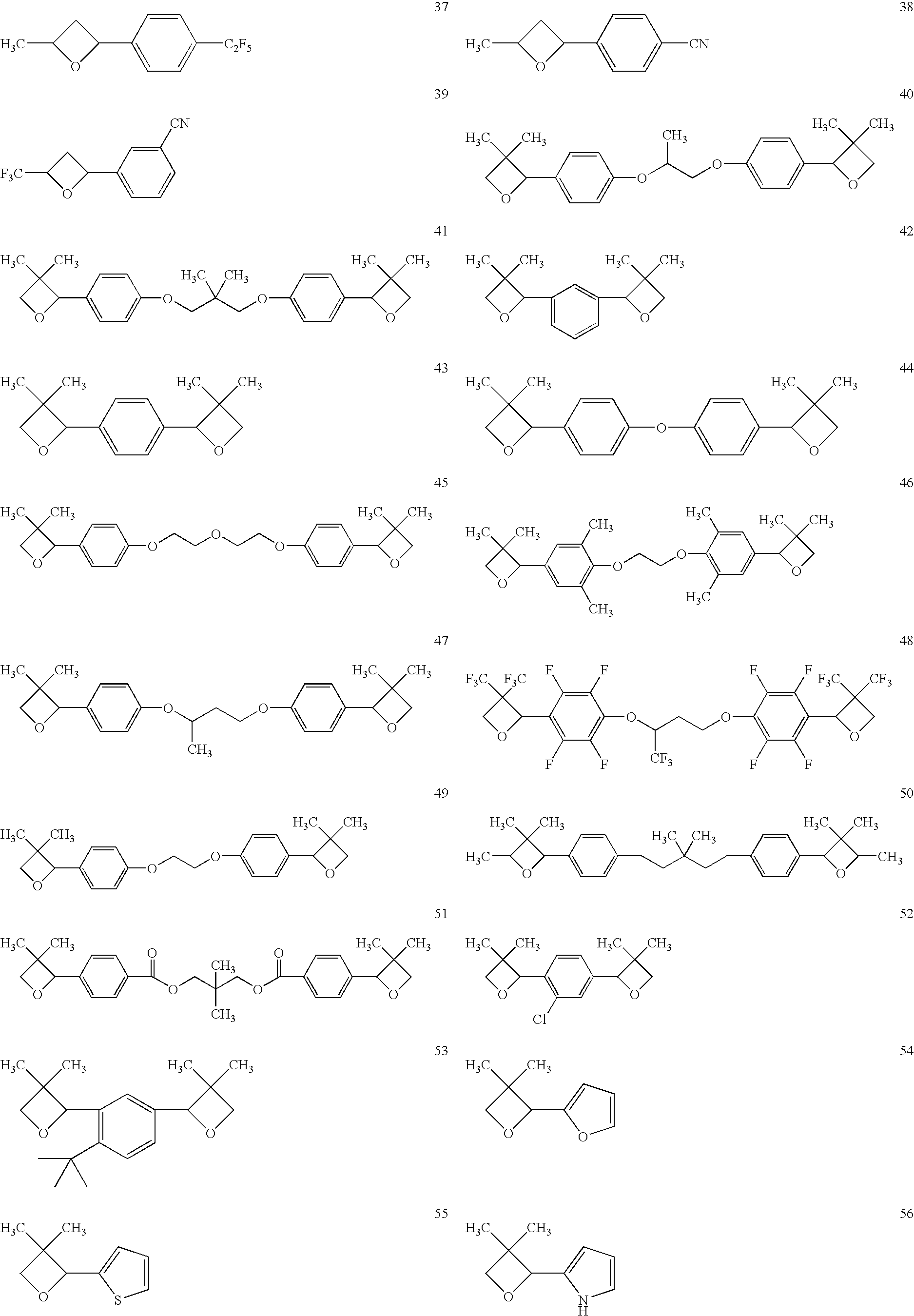

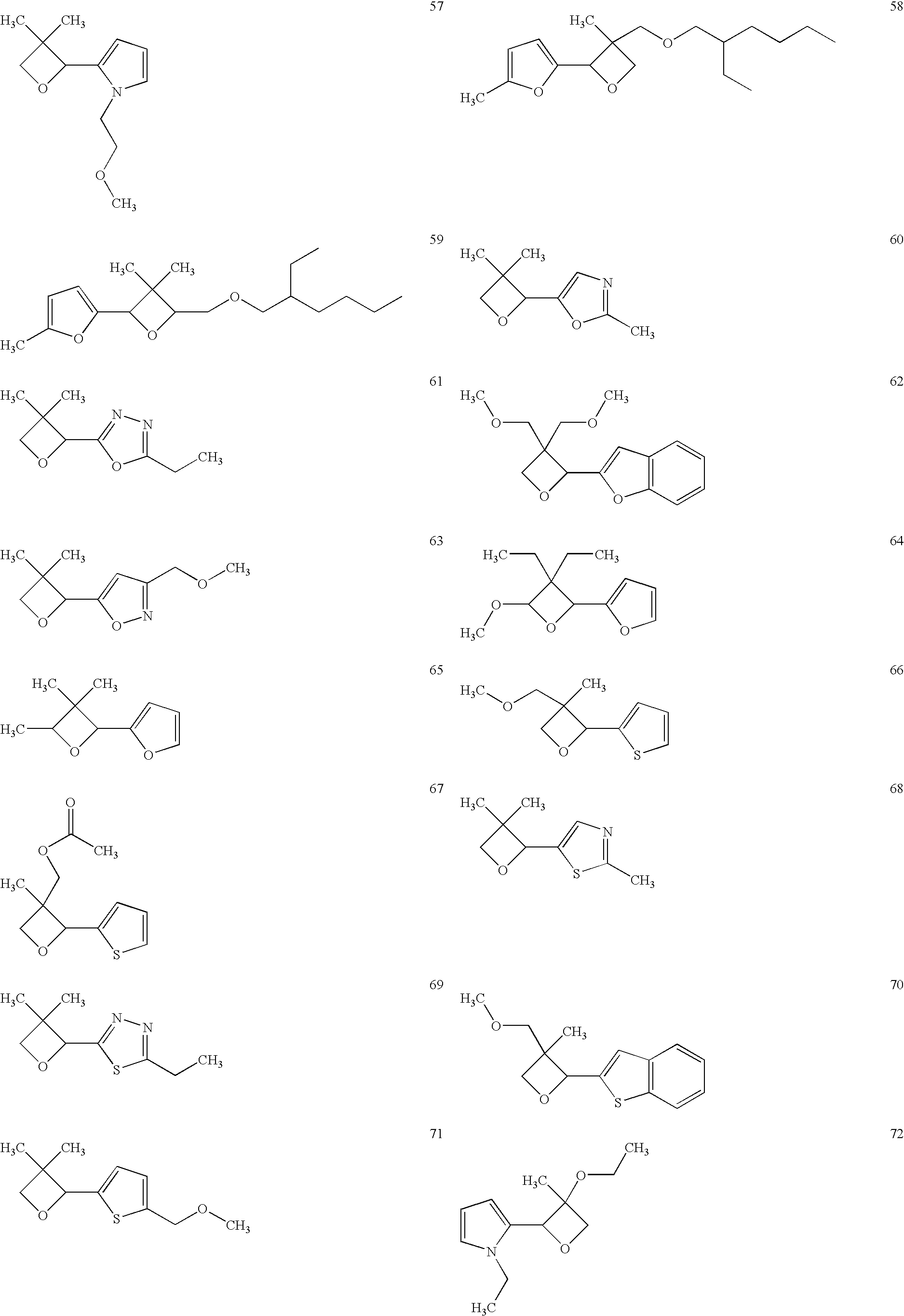

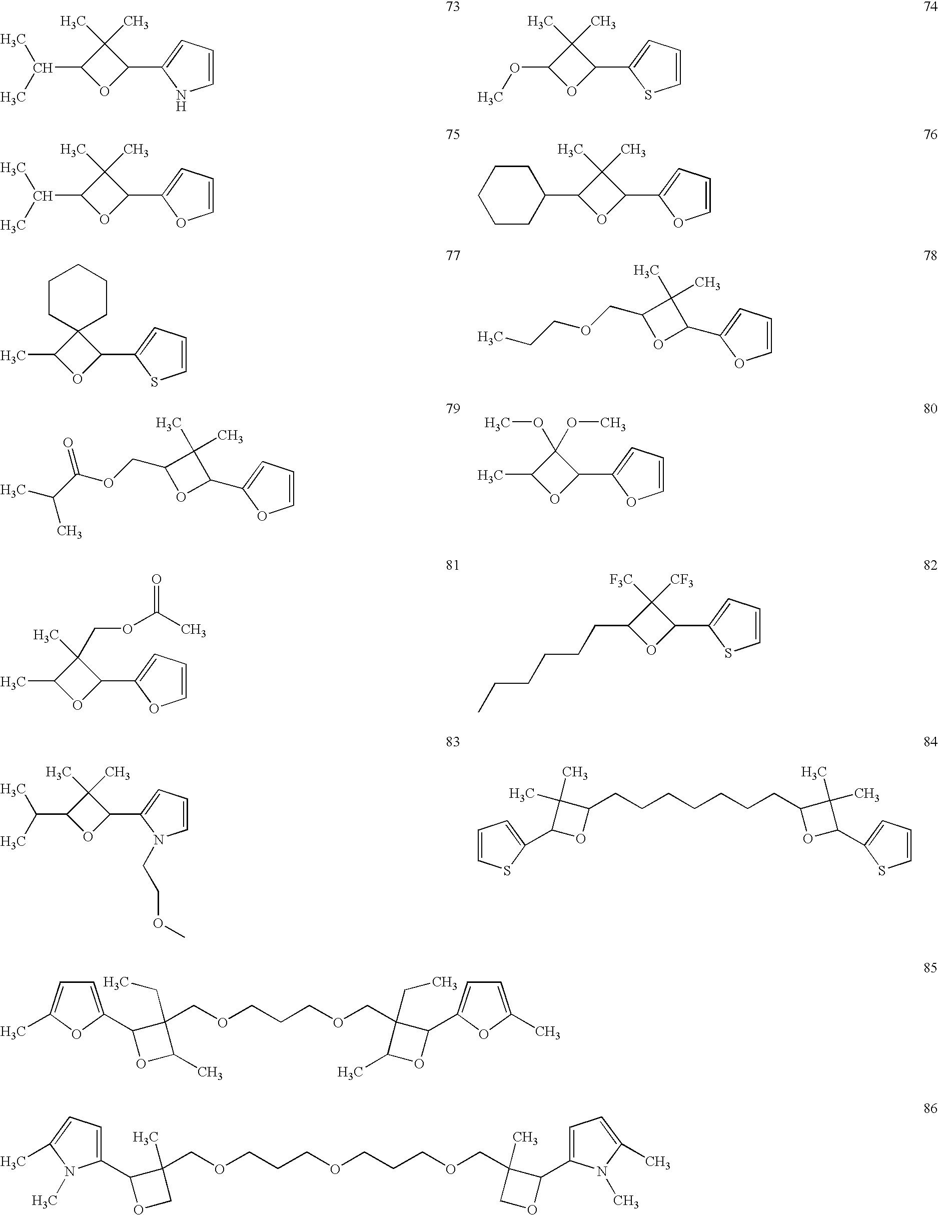

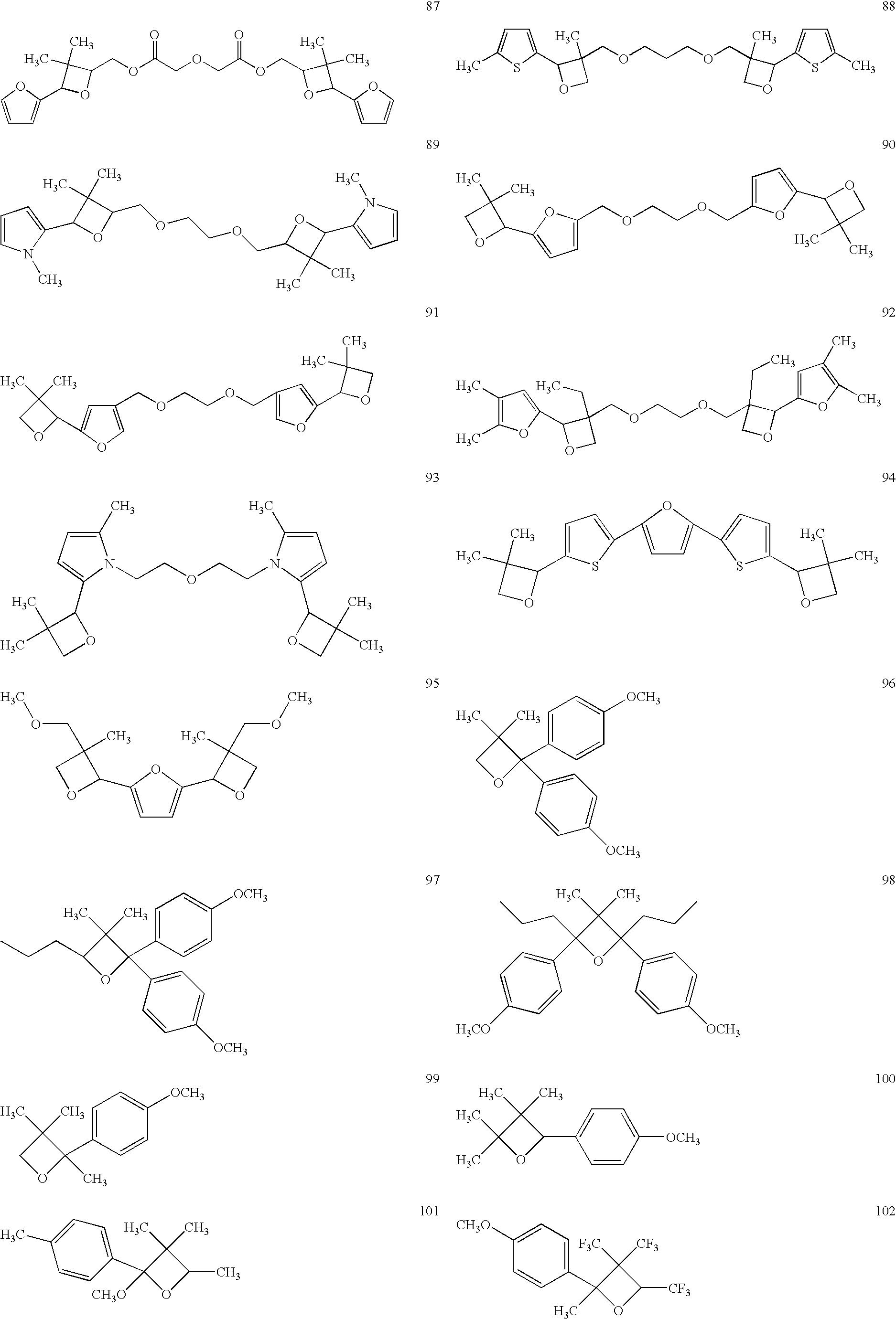

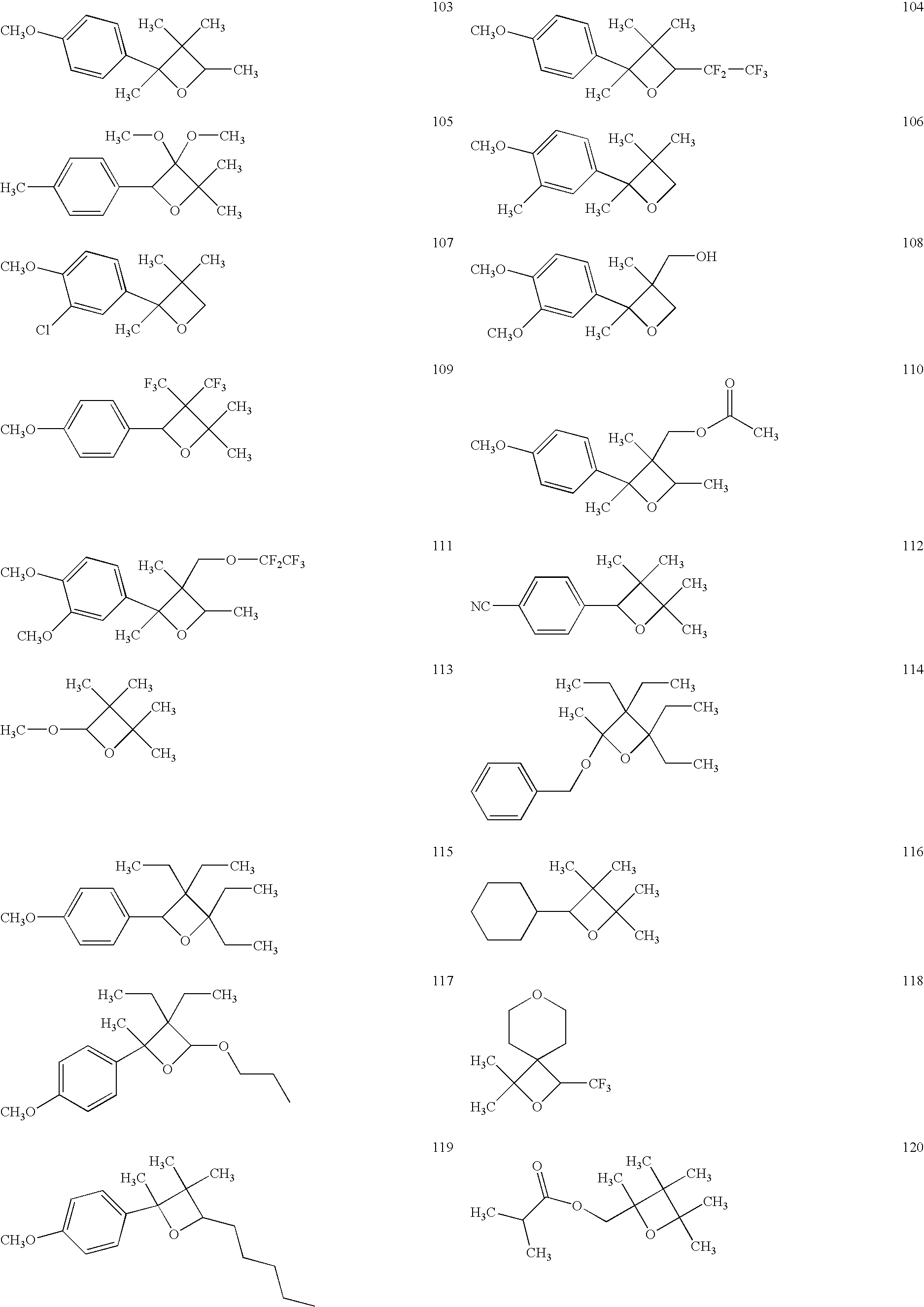

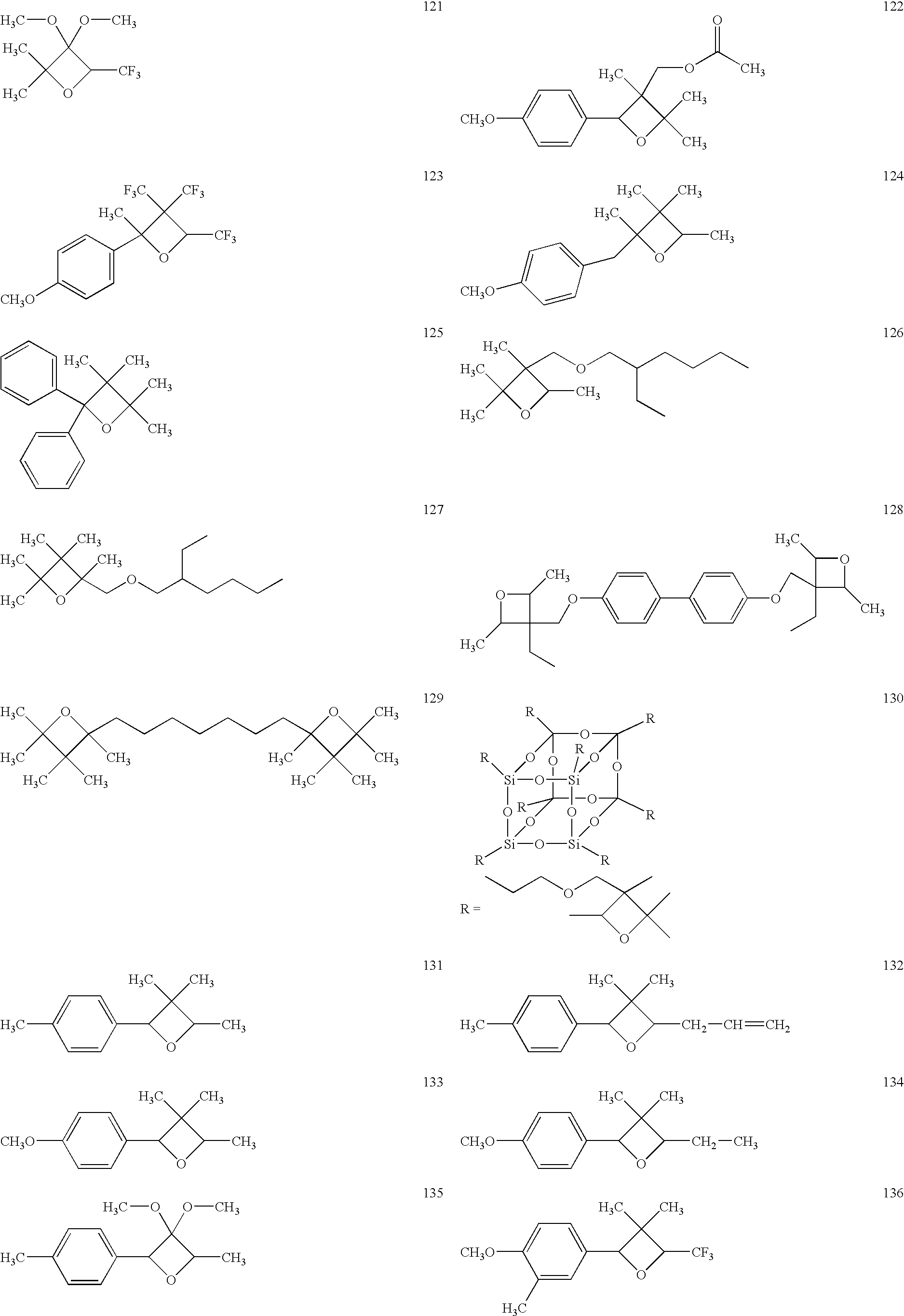

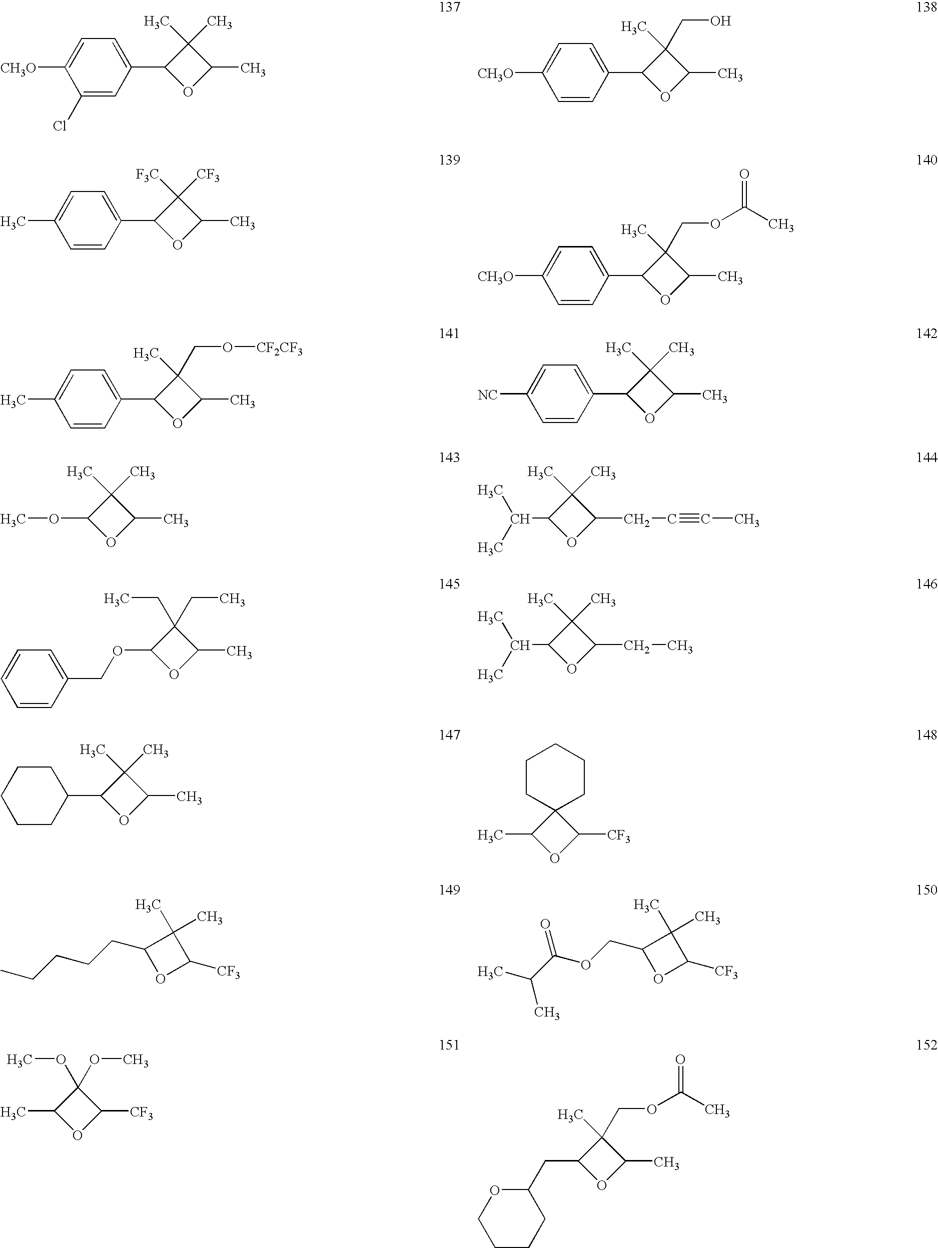

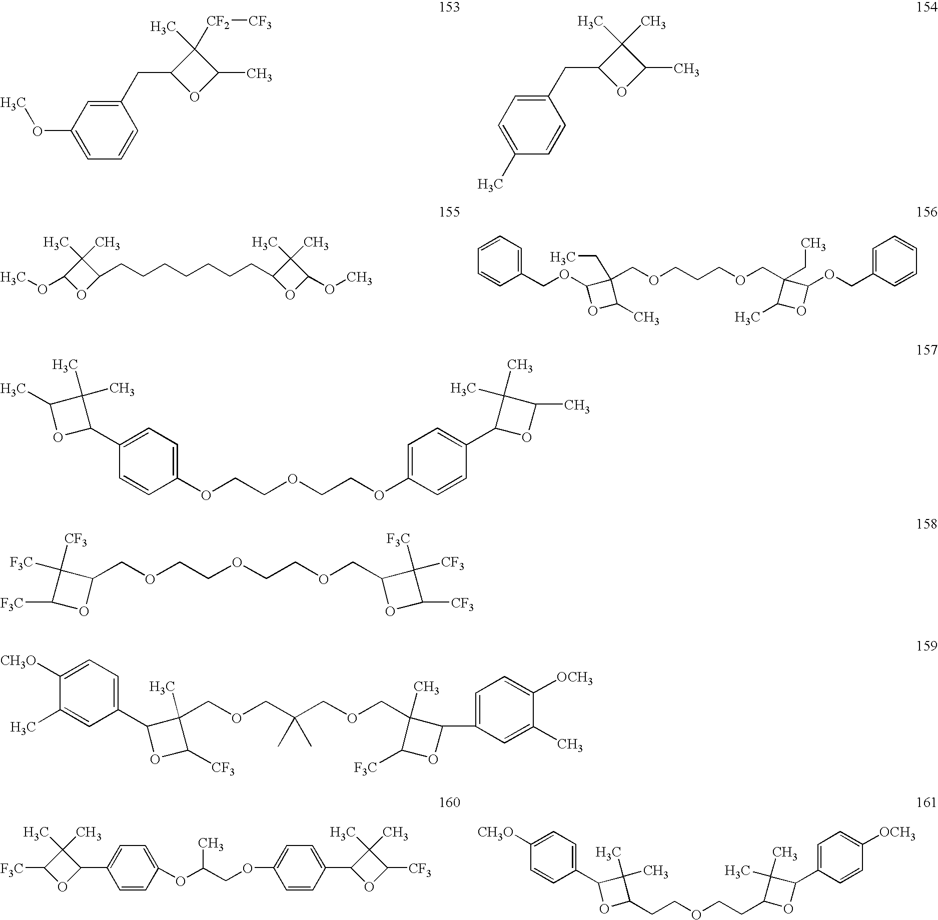

There is no particular restriction to the substituent substitutable in the third position of the oxetane ring. The preferably used substituent is the group synonymous with the aforementioned alkyl group, alkoxy group, acyloxy group, alkoxy carbonyl group, aromatic carbohydrate group, complex aromatic group, halogen atom and hydrocarbon fluoride group.

The oxetane compound having a substituent in the third position is preferably the oxetane compound of which second position is not substituted. Examples of the oxetane compound of which second position is not substituted include a compound represented by following General Formula (101).

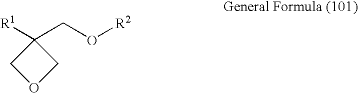

In the formula, R¹ is a hydrogen atom, an alkyl group having 1-6 carbon atoms such as a methyl, ethyl, propyl and butyl group; and a fluoroalkyl group, an alyl group, an aryl group, a furyl group or a thienyl group, all groups having 1-6 carbon atoms. R² is an alkyl group having 1-6 carbon atoms such as a methyl, ethyl, propyl and butyl group; and an alkenyl group having 2-6 carbon atoms such as a 1-propenyl, 2-propenyl, 2-methyl-1-propenyl, 2-methyl-2-propenyl, 1-butenyl, 2-butenyl and 3-butenyl group; a group having an aromatic ring such as a phenyl, benzyl, fluorobenzyl, methoxybenzyl and phenoxy ethyl group; an alkyl carbonyl group having 2-6 carbon atoms such as an ethylcarbonyl, propylcarbonyl and butylcarbonyl group; an alkoxy carbonyl group having 2-6 carbon atoms such as an ethoxycarbonyl, propoxycarbonyl and butoxycarbonyl group; or a N-alkyl carbamoyl group having 2-6 carbon atoms such as an ethylcarbamoyl, propylcarbamoyl, butylcarbamoyl and pentylcarbamoyl group.

The compound containing one oxetane ring is preferably used as an oxetane compound used in the present invention, because it provides excellent adhesive properties of the produced composition and excellent workability at a low viscosity.

The compound expressed by the following General Formula (102) can be described as an example of the compound containing two oxetane rings.

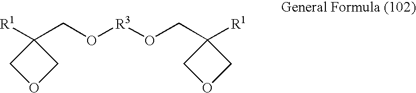

In the formula, R¹ is a group similar to that of the aforementioned General Formula (101). R³ is a linear or a branched alkylene group such as an ethylene, propylene and butylene group; a linear or a branched poly(alkyleneoxy) group such as a poly(ethyleneoxy) and poly(propyleneoxy) group; a linear or a branched unsaturated carbohydrate group such as a propenylene, methylpropenylene and butenylene group; a carbonyl group; an alkylene group including a carbonyl group; an alkylene group including a carboxyl group; and alkylene group including a carbamoyl group.

R³ is a polyvalent group selected from the groups expressed by following General Formulas (103), (104) and (105).

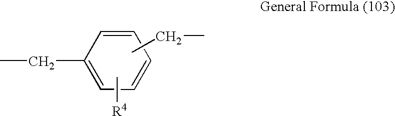

In the formula, R⁴ is a hydrogen atom, an alkyl group having 1-4 carbon atoms such as a methyl, ethyl, propyl and butyl group; an alkoxy group having 1-4 carbon atoms such as a methoxy, ethoxy, propoxy and butoxy group; a halogen atom such as chlorine and bromine; a nitro group; a cyano group; a mercapto group; a lower alkyl carboxyl group; a carboxyl group or a carbamoyl group.

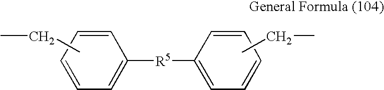

In the formula, R⁵ is an oxygen atom, a sulfur atom, a methylene group, NH, SO, SO₂, C(CF₃)₂ or C(CH₃)₂

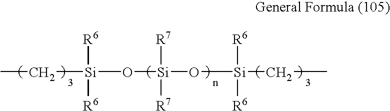

In the formula, R⁶ is an alkyl group or an aryl group having 1-4 carbon atoms such as a methyl, ethyl, propyl and butyl group. “n” is an integer of 0-2,000. R⁷ is an alkyl group or an aryl group having 1-4 carbon atoms such as a methyl, ethyl, propyl and butyl group. Further, R⁷ is a group selected from the groups represented by following General Formula (106).

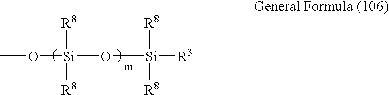

In the formula, R⁸ is an alkyl group or an aryl group having 1-4 carbon atoms, such as a methyl, ethyl, propyl and butyl group. “m” is an integer of 0-100.

The compound containing two oxetane rings is exemplified by the following compounds.

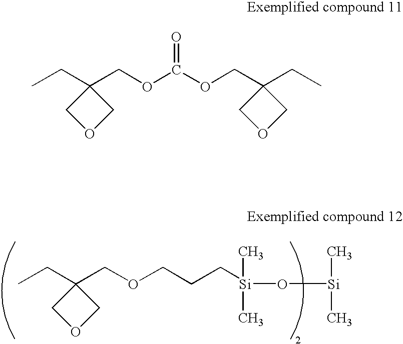

Exemplified compound 11 is a compound which R¹ is an ethyl group and R³ is a carboxyl group in aforementioned General Formula (102). Further, Exemplified compound 12 is a compound which P1 is an ethyl group, R³ is R⁶ and R⁷ being a methyl group in aforementioned General Formula (105), and “n” is 1 in aforementioned General Formula (102).

In the compound containing two oxetane rings, the preferably used examples other than the aforementioned compounds, are these represented by following General Formula (107).

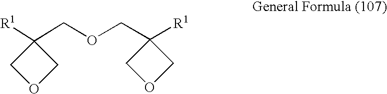

In the formula, R¹ is synonymous with R¹ of aforementioned General Formula (101).

Examples of the compound containing 3-4 oxetane rings include a compound represented by following General Formula (108).

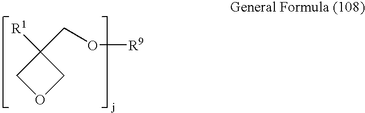

In the formula, R¹ is synonymous with R¹ of aforementioned General Formula (101). R⁹ is, for example, a branched alkylene group having 1-12 carbon atoms such as a group shown by following A-C, a branched poly(alkyleneoxy) group such as a group represented by following D, and a branched polysiloxy group such as a group shown by following E. “j” is either 3 or 4.

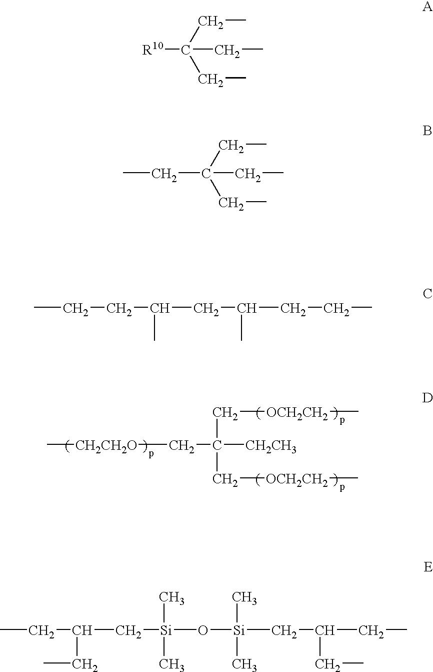

In above A, R¹⁰ is a lower alkyl group such as a methyl, ethyl or propyl group. In above D, “p” is an integer of 1-10.

Exemplified compound 13 may be mentioned as an example of the compound containing 3-4 oxetane rings.

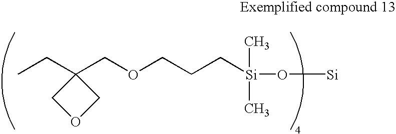

The compound containing 1-4 octane rings other than those explained above is compounds represented by following General Formula (109).

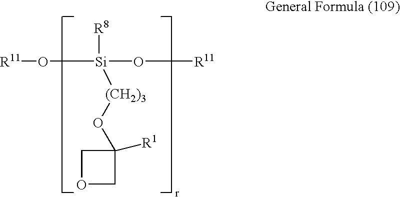

In this formula, R⁸ is synonymous with R⁸ of aforementioned General Formula (106). R¹¹ is an alkyl group or a trialkyl silyl group having 1-4 carbon atoms such as a methyl, ethyl, propyl or a butyl group. “r” is 1-4.

The specific examples of the oxetane compounds preferably used in the present invention include the following compounds.

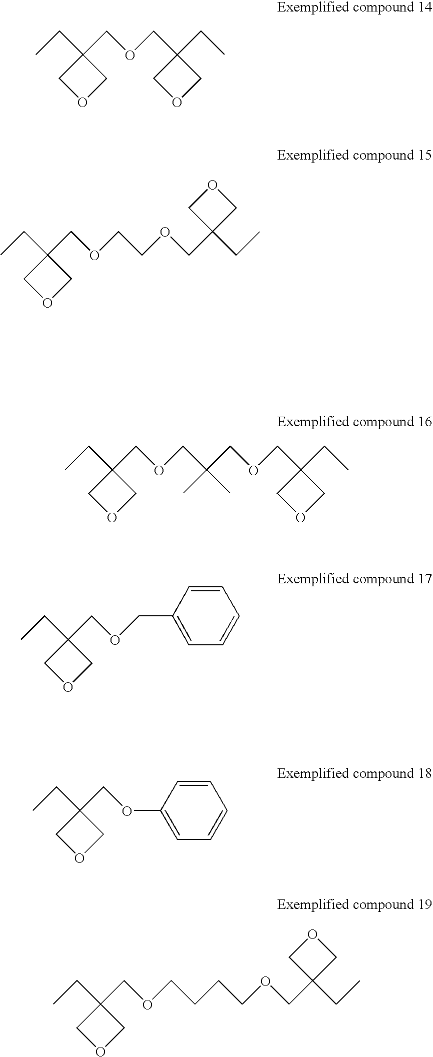

There is no particular restriction to the method of manufacturing the compound containing the aforementioned oxetane rings. A conventional method can be utilized. For example, there is a method to synthesize oxetane ring from diol disclosed by Pattison [D. B. Pattison, J. A m. Chem. Soc., 3455, 79 (1957)]. Further, other than that, it is possible to list a high polymer compound containing 1-4 octane rings and having a molecular weight of about 1,000-5,000. Specific examples of these compounds are described below. 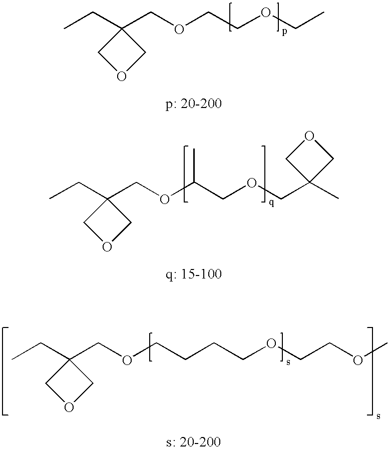
(Vinyl Ether Group-Containing Compound)

Examples of vinyl ether compounds include di- or trivinyl ether compounds such as ethylene glycol divinyl ether, diethylene glycol divinyl ether, tri ethylene glycol divinyl ether, propylene glycol divinyl ether, dipropylene glycol divinyl ether, butanediol divinyl ether, hexane diol divinyl ether, cyclohexane dimethanol divinyl ether and trimethylolpropane trivinyl ether; and monovinyl ether compounds such as ethylvinyl ether, butyl vinyl ether, i-butyl vinyl ether, octadecyl vinyl ether, cyclohexylvinyl ether, hydroxybutyl vinyl ether, 2-ethylhexylvinyl ether, cyclohexan dimethanol monovinyl ether, propylvinyl ether, i-propylvinyl ether, i-propenyl ether-O-propylene carbonate, dodecyl vinyl ether, diethylene glycol monovinyl ether and octadecyl vinyl ether.

When using a compound containing one or more polymerizable groups, a single compound can be used independently or more than one compounds can be mixed for use. When more than one compounds can be mixed for use, it is possible to mix the compounds containing two or more kinds of radical polymerizable groups. The compound containing two or more kinds of cation polymerizable compounds can be mixed. One or more compounds containing a radical polymerizable group and one or more compounds containing a cation polymerizable group can be mixed. The polymerizable compound of the present invention is oil-soluble, and is used as a solvent or dispersant for various types of components which can be added to the compound of the present invention.

(Polymerization Initiator)

Next, the polymerization initiator will be described bellow. There is no particular restriction to the polymerization initiator if it is capable of polymerizing the polymerizable compound of the present invention by giving some form of energy such as heat or light. The content of polymerization initiator is preferably 0.2-20 parts by mass, based on 100 parts by mass of the polymerizable compound. In cases when the content of polymerization initiator is less than 0.2 parts by mass, it will be difficult to get a cured object. When it exceeds 20 parts of mass, further improvement in curability cannot be expected. One or more kinds of polymerization initiators can be selected for use. A radical polymerization initiator or a cation polymerization initiator can be used as the polymerization initiator.

In the present invention, to enhance curability by active ray irradiation, use of a photo-polymerization initiator is preferred. The photo-polymerization initiator is preferably characterized in such that no thermal decomposition occurs until temperature reaches 70° C. In cases when the initiator which is subjected to thermal decomposition below 70° C., product storage problems will arise. This must be avoided.

(Photo-Radical Polymerization Initiator)

Examples of photo-radical polymerization initiators include acetophenone; 2,2-diethoxy acetophenone; p-dimethylamino acetophenone; benzophenone; 2-chlorobenzophenone; p,p′-dichlorobenzophenone; p,p′-bisdiethylaminobenzophenone; Michler's ketone; benzyl; benzoyl; benzoylmethyl ether; benzoylethyl ether; benzoylisopropyl ether; benzoyl-n-propyl ether; benzoylisobutyl ether; benzoyl-n-butyl ether; benzyl methylketal; thioxanthone; 2-chlorothioxanthone; 2-hydroxy-2-methyl-1-phenyl-1-on; 1-(4-i-propylphenyl)-2-hydroxy-2-methylpropane-1-on; methylbenzoyl formate; 1-hydroxycyclohexylphenyl ketone; azo bis-1-butyronitrile; benzoyl peroxide; and di-t-butyl peroxide. These polymerization initiators can be used independently or in combination of plural kinds.

(Sensitizer)

Further, a sensitizer can be used in the present invention. The sensitizer is not activated independently by exposure to light. When it is used in combination with a photo-polymerization initiator, greater advantages will be provided than when the photo-polymerization initiator is used independently. It is possible to use the conventionally known ones such as a triplet sensitizer, an electron mobility sensitizer and a redox sensitizer. The photo-sensitizer has a characteristic absorption band preferably in the long wave range of the ultraviolet ray, for example, in the long wave range of more than 300 nm. Examples of sensitizers include a cyclic amine based compound such as an aliphatic amine, an amine containing an aromatic group, or piperidine; a urea based compound such as o-tolylthio urea; a sulfur compound such as soluble salts of sodium diethylthiophosphate or aromatic sulfinic acid; a nitrile compound such as N,N′-disubstituted-p-aminobenzonitrile; a phosphorus compound such as tributyl phosphine or sodium diethyldithio phosphade; Michler's ketone; an N-nitrosohydroxyl amine derivative; an oxazolidine compound; a tetrahydro-1,3-oxazine compound; formaldehyde; or a nitrogen compound such as a condensate between acetoaldehyde and diamine. One of these sensitizers or a combination of them can be used.

(Photo-Cation Polymerization Initiator)

A chemical amplification type photoresist or a compound used in photo cation polymerization is used as a photo-cation polymerization initiator (please refer to “Organic Material for Imaging”, edited by Organic Electronic Material Laboratory, Bun-Shin Publication, Co., Ltd., 1993, pp. 187-192). Examples of the compounds preferably used in the present invention will be described below.

In the first place, listed are a BF₄⁻, B(C₆F₅)₄⁻, and AsF₆⁻ salt and a sulfonate such as a p—CH₃—C₆H₄—SO₃⁻ salt and a CF₃SO₃⁻ salt, of aromatic onium compounds such as a diazonium, ammonium, iodonium, sulfonium and phosphonium compound. The compound containing a borate compound and PF₆⁻ salt are preferably used as a counter anion because of excellent oxygen generation capability. Examples of the specifically typical onium compounds are shown below.

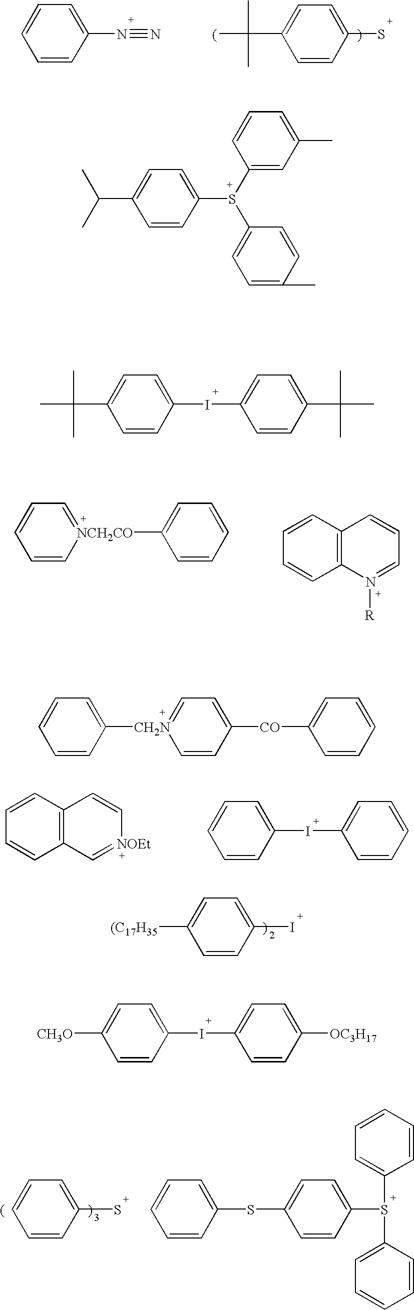

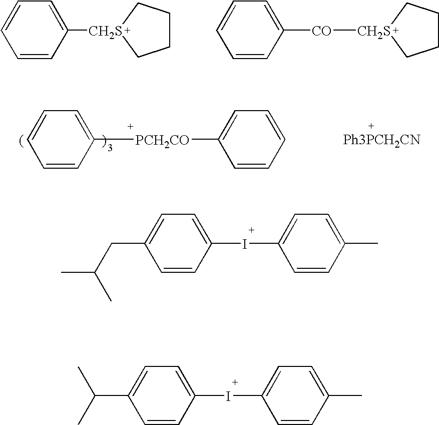

Secondly, the sulfonate compound, which generates sulfonic acid, can be described. Examples of the specific compounds will be shown below.

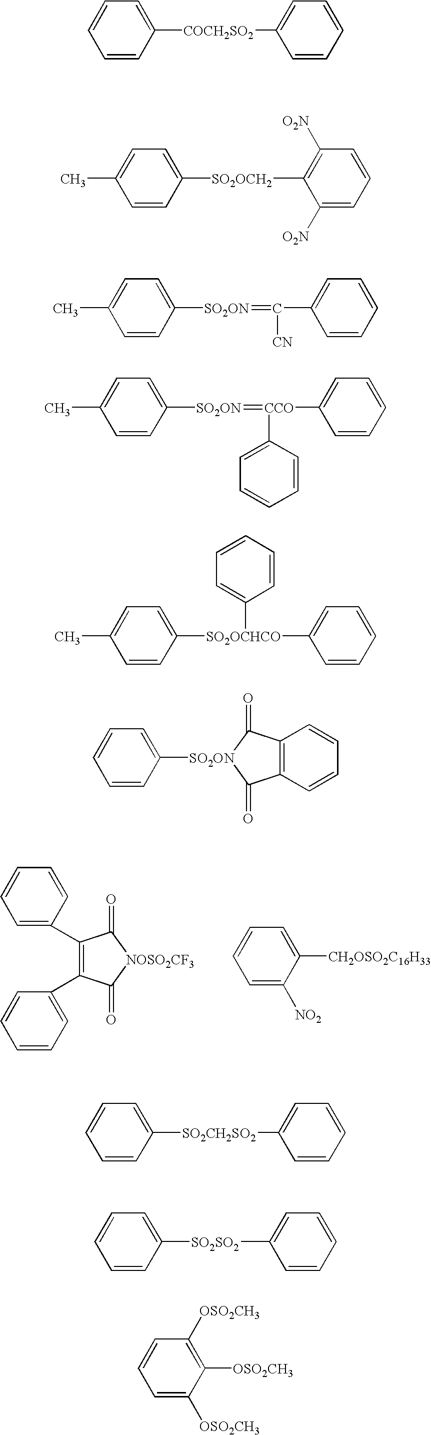

Thirdly, the halogen compound, which generates hydrogen halide can also be used. Examples of the specific compounds will be shown below.

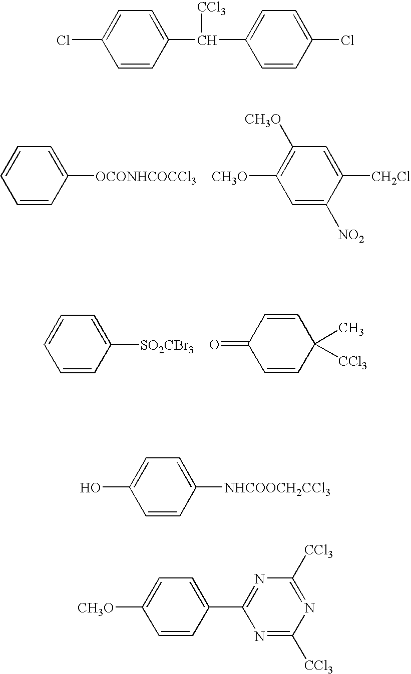

Fourthly, a ferrite allene complex can be listed.

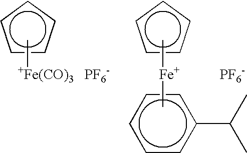

Examples of the photo cation polymerization initiator used in the present invention include an aryl sulfonium salt derivative (such as Thyracuse UV 1-6990 and Thyracure UV I-6974, produced by Union Carbide Co., Ltd.; and Adecaoptomer SP-150, Adecaoptomer SP-152, Adecaoptomer SP-170 and Adecaoptomer SP-172, produced by Asahi Denka Co., Ltd.); an aryl iodonium salt derivative (such as RP-2074, produced by Rhodia Corp.); an allene ion complex derivative (such as Irgacure 261 produced by Ciba Geigie AG); a diazonium salt derivative, a triazine based initiator and an acid generating agent such as a halogen compound. One or more than one of these photo cation polymerization initiators can be selected for use.

(Sulfonium Salt)

The preferable photo cation polymerization initiator is an aryl sulfonium salt compound represented by following General Formula (b).

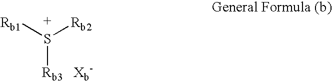

In the formula, R^{b1}-R_{b3} are substituents, and may be the same or differ. There is no restriction to these substituents. As examples, listed are an alkyl group (such as a methyl, ethyl, propyl, i-propyl, t-butyl pentyl, hexyl, octyl, dodecyl, tridesyl, tetradesyl pentadesyl, cyclopentyl and cyclohexyl group), an alkenyl group (such as a vinyl and alyl group), an alkynyl group (such as an ethynyl and propargyl group), an aromatic carbohydrate group (such as a phenyl and naphthyl group), a complex aromatic group (such as a furyl, thienyl, pyridyl, pyridazyl, pyrimidyl, pyrazyl, triazyl, imidazolyl, pyrazoyl, thiazolyl, benzoimidazolyl, benzooxazolyl, quinazolyl and phthalazyl group), and a heterocyclic ring group (such as a pyrrolidyl, imidazolydyl, morpholyl and oxazolidyl group). The substituents denoted by these R_{b1}-R_{b2} may have further substituents. In addition to the aforementioned alkyl group, alkenyl group, alkynyl group, aromatic carbohydrate group, complex aromatic group and heterocyclic ring group, the groups which can be substituted by these substituents are an alkoxy group (such as a methoxy, ethoxy, propoxy, pentyloxy, hexyloxy, octyloxy and dodecyloxy group), a cycloalkoxy group (such as cyclopentyloxy and cyclohexyloxy group), an aryloxy group (such as a phenoxy and naphtoxy group), an alkylthio group (such as a methylthio, ethylthio, propylthio, pentylthio, hexylthio, octylthio and dodecylthio group), a cycloalkylthio group (such as a cyclopentylthio and cyclohexylthio group), an arylthio group (such as a phenylthio and naphthylthio group), an alkoxy carbonyl group (such as a methoxycarbonyl, ethoxycarbonyl, butoxycarbonyl, octyloxycarbonyl and dodecyloxycarbonyl group), an aryloxycarbonyl group (such as a phenoxy carbonyl and naphtoxy carbonyl group), a sulfamoyl group (such as an aminosulfonyl, methylaminosulfonyl, dimethylaminosulfonyl, butyl aminosulfonyl, hexylaminosulfonyl, cyclohexylaminosulfonyl, octyl aminosulfonyl, dodecyl aminosulfonyl, phenylaminosulfonyl, naphthylaminosulfonyl and 2-pyridyl aminosulfonyl group), an acyl group (such as an acetyl, ethylcarbonyl, propylcarbonyl, pentylcarbonyl, cyclohexylcarbonyl, octylcarbonyl, 2-ethylhexylcarbonyl, dodecyl carbonyl, phenylcarbonyl, naphthylcarbonyl and pyridyl carbonyl group), an acyloxy group (such as an acetyloxy, ethylcarbonyloxy, butylcarbonyloxy, octylcarbonyloxy, dodecyl carbonyloxy and phenylcarbonyloxy group), an amide group (such as a methylcarbonyl amino, ethylcarbonyl amino, dimethylcarbonyl amino, propylcarbonyl amino, pentylcarbonyl amino, cyclohexylcarbonyl amino, 2-ethylhexylcarbonyl amino, octylcarbonyl amino, dodecyl carbonyl amino, phenylcarbonyl amino and naphthylcarbonyl amino group), a carbamoyl group (such as an aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl and 2-pyridylaminocarbonyl group), a ureide group (such as a methylureide, ethylureide, pentylureide, cyclohexylureide, octyl ureide, dodecylureide, phenylureide, naphthylureide, and 2-pyridyl aminoureide group), a sulfonyl group (such as a methylsulfonyl, ethylsulfonyl, butylsulfonyl, cyclohexylsulfonyl, 2-ethylhexylsulfonyl, dodecylsulfonyl, phenylsulfonyl, naphthylsulfonyl, and 2-pyridylsulfonyl group), an alkyl sulfonyl group (such as a methylsulfonyl, ethylsulfonyl, butylsulfonyl, cyclohexylsulfonyl, 2-ethylhexylsulfonyl, and dodecyl-sulfonyl group), an aryl sulfonyl group (such as a phenylsulfonyl, naphthylsulfonyl and 2-pyridylsulfonyl group), an amino group (such as an amino, ethylamino, dimethylamino, butylamino, cyclopentylamino, 2-ethylhexylamino, dodecylamino, anilino, naphthylamino, and 2-pyridylamino group), a halogen atom (such as fluorine and chlorine, bromine), a hydrocarbon fluoride group (such as a fluoromethyl, trifluoromethyl, pentafluoroethyl and pentafluorophenyl group), a cyano group, a nitro group, a hydroxyl group, a mercapto group, a silyl group (such as a trimethylsilyl, tri-i-propylsilyl, triphenylsilyl and phenyldiethylsilyl group), and a carboxyl group. These substituents can be substituted by the aforementioned substituents. Further, these substituents may be bonded with one another to form a ring. R_{b1}-R_{b3} may be bonded with one another to form a ring.

R^{b1}-R_{b3} are preferably an alkyl group and an aromatic carbohydrate group. They may have a further substituent. Such a substituent can be exemplified by the group which can be substituted by substituents represented by aforementioned R_{b1}-R_{b3}.

X_{b}⁻ is a counter ion, and the counter anion includes a halogen ion such as F⁻, Cl⁻ and Br⁻; a complex ion such as BF₄⁻, B(C₆F₅)₄⁻, PF₆⁻, AsF₆⁻, SbF₆⁻ and GaF₆⁻; and a sulphonate ion such as a benzene sulfonic acid ion (p-CH₃—C₆H₄—SO₃⁻, and C₆H₅SO₃⁻), an alkyl sulfonic acid ion (CH₃SO₃⁻, and C₂H₅SO₃⁻), a fluoroalkyl sulfonic acid ion (CF₃SO₃⁻, C₂F₅SO₃⁻, and C₉F₁₉SO₃⁻) a fluoroalkyl benzene sulfonic acid ion (p-CF₃—C₆H₄SO₃⁻, and p-CF₃—C₆F₄SO₃⁻), and a fluorobenzene sulfonic acid ion (p-F—C₆H₄SO₃⁻, and C₆F₅SO₃⁻). The counter anion is more preferably PF₆⁻, BF₄⁻, SbF₆⁻, GaF₆⁻, AsF₆⁻, B(C₆F₅)₄⁻, and fluoroalkyl sulfonic acid ion, and still more preferably BF₄⁻, B(C₆F₅)₄⁻ and PF₆⁻.

The compound represented by General Formula (b) is preferably any one of the sulfonium salts represented by following General Formulas (I-1), (I-2) and (I-3).

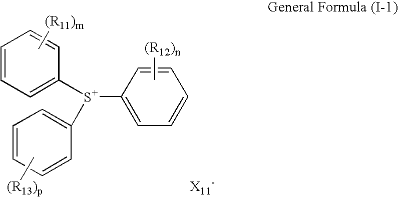

In the formula, R₁₁, R₁₂ and R₁₃ are substituents, and m, n and p are each an integers of 0-5. X₁₁⁻ is a counter ion.

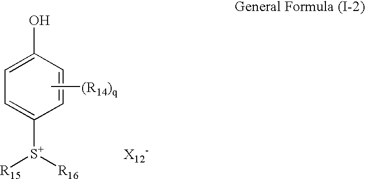

In the formula, R₁₄ is a substituent, and “q” is an integer of 0-2. R₁₅ and R₁₆ are each an alkyl group, alkenyl group, alkynyl group or aryl group, all of which are substituted or unsubstituted. X₁₂⁻ is a counter ion.

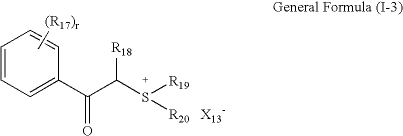

In the formula, R₁₇ is a substituent, and “r” is an integer of 0-3. R₁₈ is a hydrogen atom, an alkyl group, an alkenyl group, an alkynyl group or an aryl group, which groups are substituted or unsubstituted. X₁₃⁻ is a counter ion.

In General Formula (I-1), the substituent groups represented by R₁₁, R₁₂ and R₁₃ are a halogen atom (such as chlorine, bromine and, fluorine), an alkyl group having 1-6 carbon atoms (such as a methyl, ethyl, propyl, i-propyl and butyl group), a cycloalkyl group having 3-6 carbon atoms (such as a cyclopropyl, cyclobutyl, cyclopentyl, and cyclohexyl group), an alkenyl group having 1-6 carbon atoms (such as a vinyl, 1-propenyl, 2-propenyl and 2-butenyl group), an alkynyl group having 1-6 carbon atoms (such as an acetylenyl, 1-propinyl, 2-propinyl and 2-butynyl group), an alkoxy group having 1-6 carbon atoms (such as a methoxy, ethoxy, propoxy, i-propoxy, butoxy and t-butoxy group), an alkylthio group having 1-6 carbon atoms (such as a methylthio, ethylthio, propylthio, i-propylthio, butylthio, and t-butylthio group), an aryl group having 6-14 carbon atoms (such as a phenyl, naphthyl and anthracenyl group), an aryloxy group having 6-10 carbon atoms (such as a phenoxy and naphtoxy group), an arylthio group having 6-10 carbon atoms (such as a phenylthio and naphthylthio group), an acyl group (such as an acetyl, propionyl, trifluoroacetyl and benzoyl group), an acyloxy group (such as an acetoxy, propionyloxy, trifluoroacetoxy and benzoyloxy group), an alkoxy carbonyl group (such as a methoxycarbonyl, ethoxycarbonyl and t-butoxycarbonyl group), and an aromatic cyclic group including a hetero atom having 4-8 carbon atoms (such as a furyl and thienyl group), and a nitro group, a cyano group. The substituent is preferably a halogen atom, an alkyl group, an alkyloxy group, an aryl group, an aryloxy group, an arylthio group and an acyl group. Of these substituents, those, which can be substituted, may be further substituted.

m, n and p are each an integer of 0-5. Each of them is preferably 1 or more.

The counter anion expressed by X₁₁⁻ is the same counter anion as X_{b}⁻ of aforementioned General Formula (b).

In General Formula (I-2), the substituents represented by R₁₄ are a halogen atom (such as chlorine, bromine and fluorine), an alkyl group having 1-6 carbon atoms (such as a methyl, ethyl, propyl, i-propyl and butyl group), a cycloalkyl group having 3-6 carbon atoms (such as a cyclopropyl, cyclobutyl, cyclopentyl and cyclohexyl group), an alkenyl group having 1-6 carbon atoms (such as a vinyl, 1-propenyl, 2-propenyl and 2-butenyl group), an alkynyl group having 1-6 carbon atoms (such as an acetylenyl, 1-propinyl, 2-propinyl and 2-butynyl group), an alkoxy group having 1-6 carbon atoms (such as a methoxy, ethoxy, propoxy, i-propoxy and butoxy, t-butoxy group), an alkylthio group having 1-6 carbon atoms (such as a methylthio, ethylthio, propylthio, i-propylthio, butylthio and t-butylthio group), an aryl group having 6-14 carbon atoms (such as a phenyl, naphthyl and anthracenyl group), an aryloxy group having 6-10 carbon atoms (such as a phenoxy, and naphtoxy group), an arylthio group having 6-10 carbon atoms (such as a phenylthio and naphthylthio group), an acyl group (such as an acetyl, propionyl, trifluoroacetyl and benzoyl group), an acyloxy group (such as an acetoxy, propionyloxy, trifluoroacetoxy and benzoyloxy group), an alkoxy carbonyl group (such as a methoxycarbonyl, ethoxycarbonyl and t-butoxycarbonyl group), an aromatic cyclic group including a hetero atom having 4-8 carbon atoms (such as a furyl and thienyl group), and a nitro group and a cyano group. They are preferably a halogen atom, an alkyl group, an aryl group, an alkoxy group and an aryloxy group. Of these substituents, those which can be substituted, may be further substituted, if possible.

“q” is an integer of 0-2 and is preferably 1 or more, and more preferably 2.

R₁₅ and R₁₆ are each an alkyl group, an alkenyl group, an alkynyl group or an aryl group, which groups may be substituted or unsubstituted.

Examples of the substituent include a halogen atom (such as chlorine, bromine and fluorine), an alkyl group having 1-6 carbon atoms (such as a methyl, ethyl, propyl, i-propyl and butyl group), a cycloalkyl group having 3-6 carbon atoms (such as a cyclopropyl, cyclobutyl, cyclopentyl and cyclohexyl group), an alkenyl group having 1-6 carbon atoms (such as a vinyl, 1-propenyl, 2-propenyl and 2-butenyl group), an alkynyl group having 1-6 carbon atoms (such as an acetylenyl, 1-propinyl, 2-propinyl and 2-butynyl group), an alkoxy group having 1-6 carbon atoms (such as a methoxy, ethoxy, propoxy, i-propoxy, butoxy and t-butoxy group), an alkylthio group having 1-6 carbon atoms (such as an methylthio, ethylthio, propylthio, i-propylthio, butylthio and t-butylthio group), an aryl group having 6-14 carbon atoms (such as a phenyl, naphthyl and anthracenyl group), an aryloxy group having 6-10 carbon atoms (such as a phenoxy and naphtoxy group), an arylthio group having 6-10 carbon atoms (such as a phenylthio and naphthylthio group), an acyl group (such as an acetyl, propionyl, trifluoroacetyl and benzoyl group), an acyloxy group (such as an acetoxy, propionyloxy, trifluoroacetoxy and benzoyloxy group), an alkoxy carbonyl group (such as a methoxycarbonyl, ethoxycarbonyl and t-butoxycarbonyl group), an aromatic cyclic group including a hetero atom having 4-8 carbon atoms (such as a furyl and thienyl group), a nitro group, a cyano group, and a hydroxyl group. They are preferably a halogen atom, an alkyl group, an alkoxy group, an aryloxy group and an acyl group.

R₁₅ and R₁₆ are each preferably a substituted or unsubstituted alkyl and aryl group. The substituent is preferably a halogen atom, an alkyl group, an alkoxy group, an aryl group, an aryloxy group, an acyl group and a hydroxyl group.

The counter anion expressed by X₁₂⁻ is the same counter anion as X_{b}⁻ of aforementioned General Formula (b).

In General Formula (I-3), the substituent shown by R₁₇ is a halogen atom (such as chlorine, bromine and fluorine), an alkyl group having 1-6 carbon atoms (such as a methyl, ethyl, propyl, i-propyl and butyl group), a cycloalkyl group having 3-6 carbon atoms (such as a cyclopropyl, cyclobutyl, cyclopentyl and cyclohexyl group), an alkenyl group having 1-6 carbon atoms (such as a vinyl, 1-propenyl, 2-propenyl and 2-butenyl group), an alkynyl group having 1-6 carbon atoms (such as an acetylenyl, 1-propinyl, 2-propinyl and 2-butynyl group), an alkoxy group having 1-6 carbon atoms (such as a methoxy, ethoxy, propoxy, i-propoxy, butoxy and t-butoxy group), an aryl group having 6-14 carbon atoms (such as a phenyl, naphthyl and anthracenyl group), an acyl group (such as an acetyl, propionyl, trifluoroacetyl and benzoyl group), an acyloxy group (such as an acetoxy, propionyloxy, trifluoroacetoxy and benzoyloxy group), an alkoxy carbonyl group (such as a methoxycarbonyl, ethoxycarbonyl, and t-butoxycarbonyl group), an aryl group having 6-10 carbon atoms (such as a phenyl, naphthyl and anthracenyl group), an aromatic cyclic group including a hetero atom having 4-8 carbon atoms (such as a furyl and thienyl group), and a nitro group, and a cyano group. The substituent is preferably a halogen atom, an alkyl group, an alkoxy group, an aryl group, an aryloxy group and an acyl group.

“r” is an integer of 0-3, and is preferably 1 or more, and more preferably 2 or more.

R₁₈ is a hydrogen atom or a substituted or unsubstituted alkyl group, and R₁₉ and R₂₃ are each an alkyl group, an alkenyl group, an alkynyl group or an aryl group, which groups are substituted or unsubstituted.

Examples of the substituent include a halogen atom (such as chlorine, bromine and fluorine), an alkyl group having 1-6 carbon atoms (such as a methyl, ethyl, propyl and i-propyl, butyl group), a cycloalkyl group having 3-6 carbon atoms (such as a cyclopropyl, cyclobutyl, cyclopentyl and cyclohexyl group), an alkenyl group having 1-6 carbon atoms (such as a vinyl, 1-propenyl, 2-propenyl and 2-butenyl group), an alkynyl group having 1-6 carbon atoms (such as an acetylenyl, 1-propinyl, 2-propinyl and 2-butynyl group), an alkoxy group having 1-6 carbon atoms (such as a methoxy, ethoxy, propoxy, i-propoxy, butoxy, and t-butoxy group), an aryl group having 6-14 carbon atoms (such as a phenyl, naphthyl and anthracenyl group), an acyl group (such as an acetyl, propionyl, trifluoroacetyl and benzoyl group), an acyloxy group (such as an acetoxy, propionyloxy, trifluoroacetoxy and benzoyloxy group), an alkoxy carbonyl group (such as a methoxycarbonyl, ethoxycarbonyl and t-butoxycarbonyl group), an aryl group having 6-10 carbon atoms (such as a phenyl, naphthyl and anthracenyl group), an aromatic cyclic group including a hetero atom having 4-8 carbon atoms (such as a furyl and thienyl group), a nitro group, and a cyano group. They are preferably a halogen atom, an alkyl group, an alkoxy group, an aryl group, an aryloxy group and an acyl group.

R₁₈ is preferably a hydrogen atom or an unsubstituted lower alkyl group (such as a methyl, ethyl and propyl group). R₁₉ and R₂₀ are each preferably an alkyl group, an aryl group, which are substituted or unsubstituted. The substituent is preferably a halogen atom, an alkyl group, an alkoxy group, an aryl group, an aryloxy group or an acyl group.

The same counter anion as the X₁₃⁻ of the aforementioned General Formula (b) will be described as the counter anion expressed by the X₁₃⁻.

Specific examples of the sulfonium salts represented by General Formulas (I-1)-(I-3), but the present invention is not limited thereto.

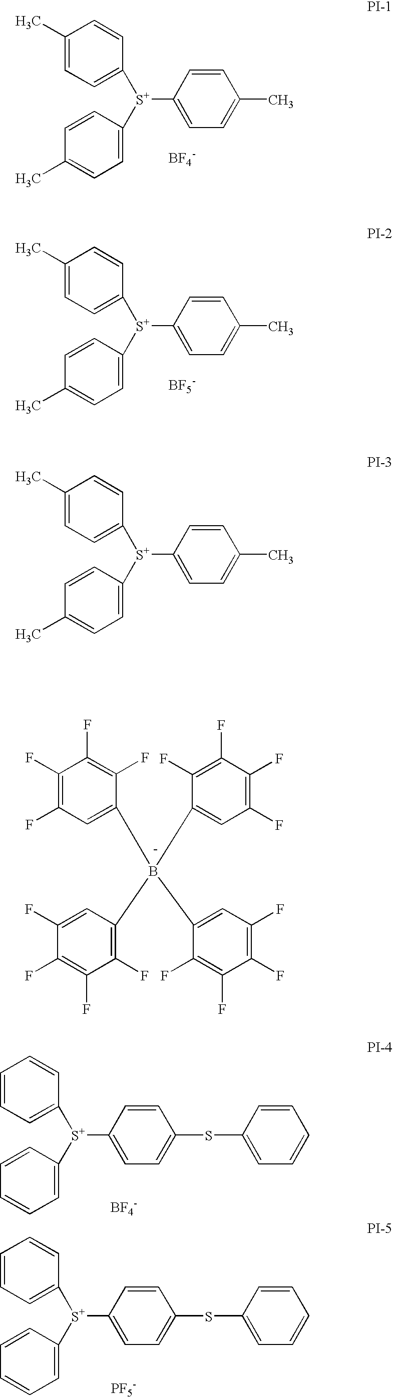

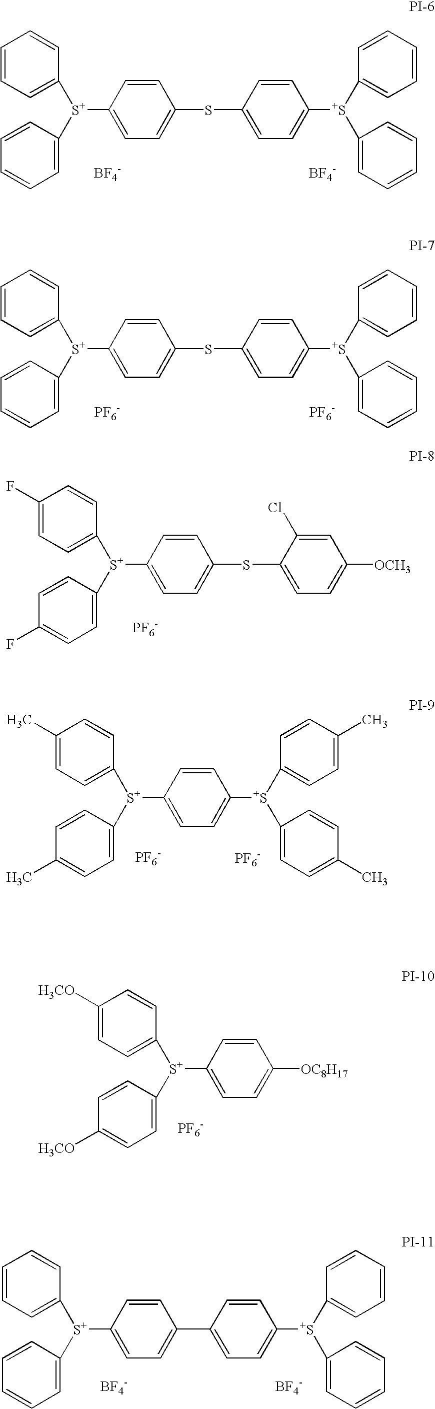

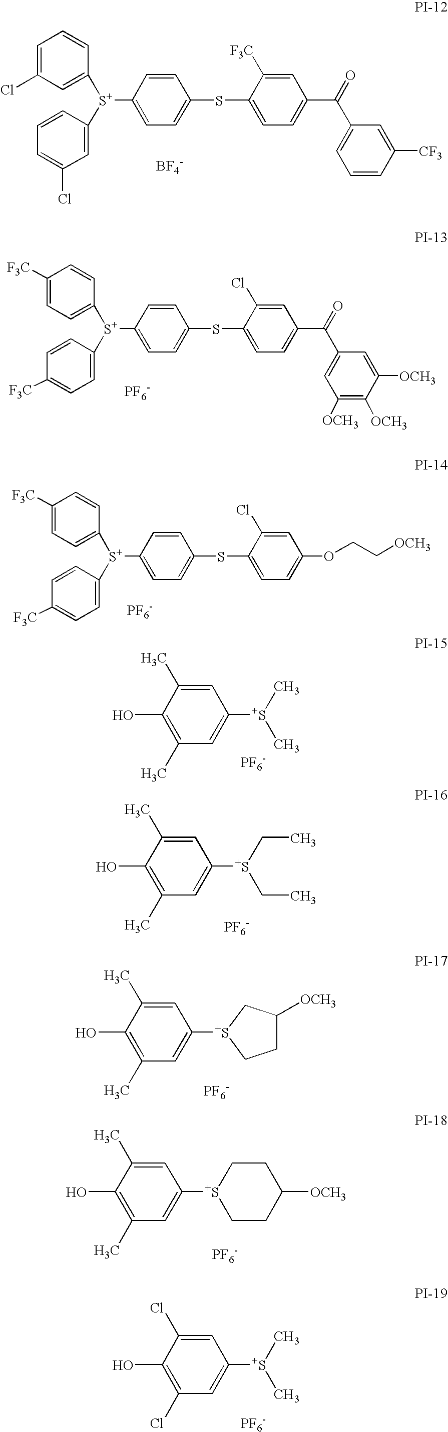

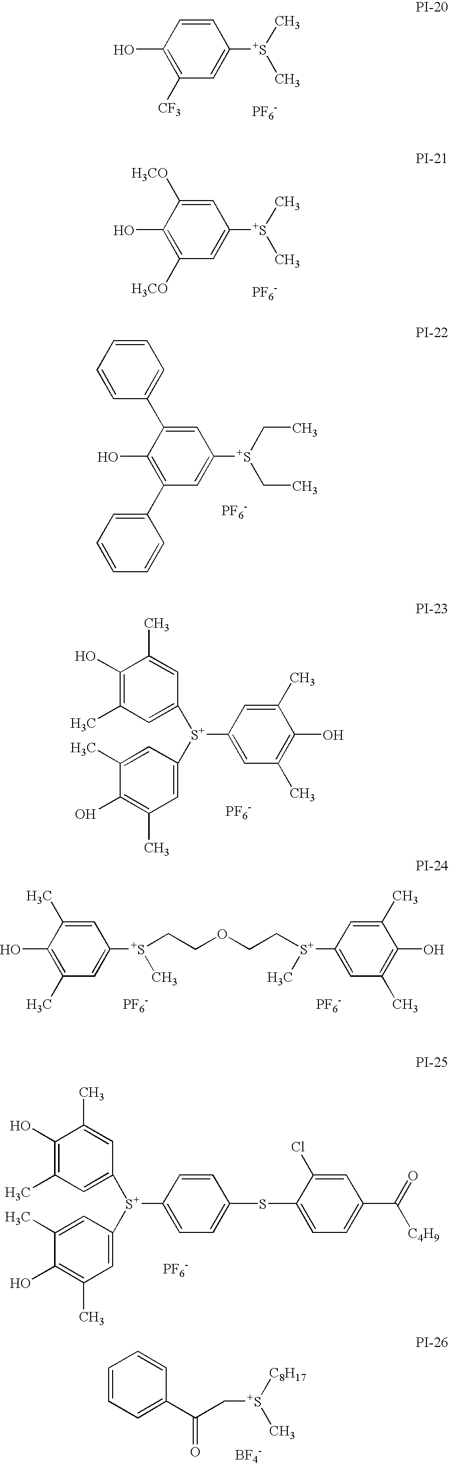

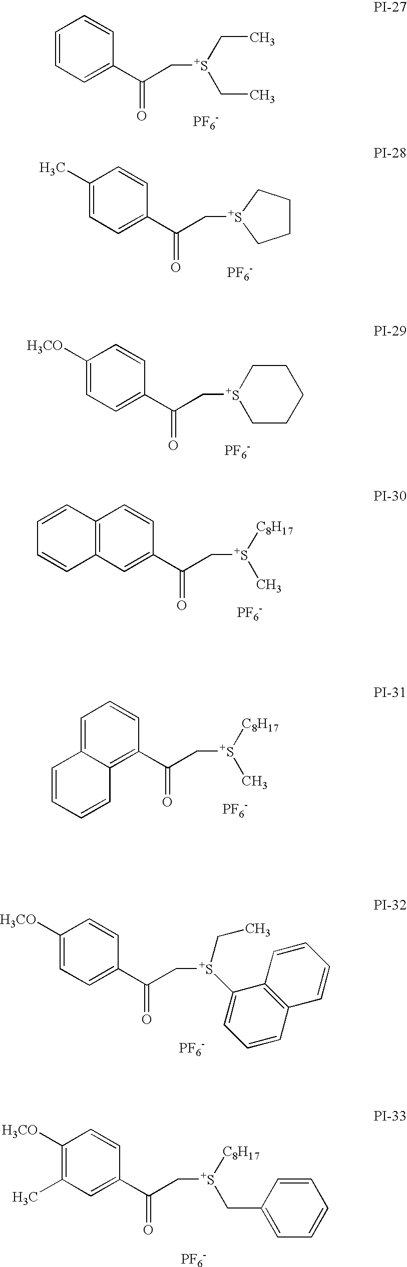

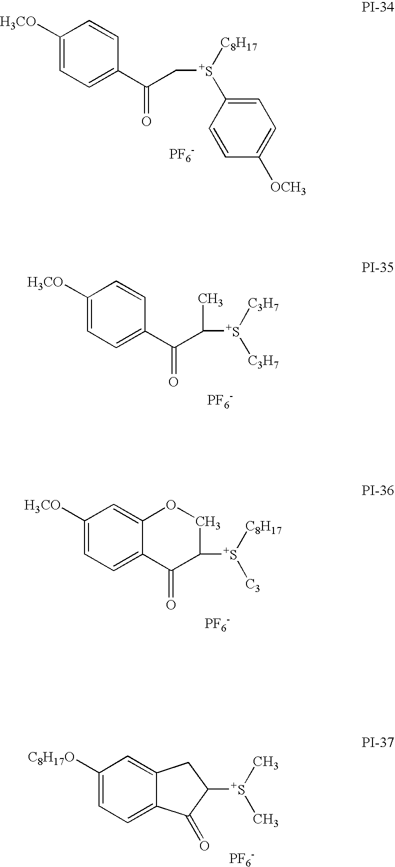

Further, the aforementioned General Formula (I-1) is more preferably the sulfonium salt represented by following General Formula (T-1).

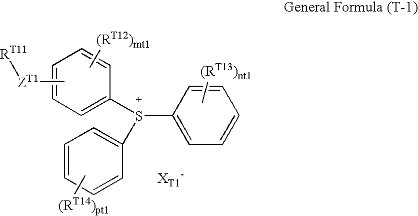

In the formula, R^{T11} and R^{T12} are each an alkyl group or an aromatic group. The alkyl group may be a straight-chained, branched or a cyclic group, and for example, it may be a methyl, ethyl, propyl, i-propyl, t-butyl, pentyl, hexyl, octyl, dodecyl, tridesyl, tetradesyl, pentadesyl, cyclopentyl and a cyclohexyl group. The aromatic group may be an aromatic carbohydrate ring group, an aromatic heterocyclic ring group, or a condensed ring group. Examples of the aromatic group include an aromatic carbohydrate group (such as a phenyl and naphthyl group), and an aromatic heterocyclic ring group (such as a furyl, thienyl, pyridyl, pyridazyl, pyrimidyl, pyrazyl, triazyl, imidazolyl, pyrazoyl, thiazolyl, benzoimidazolyl, benzooxazolyl, quinazolyl and phthalazyl group). The aforementioned alkyl group or aromatic group may have a further substituent. These substituents may be bonded to form a ring, or may have a condensed ring. In addition to the aforementioned alkyl group, the substituent is an alkenyl group (such as a vinyl and alyl group), an alkynyl group (such as an ethynyl and propargyl group), an aromatic carbohydrate group (such as a phenyl and naphthyl group), a complex aromatic group (such as a furyl, thienyl, pyridyl, pyridazyl, pyrimidyl, pyrazyl, triazyl, imidazolyl, pyrazoyl, thiazolyl, benzoimidazolyl, benzooxazolyl, quinazolyl and phthalazyl group), a heterocyclic ring group (such as a pyrrolidyl, imidazolydyl, morpholyl and oxazolidyl group), an alkoxy group (such as a methoxy, ethoxy, propyloxy, pentyloxy, hexyloxy, octyloxy and dodecyloxy group), a cycloalkoxy group (such as a cyclopentyloxy and cyclohexyloxy group), an aryloxy group (such as a phenoxy and naphthyloxy group), an alkylthio group (such as a methylthio, ethylthio, propylthio, pentylthio, hexylthio, octylthio and dodecylthio group), a cycloalkylthio group (such as a cyclopentylthio and cyclohexylthio group), an arylthio group (such as a phenylthio and naphthylthio group), an alkoxy carbonyl group (such as a methyloxycarbonyl, ethyloxycarbonyl, butyloxycarbonyl, octyloxycarbonyl and dodecyloxycarbonyl group), an aryl oxycarbonyl group (such as a phenyloxycarbonyl and naphthyloxycarbonyl group), a sulfamoyl group (such as an aminosulfonyl, methylaminosulfonyl, dimethylaminosulfonyl, butyl aminosulfonyl, hexylaminosulfonyl, cyclohexylaminosulfonyl, octyl aminosulfonyl, dodecyl aminosulfonyl, phenylaminosulfonyl, naphthylaminosulfonyl and 2-pyridyl aminosulfonyl group), an acyl group (such as an acetyl, ethylcarbonyl, propylcarbonyl, pentylcarbonyl, cyclohexylcarbonyl, octylcarbonyl, 2-ethylhexylcarbonyl, dodecyl carbonyl, phenylcarbonyl, naphthylcarbonyl and pyridyl carbonyl group), an acyloxy group (such as an acetyloxy, ethylcarbonyloxy, butylcarbonyloxy, octylcarbonyloxy, dodecyl carbonyloxy and phenylcarbonyloxy group), an amide group (such as a methylcarbonyl amino, ethylcarbonyl amino, dimethylcarbonyl amino, propylcarbonyl amino, pentylcarbonyl amino, cyclohexylcarbonyl amino, 2-ethylhexylcarbonyl amino, octylcarbonyl amino, dodecyl carbonyl amino, phenylcarbonyl amino and naphthylcarbonyl amino group), a carbamoyl group (such as an aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecyl aminocarbonyl, phenylaminocarbonyl, naphthylaminocarbonyl and 2-pyridyl aminocarbonyl group), a ureide group (such as a methylureide, ethylureide, pentylureide, cyclohexylureide, octyl ureide, dodecyl ureide, phenylureide, naphthylureide, and 2-pyridyl aminoureide group), a sulfonyl group (such as a methylsulfonyl, ethylsulfonyl, butyl sulfonyl, cyclohexylsulfonyl, 2-ethylhexylsulfonyl, dodecyl sulfonyl, phenylsulfonyl, naphthylsulfonyl and 2-pyridyl sulfonyl group), an alkyl sulfonyl group (such as a methylsulfonyl, ethylsulfonyl, butyl sulfonyl, cyclohexylsulfonyl, 2-ethylhexylsulfonyl and dodecyl sulfonyl group), an aryl sulfonyl group (such as a phenylsulfonyl, naphthylsulfonyl and 2-pyridyl sulfonyl group), an amino group (such as an amino, ethylamino, dimethylamino, butyl amino, cyclopentylamino, 2-ethylhexylamino, dodecyl amino, anilino, naphthylamino and 2-pyridyl amino group), a halogen atom (such as fluorine and chlorine, bromine), a hydrocarbon fluoride group (such as a fluoromethyl, trifluoromethyl, pentafluoroethyl and pentafluorophenyl group), and a cyano group, a nitro group, a hydroxyl group, a mercapto group, a silyl group (such as a trimethylsilyl, triisopropylsilyl, triphenylsilyl and phenyldiethylsilyl group). These substituents may be further substituted by the aforementioned substituents Further, these substituents may be bonded with another to form a ring. The alkyl group or the aromatic group represented by the R^{T11} and R^{T12} may either have or do not have a further substituent, but preferably an unsubstituted alkyl or aromatic group, or an alkyl group substituted by a halogen atom, or an aromatic group substituted by an alkoxy group. It is more preferably an unsubstituted alkyl or aromatic group, or an alkyl group substituted by a fluorine atom, or an aromatic group substituted by an alkoxy group Examples of the alkyl group substituted by the fluorine atom include a fluoromethyl, trifluoromethyl, pentafluoroethyl and pentafluorophenyl group.

Z^{T1} is an oxygen atom or a sulfur atom, and preferably bonds to the benzene ring at the ortho position or para position, provided that the benzene ring is bonded by the sulfonium ion, and more preferably bonded at the para position. The R^{T13} and R^{T14} are each an alkyl group, an aromatic group, an alkoxy group, an aryloxy group, an alkylthio group, and an arylthio group. The alkyl group and aromatic group are a group synonymous with the aforementioned R^{T11} and R^{T12}. The alkoxy group and aryloxy group are the groups formed by the group synonymous with the aforementioned R^{T11} and R^{T12} being bonded to the oxygen atom at one position, examples of which include an alkoxy group (such as a methoxy, ethoxy, propoxy, pentyloxy, hexyloxy, octyloxy, dodecyloxy, fluoromethyl, trifluoromethyl, pentafluoroethyl and pentafluorophenyl group), a cycloalkoxy group (such as a cyclopentyloxy and cyclohexyloxy group), and an aryloxy group (such as a phenoxy and naphthyloxy group). The alkylthio group and arylthio group are the groups formed by the group synonymous with the aforementioned R^{T11} and R^{T12} being bonded to the sulfur atom at one position, examples of which include an alkylthio group (such as a methylthio, ethylthio, propylthio, pentylthio, hexylthio, octylthio and dodecylthio group), a cycloalkylthio group (such as a cyclopentylthio and cyclohexylthio group), an arylthio group (such as a phenylthio and naphthylthio group). The aforementioned aromatic group and aryloxy group, arylthio group may have a condensed ring. The aforementioned alkyl group, aromatic group, alkoxy group, aryloxy group, alkylthio group and arylthio group may have a further substituent. A plurality of these substituents may be bonded to one another to form a ring, or may have a condensed ring. Examples of the substituent may be the group synonymous with the example of the substituent of aforementioned R^{T11}. The substituent may further be substituted by a substituent. A plurality of these substituents may be bonded one another to form a ring.

The alkyl group, aromatic group, alkoxy group, aryloxy group, alkylthio group and arylthio group represented by R^{T13} and R^{T14} may either have or do not have a further substituent. They are preferably an alkyl, aromatic, alkoxy, aryloxy, alkylthio or an arylthio group, all of which groups are unsubstituted, and further, they are an alkyl group substituted by a halogen atom, or the aromatic group substituted by an alkoxy group, and more preferably an unsubstituted alkyl, aromatic, alkoxy, aryloxy, alkylthio or arylthio group. Further, they are an alkyl group substituted by a fluorine atom, or the aromatic group substituted by an alkoxy group. Examples of the alkyl group substituted by a fluorine atom include a fluoromethyl, trifluoromethyl, pentafluoroethyl, and pentafluorophenyl group.

“mt1” is an integer of 0-4, preferably an integer of 0-3, and more preferably an integer of 0-2. “nt1” and “pt1” are each integers of 1-5, preferably integers of 1-3, and more preferably integers of 1-2. A plurality of R^{T12}, R^{T13} and R^{T14} may be the same or differ from each another. R^{T11} and R^{T12}, or a plurality of R^{T12}s may be bonded to form a ring. R^{T12} and R^{T13}, or a plurality of R^{T13}s may be bonded to form a ring. R^{T12} and R^{T14}, or a plurality of R^{T14} may be bonded to form a ring. R^{T12} and R^{T14} may be bonded to form a ring. At least one of the R^{T13}s is preferably bonded at the ortho position or para position of the benzene ring bonded with a sulfonium ion, and more preferably bonded at the para position. At least one of the R^{T14}s is preferably bonded at the ortho position or para position of the benzene ring bonded with a sulfonium ion, and more preferably bonded at the para position.

X_{T1}⁻ is a counter anion, and is the same counter anion as the X_{b}⁻ of aforementioned General Formula (b).

Specific examples of the compound represented by General Formula (T-1) below, but the present invention is not limited thereto. 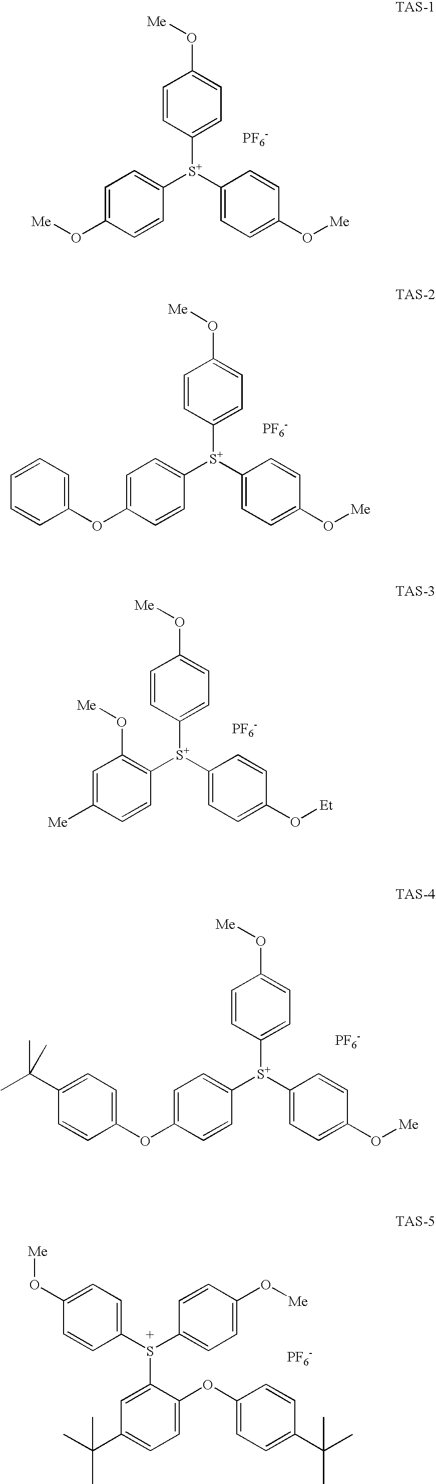 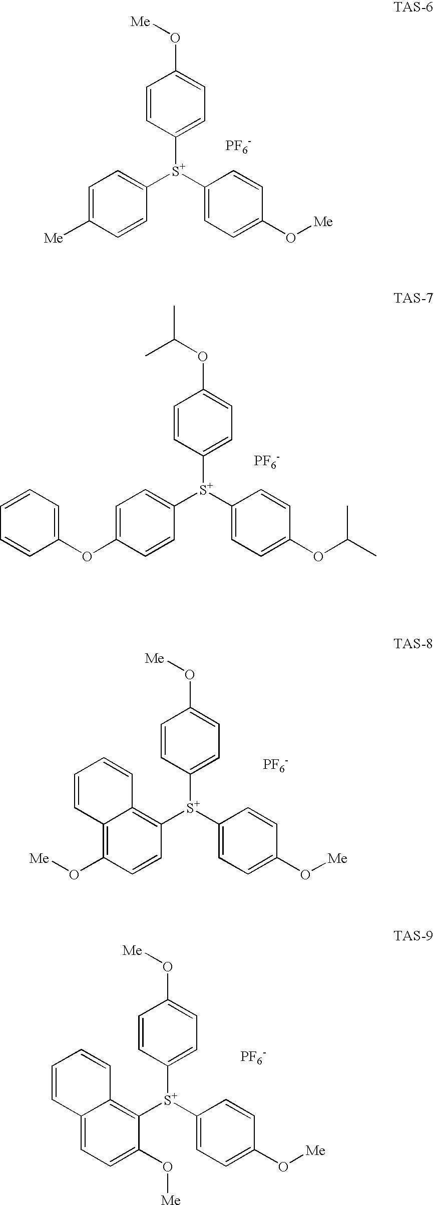 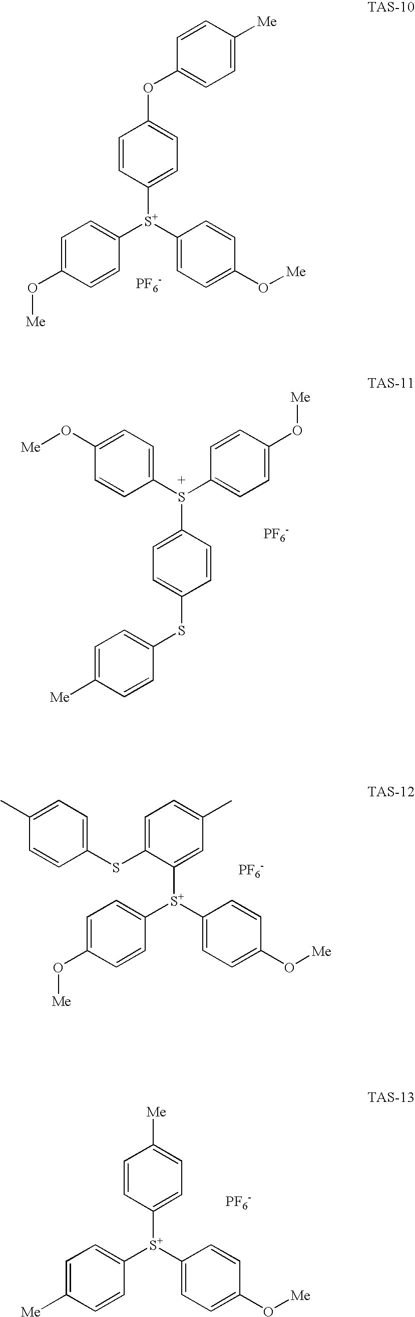 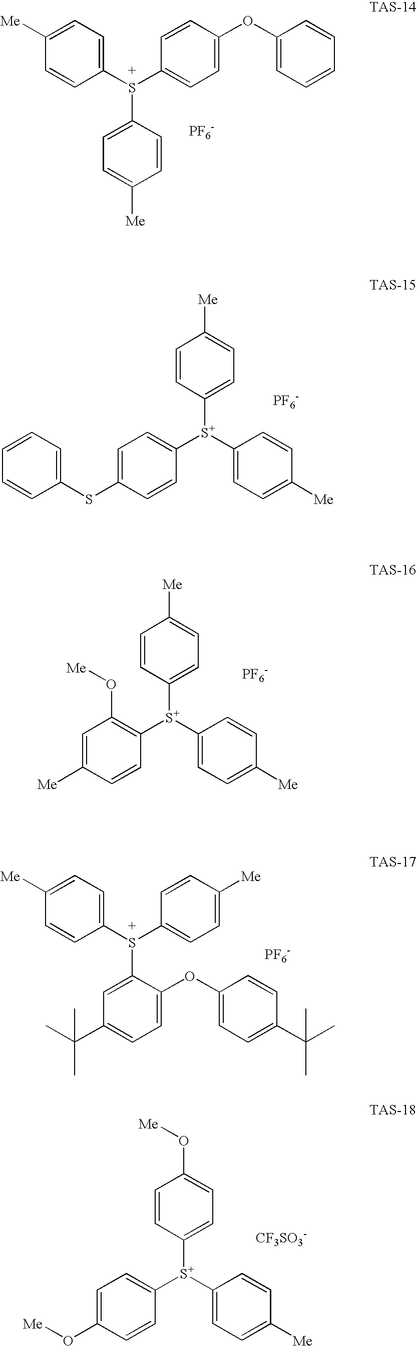 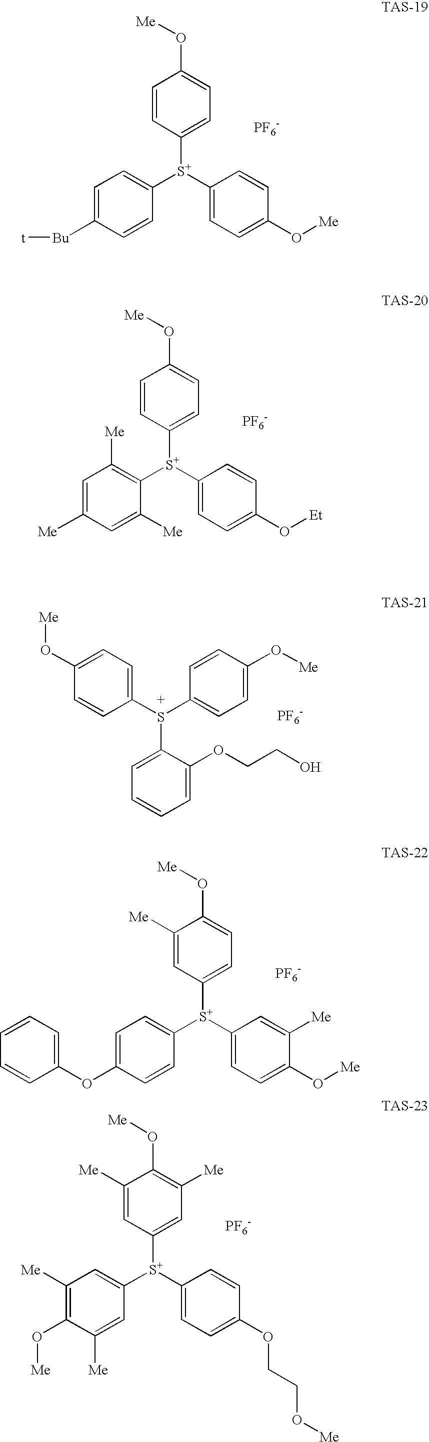 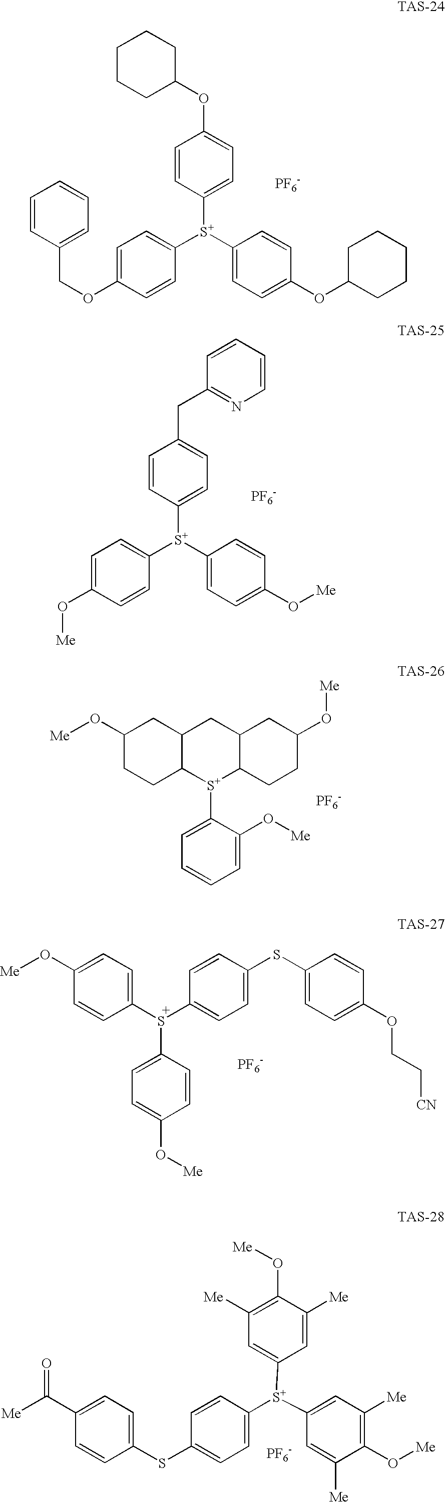 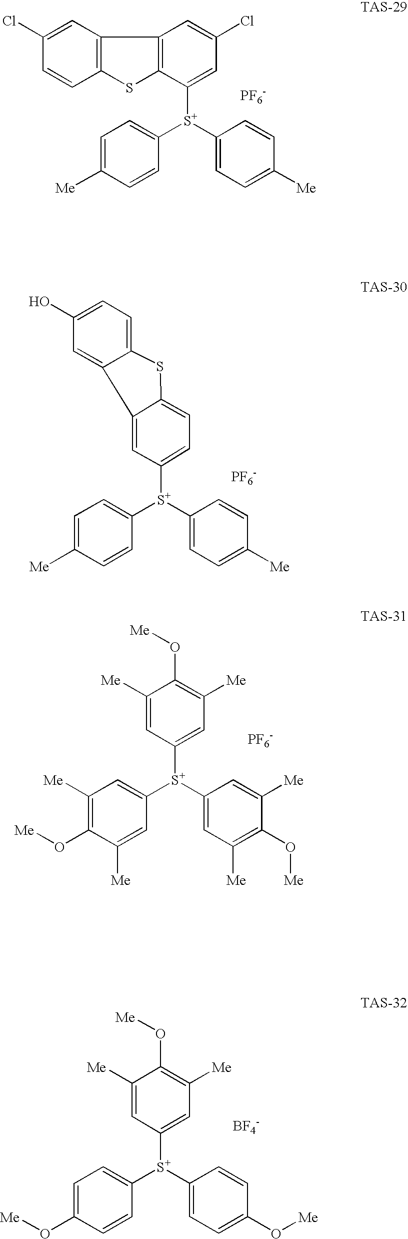 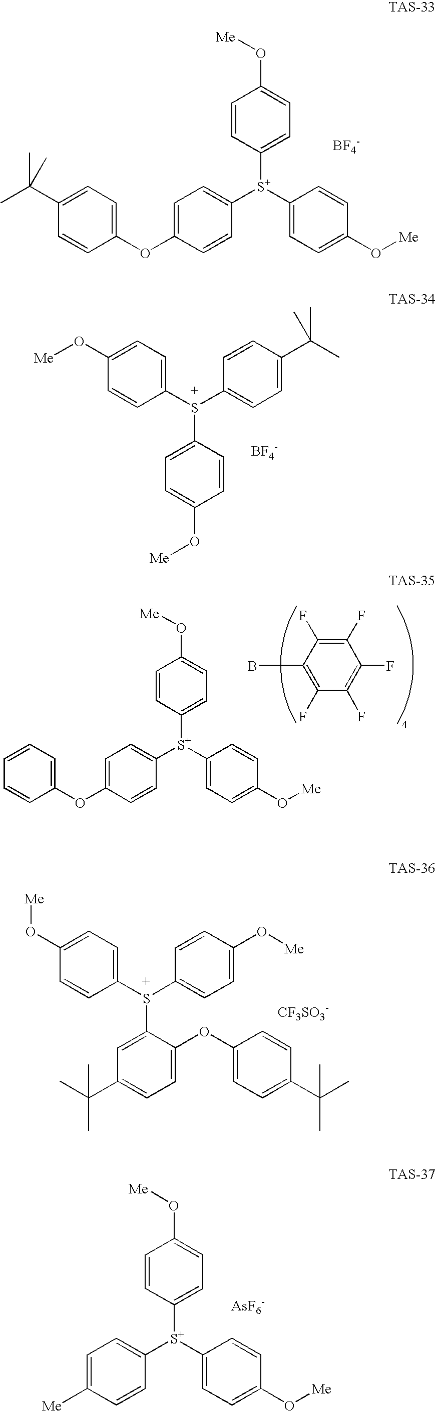 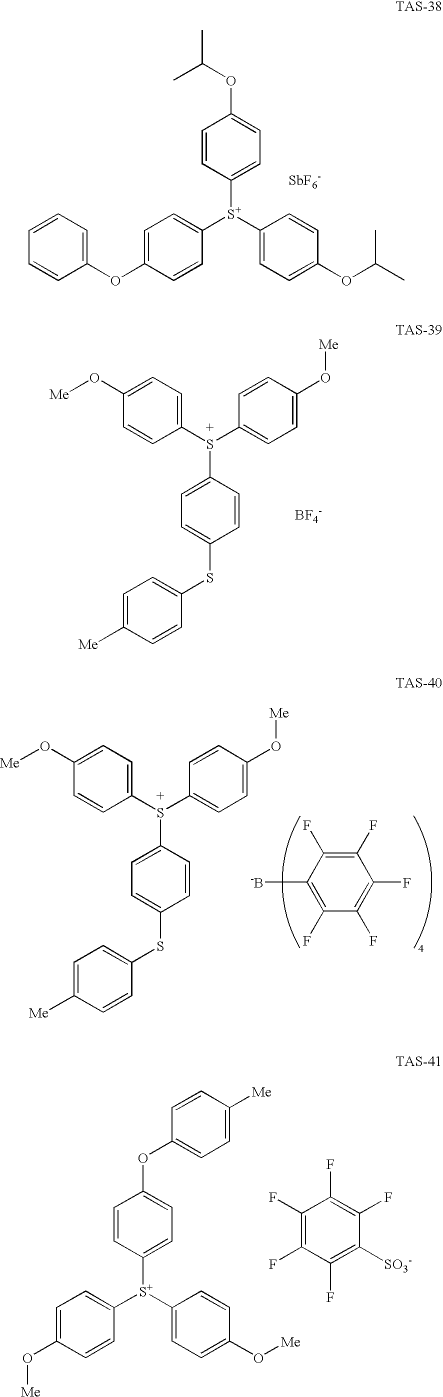 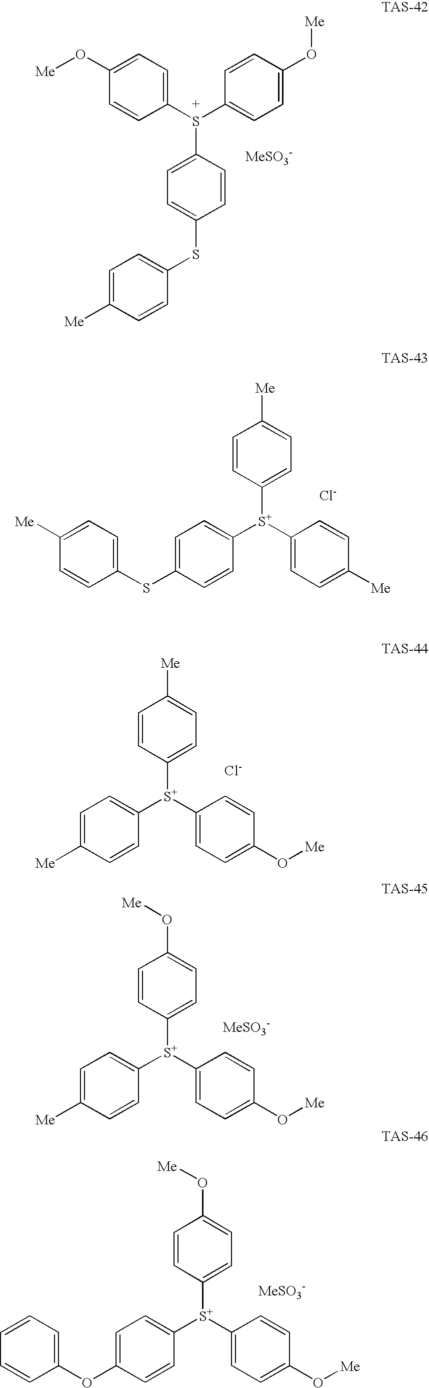 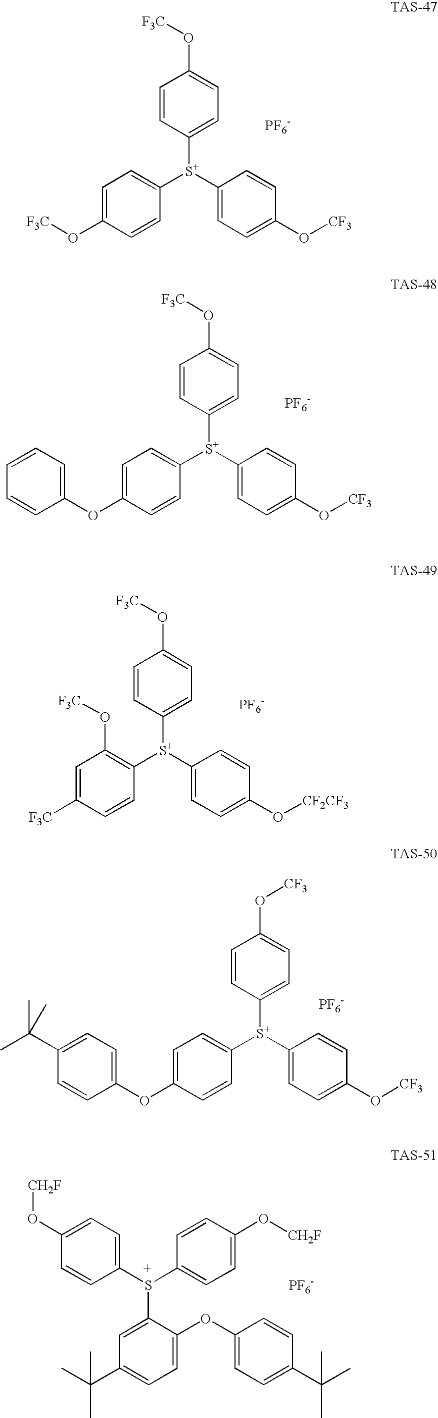 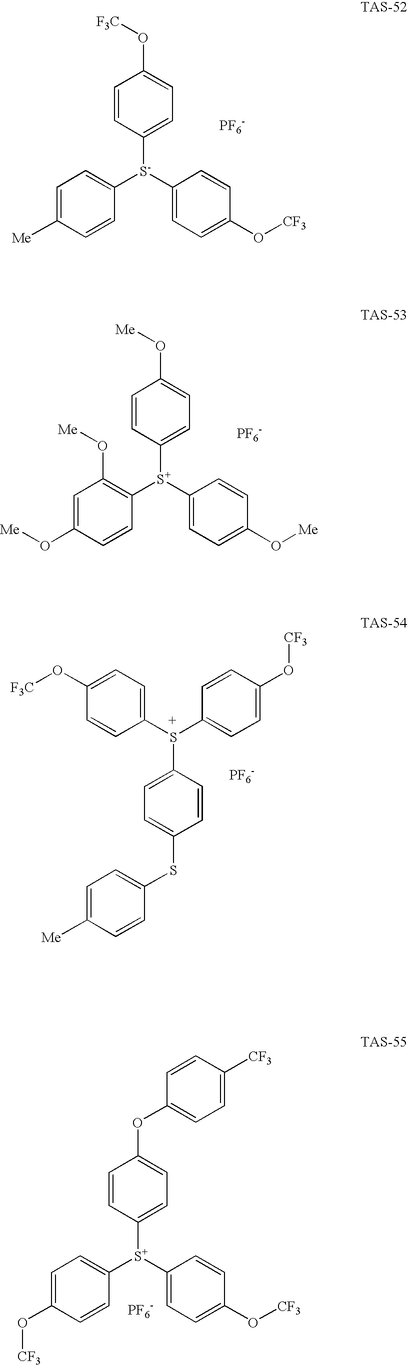 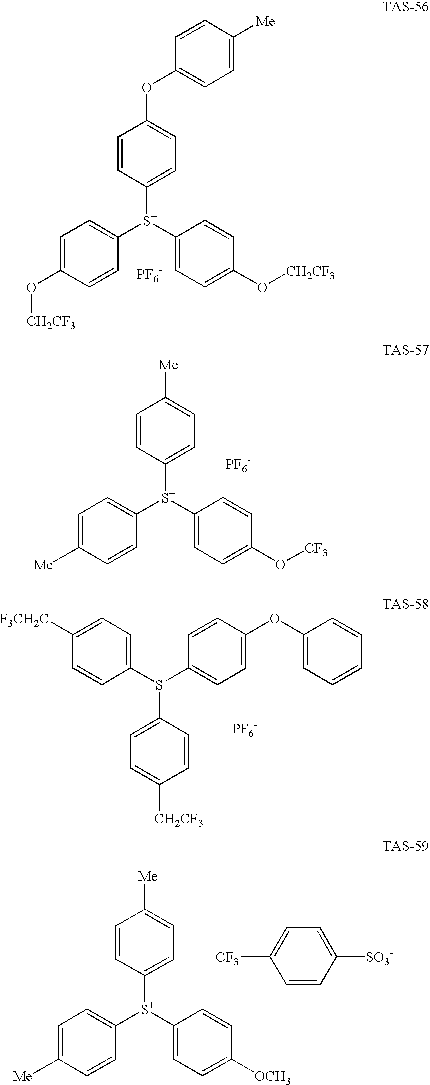
(Photo-Polymerization Accelerator)

Examples of the photo-polymerization accelerator include anthracene, an anthracene derivative (such as Adecaoptomer SP-100 produced by Asahi Denka Co., Ltd.), phenothiazine (such as 10H-phenothiazine), and a phenothiazine derivative (such as 10-methylphenothiazine, 10-ethylphenothiazine, 10-desyl phenothiazine, 10-acetyl phenothiazine, 10-desyl phenothiazine-5-oxide, 10-desyl phenothiazine-5,5-dioxide, and 10-acetylphenothiazine-5,5-dioxide). One or more than one of these photo-polymerization accelerators may be used independently or in combination.

(Infrared Absorbing Agent)

Next, the infrared absorbing agent will be described below. The infrared absorbing agent is a dye or a pigment for effective absorption of near-infrared rays, and preferably a dye or a pigment which ensures effective absorption of infrared rays having wavelength of 760-1500 nm, and more preferably a dye or pigment which ensures effective absorption of infrared rays having wavelength of 760-1200 nm. The infrared absorbing agent has the absorption maximum preferably in the near-infrared ray area, more preferably at wavelength of 760-1500 nm, and still more preferably at wavelength of 760-1200 nm.

For the application requiring transparency in the visible light area or the application requiring color reproducibility, the infrared absorbing agent is added so as to give no substantial impact to the required transparency and color reproducibility in the visible light area. In embodiments of the present invention, the added amount of the infrared absorbing agent may be determined based on studies of various evaluation of the performances required by the users. Especially in the application requiring color reproducibility as in the case of ink, the added amount may be determined in such a way that the color reproducibility is not be affected virtually. Specifically, the infrared absorbing agent is 0.0001-10% by mass based on the total weight of the polymerizable compound, preferably 0.0001-5%, and more preferably 0.001-1%.

In cases when the infrared absorbing agent included in the yellow ink composition for ink-jet recording is such that the absorbance between 630 and 690 nm is 0.15 or less assuming that the absorbance at the maximum absorption wavelength of the infrared absorbing agent is 1, then the green light area absorption of the infrared absorbing agent used for the yellow ink composition does not virtually affect the color reproducibility after curing of the yellow ink composition.

Further, the ink curability of the yellow ink composition is enhanced sufficiently. Further, when the infrared absorbing agent contained in the cyan ink composition for ink-jet recording is such that the absorbance between 410 and 460 nm is 0.15 or less assuming that the absorbance at the maximum absorption wavelength of this infrared absorbing agent is 1, then blue light area absorption of the infrared absorbing agent used for the cyan ink composition does not virtually affect the color reproducibility after curing of the cyan ink composition. Not only that, the ink curability of the cyan ink composition is enhanced sufficiently. Further, this arrangement ensures drastic enhancement of each ink composition in adhesion to the substrate and in preventing color bleeding, thereby providing that an image satisfying both of excellent curability and excellent image quality.

The absorbance is measured using a general spectrophotometer capable of measuring ultraviolet-infrared region. A commonly employed organic solvent may be used as a solvent to measure absorbance. Further, measurement may also be conducted by dissolving the infrared absorbing agent in the polymerizable compound of the present invention.

The dyes effectively absorbing near-infrared rays include the commercially available dyes as well as the well-known products as disclosed in the “Handbook of Dyes”, edited by Organic Synthetic Chemical Association, 1970, if they have the maximum absorption in near-infrared ray region. Specifically, examples of such dyes include a dye which exhibits maximum absorption in near-infrared region, such as an azo dye, a metal complex salt azo dye, a pyrazolone azo dye, a naphthoquinone dye, an anthraquinone dye, a phthalocyanine dye, a carbonium dye, a quinoneimine dye, a methine dye, a cyanine dye (containing a merocyanine dye), a squalium pigment, pyrylium salt and metal thiolate complex.

The pigment capable of effectively absorbing near-infrared rays and usable in the present invention includes the commercially available pigment, as well as the pigments which are described in the Handbook on Color Index (C. I.), the “Handbook of the Latest Pigment”, edited by Japan Pigment Technology Association, 1977, the Latest Pigment Application Technology published by CMC, 1986, and Printing Ink Technology, published by CMC, 1984, and which exhibit maximum absorption in the near-infrared region. Examples of the pigments include a black pigment, a yellow pigment, an orange pigment, a brown pigment, a red pigment, a violet pigment, a blue pigment, a green pigment, a fluorescent pigment, a metallic powder pigment, and a polymer-bonded pigment. Specifically, these pigments are an insoluble azo pigment, an azo lake pigment, a condensate azo pigment, a chelate azo pigment, a phthalocyanine based pigment, an anthraquinone based pigment, a perylene and perinone based pigment, a thioindigo based pigment, a quinacridon based pigment, a dioxazine based pigment, an isoindolinone based pigment, a quinophthalone based pigment, a dyeing lake pigment, an azine pigment, a nitroso pigment, a nitro pigment, a natural pigment, a fluorescent pigment, an inorganic tin oxide, an indium based compound, and an inorganic pigment, and of these, usable are ones which exhibit maximum absorption in near-infrared region.

The infrared absorbing agent of the present invention is preferably the dye capable of effectively absorbing near-infrared rays, and specifically, examples of the infrared absorbing agents include ones, which exhibit maximum absorption in near-infrared region, in such of a phthalocyanine dye, a carbonium dye, a quinoneimine dye, a methine dye, a cyanine dye (including a merocyanine dye), a squalium pigment, a pyrylium salt, and a metal thiolate complex, and more preferably a phthalocyanine dye, a quinoneimine dye, a cyanine dye (including a merocyanine dye).

The preferred examples of the infrared absorbing agents are the compounds represented General Formulas 1-8 or 11 described in JP-A 2001-117201. Specifically, they are exemplified compounds (1)-1-(1)-24, (2)-1-(2)-38, (3, 5)-1-(3, 5)-6, (4, 6)-1-(4, 6)-6, P-1-P-26, and 1-15 described in pp. 11-25 of the above JP-A. Other examples are the compounds represented by General Formulas (1)-(3) described in JP-A 2000-160042, and specifically, they are exemplified compound S1-S42 disclosed in pp. 8-15 of this JP-A. Further examples are the compounds represented by the Formula described in claims 1-14 of Examined Japanese Patent Application Publication No. (hereinafter referred to as JP-B) 2633086. Specifically, they are exemplified compounds (I R1)-(I R8) in pp. 15-18 of above JP-B. Still other examples are the compounds represented by General Formulas (a), (a-1)-(a-4), and (b)-(f) of JP-A 2004-117705. Specifically, they are exemplified compounds described in pp. 29-41 of above JP-A. Still further examples are exemplified compounds (I R-1)-(I R-29) described in pp. 26-29 of JP-A 2004-66482, and exemplified compounds (I R-1)-(I R-11) described in pp. 33-34 of JP-A 2004-98332. And the compounds represented by General Formulas (a)-(d) described in JP-A 2004-77763, and specifically, they are the exemplified compounds described in pp. 23-30 of this JP-A. Still further examples are the compounds represented by General Formula (1) of JP-A 10-140022. Specifically, they are exemplified compounds (I) (57) in pp. 6-8 of this JP-A. Still further examples are the compounds represented by General Formula (1) described in JP-A 2002-187879. Specifically, they are exemplified compounds (1)-(51) described in pp. 7-23 of this JP-A. Still further examples are the compounds described in claim 1 of JP-A 9-188689, the compounds described in claim 1 or 2 of JP-A 2004-10822, the compounds represented by General Formulas (1), (2), and (4)-(8) of JP-A 7-191492, and the compounds represented by Formula (1) described in JP-A 2003-55643. Specifically they are the compounds produced in Examples 1-4, 7 and 8 described in pp. 5-6 of JP-A 2003-55643. Still further examples are the compounds represented by General Formula described in claim 1 of JP-A 2000-35689. Specifically, they are the compounds used in Examples 1-3 described in pp. 4-5 of this JP-A. Still further examples are compound Dye 1451 and Compound BDN (CAS. 38465-55-3) described in the catalog of ORGANICA Feinchemie GmbH; KAYASORB IRG-022, KAYASORB IRG-040, KAYASORB IRG-050, KAYASORB IR-820(B) and KAYASORB CY-10 produced by Nippon Kayaku Co., Ltd.; and Compounds ST1139, ST971, ST946, ST1226, ST959, ST990, ST1844, ST186, ST84, ST1133, ST380, ST798, ST1291, ST1292 and ST1458 described in the catalog of SYNTHON Chemicals GmbH & Co. KG.

(Viscosity of Ink Composition)

In the ink set for ink-jet recording of the present invention, the viscosity of each ink composition is preferably 1-1,000 mPa·s at 30° C., and more preferably 1-500 mPa·s at 30° C. When the ink composition has the viscosity within the aforementioned range, ink composition can penetrate into the fine pore on the order of submicrons on the porous material in a short period of time. Further, to prevent penetration of ink composition into an absorptive substance within a appropriate level, the viscosity may be adjusted to a reasonable level, whereby further curing is accelerated. Further, the viscosity is preferably 10-500 mPa·s at 30° C. This will prevent penetration of ink into an absorptive recording medium, and will reduce the amount of uncured monomer, an offensive odor and bleeding of the dot at ink landing, whereby the image quality is improved. The similar dots are formed on the substrates having different surface tensions, and the similar images are preferably obtained. When the ink composition for ink-jet recording of the present invention is actually used, the viscosity of the ink composition may be determined after studying the evaluation of various performances required to exhibit a function desired by the uses.

(Irradiation of Active Rays)

In the present invention, ultraviolet rays, infrared rays and visible light may be collectively referred to as active rays.

When the ink-jet ink is irradiated to infrared rays, an infrared ray source desired by users may be determined after studying the evaluation of various performances required to exhibit a desired function, before the present invention is actually embodied.

Examples of the infrared ray sources include a conventional infrared ray lamp, a xenon flash lamp, a xenon lamp, a xenon short arc lamp, a near-infrared ray halogen heater, an infrared LED, and an infrared ray laser. The preferably used sources are a xenon flash lamp, a xenon lamp, a near-infrared ray halogen heater, an infrared LED, and a solid laser or a semi-conducting laser which emits infrared rays having a wavelength of 700-1,500 nm. Infrared and ultraviolet rays may be applied from one and the same light source. Further, an infrared ray source and an ultraviolet ray source are installed separately for irradiation. When ultraviolet and visible rays other than the infrared ray emitted simultaneously from the infrared ray source, an apparatus may be downsized if rays other than infrared rays are simultaneously utilized with infrared rays without the rays other than the infrared ray being blocked by a light filter, resulting in more preferable. Further, other infrared and ultraviolet ray sources as auxiliary devices may be used in combinations.

When the ink-jet ink is irradiated with infrared and ultraviolet rays, infrared rays may be irradiated first, or ultraviolet rays may be applied first. Further, both infrared and ultraviolet rays may be irradiated simultaneously. Further, either ultraviolet rays or infrared rays may be irradiated continuously. Either of them may be irradiated on a cyclic basis (such as stroboscopic emission at a predetermined cycle). There is no particular limitation to the method of applying infrared and ultraviolet rays. When the ink-jet ink is irradiated with infrared rays, a model desired by the users may be adopted after studying the evaluation of various performances required to exhibit a desired function, before the present invention is actually embodied.

(Color Material)

The color material used in the present invention is a dye or pigment. In the ink composition for ink-jet recording of the present invention, the color material preferably has concentration of 1-10% by mass based on the entire inks. The color material used in the set of the ink composition for ink-jet recording is the color material which may be able to be dissolved or dispersed into the main component of the polymerizable compound. A dye or pigment may be used as the color material. A pigment is more preferable from the viewpoint of weather resistance.

Firstly, a dye will be described. An oil-soluble dye is preferably used as a dye. The oil-soluble dye used in the set of the ink composition of the present invention is preferred to have a higher oxidation potential to avoid fading, especially to enhance resistance to oxidizing substances such as ozone. The oxidation potential of the oil-soluble dye is preferably higher than 1.0 V (vs SCE). The higher oxidation potential is preferable, and is more preferably higher than 1.1 V (vs SCE), still more preferably 1.2 V (vs SCE) or higher, and specifically preferably 1.3 V (vs SCE) or higher.

Measuring methods of the value of oxidation potential (being Eox) is described, for example, in “New Instrumental Methods in Electrochemistry” by P. Delahay, 1954, published by Interscience Publishers), “Electrochemical Methods” by A. J. Bard et. al., 1980, published by John Wiley & Sons), and “Electrochemical measuring method” by A. Fujishima, 1984, published by Gihodo Publishing Co., Ltd. Specifically, 1×10⁻⁴-1×10⁻⁶ mol/liter of a test sample is dissolved in the solvent such as dimethylformamide and acetonitrile containing a supporting electrolyte such as sodium perchlorate and tetrapropyl ammonium perchlorate. The cyclic voltammetry or direct current polarography is used to measure the oxidation potential (Eox) as a value for SCE (saturated calomel electrode). This value may be displaced by several tens of mV due to the difference in the liquid junction potential and the influence of the liquid resistance of the sample solvent. The reproducibility of potential can be guaranteed by putting a standard sample (e.g., hydroquinone) therein.

In the present invention, for primary definition of potential, the value (vs SCE) measured by direct current polarography in the dimethylformamide (a dye concentration being 0.001 mol dm⁻³) containing 0.1 mol dm⁻³ of tetrapropyl ammonium perchlorate as a supporting electrolyte is assumed as oxidation potential of the dye.

The value of Eox shows the transferability of an electron from the sample to the electrode. The higher this value (being a higher oxidation potential), the lower the transferability of the electron from the sample to the electrode. In other words, it means that the higher value dye tends to be oxidized. In terms of relationships with the compound structure, oxidation potential is increased by introduction of an electron attractive group. The oxidation potential is reduced by introduction of an electron donative group. Thus, the oxidation potential may be described that introduction of the substituent exhibiting a large σp value, such as a sulfonyl group, a sulfonyl group and a sulfamoyl group, can be increased, when the Hammett's substituent constant of up value as a measure of an electron attractive and an electron donative property of a substituent.

The oil-soluble dye which may be used in the present invention will be described below.

Any magenta dye may be used as a magenta dye. Examples of magenta dyes include an aryl or a hetaryl azo dye containing phenols, naphthols and anilines as coupling components; an azo methine dye containing pyrazolones and pyrazolo triazoles as coupling components; a methine dye such as an arylidene dye, a styryl dye, a merocyanine dye and an oxonol dye; a carbonium dye such as a diphenylmethane dye, a triphenylmethane dye and a xanthene; a quinone based dye such as naphthoquinone, an anthraquinone, and an anthorapyridone; and a condensed polycyclic dye such as a dioxazine dye.

Of these, preferred is a hetaryl azo dye bonded with a five-membered heterocyclic ring and pyridine ring, such as a pyrrole, isothiazole, thiadiazole and benzothiazole ring, represented by General Formula (I-1a) described in JP-A 2004-175874. Specific examples are a-1-a-36, b-1-b-8, c-1-c-5, d-1-d-5, and e-1-e-5.

Any cyan dye may be used as a cyan dye. Examples of cyan dyes include an indoaniline dye, an indophenol dye or an azomethine dye containing pyrrolo-triazoles as coupling components; a polymethine dye such as a cyanine dye, an oxonol dye and a merocyanine dye; a carbonium dye such as a diphenylmethane dye, a triphenylmethane dye, a xanthene dye; a phthalocyanine dye; an anthraquinone dye; an aryl or a heteryl azo dye containing phenols, naphthols and anilines as coupling components; and an indigo-thioindigo dye.

Of these, preferably used substance is a phthalocyanine metal complex represented by General Formulas (A-1) and (A-II) described in aforementioned JP-A 2004-175874. Specifical examples are exemplified by AI-1-AI-3 and AII-1-AII-28.

Any yellow dye may be used as a yellow dye. Examples of yellow dyes include an aryl or a heteryl azo dye containing phenols, naphthols, anilines, pyrazolones, pyridones and open chain activated methylene compounds as coupling components; an azomethine dye containing a open chain activated methylene compound as coupling components; a methine dye such as a benzylidene dye and a mono-methine oxonol dye; and a quinone based dye such as a naphthoquinone dye and an anthraquinone dye. Other than the above dyes, a quinophthalone dye, a nitro/nitroso dye, an acridine dye and an acridinone dye may be listed.

Of these, a preferably used substance is a heteryl azo dye bonded with a five-membered heterocyclic ring such as a thisdiazole ring and an imidazolyl ring, and a 5-amino pyrazol ring, represented by General Formula (Y-I), (Y-II), (Y-III), and (Y-IV) described in aforementioned JP-A 2004-175874. Specific examples are Y-101-Y-160.

It is essential that the aforementioned oil-soluble dye can be dissolved in a monomer. It is also important that no crystallization or segregation occurs over time. Generally it is said that a solubility parameter (hereinafter referred to as “an SP value”) of a monomer is closer to that of an oil-soluble dye. However, this depends on structures of the molecule to be dissolved (being an oil-soluble dye in this invention) and that of a solvent (being a monomer in this invention), and the SP value alone cannot always explain a determining factor. The oil-soluble dyes of General Formulas (Y-I), (Y-II), (Y-III) and (Y-IV) have been found to provide excellent solubility and storage stability by use of the physical property value of the molecular volume of a V value and an SP value.

The SP value is preferably 26-21, more preferably 25-21, still more preferably 24-21, and specifically preferably 24-22. The V value is preferably 810-270, more preferably 800-300, still more preferably 750-350, and specifically preferably 700-380. In this case, the V value (cm³/mol) and the SP value (J0.5/cm 1.5) are the values calculated based on the Fedors method. Such a calculation method is described in page 147, Polym. Eng. Sci., Vol. 14, (1974).

Each of the aforementioned dyes may produce colors of yellow, magenta and cyan only after dissociation of a part of the chromophore. In this case, the counter cation may be an inorganic cation such as an alkali metal and ammonium, and alternatively, an organic cation such as pyridinium and a quaternary ammonium salt. Further, a polymer cation having the above counter cation in its partial structure may also be employed.

An amount of content of the oil-soluble pigments in the ink composition is preferably 0.05-40% by mass based on the ink composition, more preferably 0.1-20% by mass, still more preferably 1-15% by mass, and specifically preferably 2-10% by mass.

The pigments which may be preferably used in the present invention are listed below.

C. I. Pigment Yellow-1, 3, 12, 13, 14, 17, 81, 83, 87, 95, 109, and 42,

C. I. Pigment Orange-16, 36, and 38,

C. I. Pigment Red-5, 22, 38, 48:1, 48:2, 48:4, 49:1, 53:1, 57:1, 63:1, 144, 146, 185, and 101,

C. I. Pigment Violet-19, and 23,

C. I. Pigment Blue-15:1, 15:3, 15:4, 18, 60, 27, and 29,

C. I. Pigment Green-7, and 36,

C. I. Pigment White-6, 18, and 21,

C. I. Pigment Black-7,

To disperse the aforementioned pigments, used may be a ball mill, a sand mill, an attriter, a roll mill, an agitator, a Henschel mixer, a colloid mill, an ultrasonic homogenizer, a pearl mill, a wet jet mill, and a paint shaper. Further, a dispersant may be added at the time of dispersion of pigments. A high molecular dispersant is preferably used as a dispersant. As a high molecular dispersant, listed is Solsperse series produced by Avecia Ltd. Further, it is also possible to use a synergist appropriate to various pigments as a dispersion auxiliary agent. Addition of 1-50 parts by mass of these dispersants and dispersion auxiliary agents based on 100 parts by mass of pigment is preferred. A solvent or a polymerizable compound is used for the dispersion medium. In the active ray curable ink used in the present invention, no solvent is preferred for the purpose of reaction and curing immediately after ink landing (being deposition of ink) on the recording media. In cases when the solvent remains in the cured image, solvent resistance of the image may deteriorate and a problem of VOC may occur with the remaining solvent. Thus, for the dispersion property of the dispersion medium, it is preferred to select a monomer having the lowest viscosity from polymerizable compounds, being not a solvent.

For dispersion of a pigment, an average particle diameter of the pigment particles is preferably 0.08-0.5 μm. Selection of a pigment, a dispersant and a dispersion medium, dispersion conditions and filtering conditions may be appropriately set to ensure that the maximum particle diameter is 0.3-10 μLm, and preferably 0.3-3 μm. Proper management of this particle diameter reduces possibility of clogging of the head nozzles, and ensures ink storage stability, ink transparency and curing sensitivity.

In the present invention, various types of additives may be used in addition to the aforementioned constituents.

In the present invention, a thermal base generating agent may be used to improve the emission stability and storage stability.

Preferably employed as thermal base generating agents are, for example, salts of an organic acid and a base which thermally decompose to result in decarboxylation, amine releasing compounds upon being decomposed by reaction such as intramolecular nucleophilic substitution reaction, Lessen rearrangement, and Beckmann rearrangement, and base releasing compounds which undergo various reactions when heated. Specific examples include trichloroacetic acid salts described in British Patent No. 998,949; alpha-sulfonylacetic acid salts described in U.S. Pat. No. 4,060,420; propyl acid salts described in JP-A 59-157637; 2-carboxycarboxamide derivatives and salts of basic components such as organic bases, alkali metals, and alkaline earth metals, and a thermally decomposable acid, described in JP-A 59-168440, hydroxamcarbamate utilizing the Lessen rearrangement described in JP-A 59-180537 and aldoximecarbamates described in JP-A 59-195237 which thermally form nitryl. Other than these, thermal base generating agents are useful which are described in British Patent No. 998,945, U.S. Pat. No. 3,220,846, and British Patent No. 279,480, JP-A Nos. 50-22625, 61-32844, 61-51139, 61-52638, 61-51140, 61-53634-61-53640, 61-55644, and 61-55645. More specific examples include trichloroacetic acid guanidine, trichloroacetic acid methyl guanidine, potassium trichloroacetate, phenylsulfonylacetic acid guanidine, p-chlorophenylsulfonylacetic acid guanidine, p-methanesulfonylphenylsulfonylacetic acid guanidine, potassium phenylpropiol acetate, phenylpropiolic acid guanidine, cesium phenylpropiolate, p-chlorophenolpropiolic acid guanidine, p-phenylene-bis-phenylpropiolic acid guanidine, phenylsulfonyl acetic acid tetramethylammonium, and phenylpropiolic acid tetramethylammonium. It is possible to use the aforesaid thermal base generating agents in the wide range.

The ink composition for ink-jet recording of the present invention may contain acid increasing agents, known in the art by JP-A Nos. 8-248561 and 9-34106, which generate acid, employing acid generated by exposure of active rays.

The ink composition for ink-jet recording of the present invention is manufactured by a sufficiently dispersed pigment together with an active ray curable compound and a pigment dispersant, using a conventional homogenizer such as a sand mill. A pigment concentrate of high pigment concentration is preferably prepared in advance, and is preferably diluted with an active ray curable compound. Sufficient dispersion is ensured using a conventional homogenizer. Accordingly, much dispersion time is not required, because it does not need excessive dispersion energy. This reduces degeneration at the time of dispersion of the ink component, and ink of excellent stability can be prepared. The ink is preferably filtered by a filter having a pore size of 3 μm or less, more preferably using a filter having a pore size of 1 μm or less.

The ink composition for ink-jet recording of the present invention preferably has conductivity of 10 μS/cm or less in a piezo head, without electrical corrosion in the head. Further, in the continuous type, adjustment of conductivity by an electrolyte is essential. In this case, conductivity is adjusted to 0.5 mS/cm or more.

In the present invention, the surface tension of the ink composition for ink-jet recording is preferably in the range of 25-40 mN/m at 25° C. When the surface tension of the ink composition is less than 25 mN/m at 25° C., it is difficult to achieve stable ink ejection. On the other hand, when it exceeds 40 mN/m, it is extremely difficult to result in the desired dot diameter. If the surface tension is outside of the range of 25-40 mN/m, it is difficult to obtain the uniform dot diameter for various supporting members, even if ink ejection and light irradiation are conducted while ink viscosity and percentage of water content in ink are placed under control, as in the present invention.

To adjust the surface tension, if desired, a surface active agent may be incorporated. Examples of the surface active agents which are preferably used in the ink of the present invention include an anionic surface active agent such as dialkyl sulfosuccic acid salts, alkyl naphthalene sulfonic acid salts, and aliphatic acid salts; a nonionic surface active agent such as polyoxy ethylene alkyl ethers, polyoxy ethylene alkyl alyl ethers, acetylene glycols, and polyoxy ethylene/polyoxy propylene block copolymers; a cationic surface active agent such as alkyl amine salts and quaternary ammonium salts; and a surface active compound having a polymerizable group. Of these, specifically preferred are surface active compounds having a unsaturated bond, oxirane, and a oxetane ring, such as a silicone modified acrylate, a fluorine modified acrylate, a silicone modified epoxy, a fluorine modified epoxy, a silicone modified oxetane, a fluorine modified oxetane.

In the ink composition for ink-jet recording of the present invention, various types of additives may be used, in addition to the aforementioned ones. For example, it is possible to add a leveling additive, a matting agent, a polyester based resin, a polyurethane based resin, a vinyl based resin, an acryl based resin, rubber based resin and waxes, all resins and waxes are used to adjust physical properties of the layer. To improve the degree of adhesion to the recording medium, addition of a trace quantity of organic solvent is also effective. In this case, the addition of organic solvent is effective within the extent not occurring problems of the solvent resistance and VOC. The used amount is within 0.1-5%, and preferably 0.1-3%. Further, the radical polymerizable monomer and an initiator may be combined to produce a hybrid type curable ink of a radical cation.

In the image forming method of the present invention, the ink composition is ejected on the recording medium and is formed an image by the ink-jet recording method. Then, active ray irradiation such as ultraviolet rays is conducted to cure the ink.

In the image forming method of the present invention, it is preferable that ink is heated together with the ink-jet nozzles at the time of ink ejection, and a viscosity of the liquid ink is reduced. The heating temperature is 30-80° C., and preferably 35-60° C.

In the present invention, the total thickness of the ink layer after ink is landed and cured by irradiation of active rays, is preferably 2-20 μm. In the active ray curable ink-jet recording in the field of screen printing, the total ink layer thickness is actually exceeding 20 μm. However, in the field of soft package printing, the recording medium is a thin plastic material in many cases, and thus, there is a problem of the overall stiffness and texture of the printed matter being changed, in addition to the aforementioned problems of curling and wrinkles of the recording medium, and therefore, it cannot be used. Further, in the present invention, the ink droplet volume ejected from each nozzle is preferably 2-15 pl.

In the present invention, to form a high-definition image, timing of irradiation is preferably as early as possible. However, in the present invention, light irradiation is preferably started in conformity to the time when ink viscosity or percentage of water content therein reaches to the preferable status.

In details, as active ray irradiation conditions, active ray irradiation is started within 0.001-2.0 sec. after ink landed, and more preferably 0.001-0.4 sec. Further, in 0.1-3 sec., preferably within 0.2-1 sec., light irradiation is conducted until the flowability of the ink is almost lost. After that, light irradiation is terminated. If the above conditions are obtained, it is possible to avoid expansion of a dot diameter and bleeding among ink dots.

In the method of active ray irradiation, the basic method is disclosed in JP-A 60-132767. According to this patent, light sources are arranged on both sides of a recording head unit. The recording head as well as the light sources scan according to the shuttle method. Thus, irradiation starts at certain intervals after ink particles landing. Further, curing is terminated using another light source which is not driven. The method of irradiation disclosed in the U.S. Pat. No. 6,145,979 indicates the method using the optical fiber, and the method irradiating UV rays to the recorded areas by directing a collimated light source to the mirror surface arranged on the side face of the recording head unit. In the image forming method of the present invention, any one of these methods of irradiation may be utilized.

Further, active ray irradiation may be divided into two steps. In the first step, active ray irradiation is conducted according to the aforementioned method within 0.001-2.0 sec. after ink particles landed on the recording medium, and then further active ray irradiation is conducted after termination of overall printing. This method is also one of preferable embodiments. When active ray irradiation is conducted in two steps, it becomes possible to reduce shrinking of a recording medium which occurs at the time of curing of the ink.

Specific examples of the light sources used in irradiation of active rays are a mercury arc lamp, a xenon arc lamp, a fluorescent lamp, a carbon arc lamp, a tungsten-halogen copying lamp, a high-pressure mercury lamp, a metal halide lamp, a non-electron UV lamp, a low-pressure mercury lamp, a UV laser, a xenon flash lamp, an insect capturing lamp, a black light, a bactericidal lamp, a cold-cathode tube and LEDs, without the present invention being limited thereto. Of these, the fluorescent tube is preferred because of low energy and low cost. It is preferred to use a light source featuring a peak emission wavelength of 250-370 nm, and preferably 270-320 nm, from the viewpoint of sensitivity. The intensity of illumination is 1-3,000 mW/cm², and preferably 1-200 mW/cm². Further, when electron beams are used for curing, the electron beams having energy of 300 eV or less are normally used for curing, however, it is also possible to use the method of instantaneous curing by an irradiance level of 1-5 Mrad.

An image is printed on a recording medium (also called as a substrate) according to the present invention. All the wide-ranging synthetic resins used conventionally for various forms of application can be used as a recorded medium. Specific examples are, for example, polyester, vinyl polychloride, polyethylene, polyurethane, polypropylene, acryl resin, polycarbonate, polystyrene, acrylonitrile-butadiene-styrene copolymer, polyethylene terephthalate, and polybutadieneterephthalate. There is no particular limitation to the thickness or shape of these synthetic resin substrates.

In addition to the normal coated or uncoated paper, a non-absorbent supporting member can also be used as a substrate which can be used in the present invention. Among these substrates, use of a non-absorbent supporting member as a substrate is preferred.

In the present invention, various forms of non-absorbing plastics and the films thereof can be used as a non-absorbent supporting member. Specific examples of various plastic films include a PET film, an OPS film, an OPP film, an ONy film, a PVC film, a PE film and a TAC film. Other plastics which can be used include polycarbonate, an acryl resin, ABS, polyacetal, PVA and rubbers. Metals and glasses can also be employed. When an image is formed particularly on a PET film, an OPS film, an OPP film, an ONy film and a PVC film which can be shrunk by heat, the structure of the present invention is effective. In these substances, curling and deformation of the film tend to be caused by heat due to shrinking of the ink during curing and curing reaction. Not only these problems, the ink layer cannot easily conform to the shrinking of the substrate.

There is a big difference in the surface energy among various forms of plastic films. Depending on the recording medium, the dot diameter is subjected to change after ink landing on the recording medium. This has been a problem so far. In the present invention, wettability index of a substrate is preferably 40-60 mN/m, although the embodiments of the invention include OPP film and OPS film of lower surface energy and PET of relatively greater surface energy.

A longer recording medium (being a web) is preferably used in the present invention because of the advantages in recording medium costs such as packaging costs and production costs and print creation efficiency, as well as compatibility with the requirements for printing on media of various sizes.

### EXAMPLE

The present invention will be described with reference to specific Examples, but the present invention is not limited thereto.

### Example 1

<Preparation of Ink Set>

(Preparation of Ink Composition for Ink-Jet Recording)

Ink compositions for ink-jet recording (abbreviated as “ink composition”) made up of compositions described in Tables 1 and 2 have been prepared.

The ink composition was prepared according to the following steps. The dispersant Solsperse 24000 (produced by Avecia Ltd.) was added to each composition except for the polymerization initiator, and the resulting mixture was dispersed for four hours using a sand grinder, after which the polymerization initiator was added, and the mixture was filtered by a 0.8 μm membrane filter and was heated to 50° C. It was then dehydrated under reduced pressure. In the ink color column of the Table, “C” is a cyan ink, “M” is a magenta ink, and “Y” is a yellow ink.

<Measurement of Viscosity>

Viscosity of the aforementioned ink composition was measured using an oscillation type viscometer at 30° C., and the result was evaluated according to the following criteria.

3: below 500 mPa·s

2: 500-1,000 mPa·s

1: above 1,000 mPa·s

The results are shown in Tables 1 and 2.

<Image Recording>

Each ink composition having been obtained was ejected onto a polyethylene terephthalate film substrate which was subjected to a corona treatment, using nozzle portions which were heated and controlled to 50° C. In this case, the nozzles were piezo type ink-jet nozzles which provided the ink particle volume of 7 pl (wherein the nozzle pitches were 360 dpi, (“dpi” representing the number of dots per inch or 2.54 cm). Then a solid image (the amount of ejected liquid ink being 10 g/m²) and 6-point MS Ming type letters were printed. A fluorescent tube having a main peak of 308 nm was employed as a light source. At an intensity of illumination of 1 mW/cm² on the surface of the substrate immediately below the light source, irradiation was started 0.1 sec. after ink landing on the recording medium. The exposure terminated 0.5 sec. later. The exposure energy was 3 mJ/cm².

Further, an infrared flash light was installed in parallel with the fluorescent tube. Simultaneously with the start of exposure by the fluorescent tube, infrared flash light (wherein the light emitting energy of light emitting surface was 1.5 J/cm²) was applied twice, after 0.05 sec. and 0.25 sec. after ink landing. This image printing was conducted at 30° C. and 85% RH. For comparison, a sample without infrared ray irradiation was also prepared. The test results are shown in Tables 1 and 2 including whether infrared rays were applied or not.

TABLE 1

| | | | | | | | | | | | | | Infrared | | | | |
|---|---|---|---|---|---|---|---|---|---|---|---|---|---|---|---|---|---|
| Ink | | | | | | | | | | | | | ray | | | | |
| set | Ink | Ink | Pigment | | * 2 | | * 2 | | * 2 | | * 3 | | absorbent | | Vis- | | Re- |
| No. | No. | color | Type | * 1 | Type | * 1 | Type | * 1 | Type | * 1 | Type | * 1 | Type | * 1 | cosity | * 4 | marks |
| A | 1001 | C | ** 1 | 5 | RPC-A | 41 | RPC-B | 20 | RPC-C | 30 | *** 1 | 7 | — | — | 3 | No | Comp. |
| | 1002 | M | ** 2 | 5 | RPC-A | 41 | RPC-B | 20 | RPC-C | 30 | *** 1 | 7 | — | — | 3 | No | Comp. |
| | 1003 | Y | ** 3 | 5 | RPC-A | 41 | RPC-B | 20 | RPC-C | 30 | *** 1 | 7 | — | — | 3 | No | Comp. |
| B | 1011 | C | ** 1 | 5 | CPC-B | 15 | CPC-C | 85 | — | — | *** 2 | 7 | — | — | 3 | No | Comp. |
| | 1012 | M | ** 2 | 5 | CPC-B | 15 | CPC-C | 85 | — | — | *** 2 | 7 | — | — | 3 | No | Comp. |
| | 1013 | Y | ** 3 | 5 | CPC-B | 15 | CPC-C | 85 | — | — | *** 2 | 7 | — | — | 3 | No | Comp. |
| A | 1001 | C | ** 1 | 5 | RPC-A | 41 | RPC-B | 20 | RPC-C | 30 | *** 1 | 7 | — | — | 3 | Yes | Comp. |
| | 1002 | M | ** 2 | 5 | RPC-A | 41 | RPC-B | 20 | RPC-C | 30 | *** 1 | 7 | — | — | 3 | Yes | Comp. |
| | 1003 | Y | ** 3 | 5 | RPC-A | 41 | RPC-B | 20 | RPC-C | 30 | *** 1 | 7 | — | — | 3 | Yes | Comp. |
| B | 1011 | C | ** 1 | 5 | CPC-B | 15 | CPC-C | 85 | — | — | *** 2 | 7 | — | — | 3 | Yes | Comp. |
| | 1012 | M | ** 2 | 5 | CPC-B | 15 | CPC-C | 85 | — | — | *** 2 | 7 | — | — | 3 | Yes | Comp. |
| | 1013 | Y | ** 3 | 5 | CPC-B | 15 | CPC-C | 85 | — | — | *** 2 | 7 | — | — | 3 | Yes | Comp. |
| C | 1021 | C | ** 1 | 5 | RPC-A | 41 | RPC-B | 20 | RPC-C | 30 | *** 1 | 7 | C | 0.05 | 3 | Yes | Comp. |
| | 1022 | M | ** 2 | 5 | RPC-A | 41 | RPC-B | 20 | RPC-C | 30 | *** 1 | 7 | C | 0.05 | 3 | Yes | Comp. |
| | 1023 | Y | ** 3 | 5 | RPC-A | 41 | RPC-B | 20 | RPC-C | 30 | *** 1 | 7 | C | 0.05 | 3 | Yes | Comp. |
| D | 1031 | C | ** 1 | 5 | CPC-B | 15 | CPC-C | 85 | — | — | *** 2 | 7 | C | 0.04 | 3 | Yes | Comp. |
| | 1032 | M | ** 2 | 5 | CPC-B | 15 | CPC-C | 85 | — | — | *** 2 | 7 | C | 0.04 | 3 | Yes | Comp. |
| | 1033 | Y | ** 3 | 5 | CPC-B | 15 | CPC-C | 85 | — | — | *** 2 | 7 | C | 0.04 | 3 | Yes | Comp. |
| E | 1041 | C | ** 1 | 5 | RPC-A | 41 | RPC-B | 20 | RPC-C | 30 | *** 1 | 7 | D | 0.05 | 3 | Yes | Comp. |
| | 1042 | M | ** 2 | 5 | RPC-A | 41 | RPC-B | 20 | RPC-C | 30 | *** 1 | 7 | D | 0.05 | 3 | Yes | Comp. |
| | 1043 | Y | ** 3 | 5 | RPC-A | 33 | RPC-B | 20 | RPC-C | 30 | *** 1 | 7 | D | 0.05 | 3 | Yes | Comp. |
| F | 1051 | C | ** 1 | 5 | CPC-B | 15 | CPC-C | 85 | — | — | *** 2 | 7 | D | 0.04 | 3 | Yes | Comp. |
| | 1052 | M | ** 2 | 5 | CPC-B | 15 | CPC-C | 85 | — | — | *** 2 | 7 | D | 0.04 | 3 | Yes | Comp. |
| | 1053 | Y | ** 3 | 5 | CPC-B | 15 | CPC-C | 85 | — | — | *** 2 | 7 | D | 0.04 | 3 | Yes | Comp. |
| G | 1061 | C | ** 1 | 5 | RPC-A | 41 | RPC-B | 20 | RPC-C | 30 | *** 1 | 7 | C | 0.05 | 3 | Yes | Inv. |
| | 1062 | M | ** 2 | 5 | RPC-A | 41 | RPC-B | 20 | RPC-C | 30 | *** 1 | 7 | C | 0.05 | 3 | Yes | Inv. |
| | 1063 | Y | ** 3 | 5 | RPC-A | 41 | RPC-B | 20 | RPC-C | 30 | *** 1 | 7 | A | 0.04 | 3 | Yes | Inv. |
| H | 1071 | C | ** 1 | 5 | CPC-B | 15 | CPC-C | 85 | — | — | *** 2 | 7 | C | 0.04 | 3 | Yes | Inv. |
| | 1072 | M | ** 2 | 5 | CPC-B | 15 | CPC-C | 85 | — | — | *** 2 | 7 | C | 0.04 | 3 | Yes | Inv. |
| | 1073 | Y | ** 3 | 5 | CPC-B | 15 | CPC-C | 85 | — | — | *** 2 | 7 | A | 0.05 | 3 | Yes | Inv. |

* 1: Amount to be added (parts by mass),
* 2: Polymerizable compound,
* 3: Polarization initiator,
* 4: Infrared rays applied
*** Initiator
** Coloring material,
Comp.: Comparative example,
Inv.: Present invention

TABLE 2

| | | | | | | | | | | | | | Infrared | | | | |
|---|---|---|---|---|---|---|---|---|---|---|---|---|---|---|---|---|---|
| Ink | | | | | | | | | | | | | ray | | | | |
| set | Ink | Ink | Pigment | | * 2 | | * 2 | | * 2 | | * 3 | | absorbent | | Vis- | | Re- |
| No. | No. | color | Type | * 1 | Type | * 1 | Type | * 1 | Type | * 1 | Type | * 1 | Type | * 1 | cosity | * 4 | marks |
| I | 1081 | C | ** 1 | 5 | RPC-A | 41 | RPC-B | 20 | RPC-C | 30 | *** 1 | 7 | E | 0.04 | 3 | No | Inv. |
| | 1082 | M | ** 2 | 5 | RPC-A | 41 | RPC-B | 20 | RPC-C | 30 | *** 1 | 7 | A | 0.04 | 3 | No | Inv. |
| | 1083 | Y | ** 3 | 5 | RPC-A | 41 | RPC-B | 20 | RPC-C | 30 | *** 1 | 7 | D | 0.05 | 3 | No | Inv. |
| J | 1091 | C | ** 1 | 5 | CPC-B | 15 | CPC-C | 85 | — | — | *** 2 | 7 | E | 0.04 | 3 | No | Inv. |
| | 1092 | M | ** 2 | 5 | CPC-B | 15 | CPC-C | 85 | — | — | *** 2 | 7 | A | 0.04 | 3 | No | Inv. |
| | 1093 | Y | ** 3 | 5 | CPC-B | 15 | CPC-C | 85 | — | — | *** 2 | 7 | D | 0.05 | 3 | No | Inv. |
| K | 1101 | C | ** 1 | 5 | EP-17 | 15 | CPC-C | 80 | CPC-D | 5 | TAS-13 | 5 | C | 0.03 | 3 | Yes | Inv. |
| | 1102 | M | ** 2 | 5 | EP-17 | 15 | CPC-C | 80 | CPC-D | 5 | TAS-13 | 5 | C | 0.03 | 3 | Yes | Inv. |
| | 1103 | Y | ** 3 | 5 | EP-17 | 15 | CPC-C | 80 | CPC-D | 5 | TAS-13 | 5 | A | 0.04 | 3 | Yes | Inv. |
| L | 1111 | C | ** 1 | 5 | EP-17 | 15 | CPC-C | 80 | CPC-D | 5 | TAS-13 | 5 | E | 0.03 | 3 | Yes | Inv. |
| | 1112 | M | ** 2 | 5 | EP-17 | 15 | CPC-C | 80 | CPC-D | 5 | TAS-13 | 5 | A | 0.03 | 3 | Yes | Inv. |
| | 1113 | Y | ** 3 | 5 | EP-17 | 15 | CPC-C | 80 | CPC-D | 5 | TAS-13 | 5 | D | 0.04 | 3 | Yes | Inv. |
| M | 1121 | C | ** 1 | 5 | EP-17 | 15 | CPC-C | 80 | CPC-D | 5 | TAS-13 | 5 | E | 0.03 | 3 | Yes | Inv. |
| | 1122 | M | ** 2 | 5 | EP-17 | 15 | CPC-C | 80 | CPC-D | 5 | TAS-13 | 5 | A | 0.03 | 3 | Yes | Inv. |
| | 1123 | Y | ** 3 | 5 | EP-17 | 15 | CPC-C | 80 | CPC-D | 5 | TAS-13 | 5 | A | 0.04 | 3 | Yes | Inv. |
| N | 1131 | C | ** 1 | 5 | EP-17 | 15 | CPC-C | 80 | CPC-D | 5 | TAS-13 | 5 | B | 0.03 | 3 | Yes | Inv. |
| | 1132 | M | ** 2 | 5 | EP-17 | 15 | CPC-C | 80 | CPC-D | 5 | TAS-13 | 5 | A | 0.03 | 3 | Yes | Inv. |
| | 1133 | Y | ** 3 | 5 | EP-17 | 15 | CPC-C | 80 | CPC-D | 5 | TAS-13 | 5 | A | 0.04 | 3 | Yes | Inv. |
| O | 1141 | C | ** 1 | 5 | EP-17 | 15 | CPC-C | 80 | CPC-D | 5 | TAS-13 | 5 | E | 0.03 | 3 | Yes | Inv. |
| | 1142 | M | ** 2 | 5 | EP-17 | 15 | CPC-C | 80 | CPC-D | 5 | TAS-13 | 5 | E | 0.03 | 3 | Yes | Inv. |
| | 1143 | Y | ** 3 | 5 | EP-17 | 15 | CPC-C | 80 | CPC-D | 5 | TAS-13 | 5 | A | 0.04 | 3 | Yes | Inv. |
| P | 1151 | C | ** 1 | 5 | EP-17 | 15 | CPC-C | 80 | CPC-D | 5 | TAS-13 | 5 | E | 0.03 | 3 | Yes | Inv. |
| | 1152 | M | ** 2 | 5 | EP-17 | 15 | CPC-C | 80 | CPC-D | 5 | TAS-13 | 5 | E | 0.03 | 3 | Yes | Inv. |
| | 1153 | Y | ** 3 | 5 | EP-17 | 15 | CPC-C | 80 | CPC-D | 5 | TAS-13 | 5 | B | 0.04 | 3 | Yes | Inv. |
| Q | 1161 | C | ** 1 | 5 | EP-17 | 15 | CPC-C | 80 | CPC-D | 5 | TAS-13 | 5 | E | 0.03 | 3 | Yes | Inv. |
| | 1162 | M | ** 2 | 5 | EP-17 | 15 | CPC-C | 80 | CPC-D | 5 | TAS-13 | 5 | E | 0.03 | 3 | Yes | Inv. |
| | 1163 | Y | ** 3 | 5 | EP-17 | 15 | CPC-C | 80 | CPC-D | 5 | TAS-13 | 5 | D | 0.04 | 3 | Yes | Inv. |

* 1: Amount to be added (parts by mass),
* 2: Polymerizable compound,
* 3: Polarization initiator,
* 4: Infrared rays applied
*** Initiator
** Coloring material,
Comp.: Comparative example,
Inv.: Present invention

The following describes the structures of the color material, polymerizable compound, polymerization initiator, infrared absorbing agent of Tables 1 and 2.
Color material 1: C.I. pigment Blue-15:3
Color material 2: C.I. pigment Red-57:1
Color material 3: C.I. pigment Yellow-13
RPC-A (radical polymerizable compound A): tetraethyleneglycol diacrylate
RPC-B (radical polymerizable compound B): ε caprolactam modified dipentaerithritol hexaacrylate
RPC-C (radical polymerizable compound C): phenoxy ethylmethacrylate
CPC-A (cation polymerizable compound A): Seroxide 3000 (Produced by Daicel UCB Co. Ltd.)
CPC-B (cation polymerizable compound B): Seroxide 2021P (produced by Daicel UCB Co. Ltd.)
CPC-C (cation polymerizable compound C): OXT-221: di-[1-ethyl(3-oxetanyl)] methyl ether (produced by Toagosei Co., Ltd.)
CPC-D (cation polymerizable compound D): OXT-212: 3-ethyl-3-(2-ethylhexyloxymethyl)oxetane (produced by Toagosei Co., Ltd.)
CPC-E (cation polymerizable compound E): Epolead GT401 (produced by Daicel Chemical Industries, Ltd.)
EP-17: Exemplified compound of the present invention
Initiator 1: Irgacure-907 (produced by Ciba Geigie AG.)
Initiator 2: Thyracure UV 16990 (produced by Union Carbide Co., Ltd.)
Initiator 3: CI-2855 (produced by Nippon Soda Co., Ltd.)
TAS-13: Exemplified compound of the present invention
Infrared absorbing agent A: Exemplified compound P-1 described in JP-A 2001-117201
Infrared absorbing agent B: KAYASORB IRG-022 (produced by Nippon Kayaku Co.)
Infrared absorbing agent C: KAYASORB IR-820(B) (Produced by Nippon Kayaku Co.)
Infrared absorbing agent D: bis-(4,5-bisdimethylamino-1,2-benzenedithiorene) nickel tetrabutyl ammonium (compound described in the Claims of JP-A 9-188689)
Infrared absorbing agent E: Compound P-4 described in JP-A 2001-117201
   P-1 (Compound Described in JP-A 2001-117201) 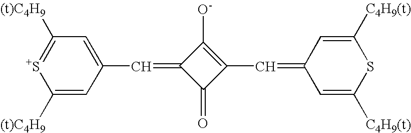
   P-4 (Compound Described in JP-A 2001-117201)

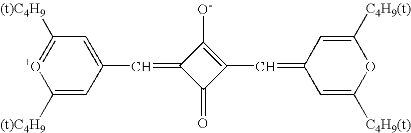

The following shows the ratio of absorbance in the visible light area assuming that absorbance of the infrared absorbing agent at the infrared maximum wavelength is 1. Absorbance was measured using a cation polymerizable compound C(CPC—C) as a solvent.

| | Ratio of maximum absorbance | Ratio of maximum absorbance |
|---|---|---|
| Infrared | between 410 and 460 nm | between 630 and 690 nm |
| absorbing | based on infrared maximum | based on infrared maximum |
| agent | absorbance | absorbance |
| A | ≧0.1 | ≧0.1 |
| B | 0.125 | ≧0.1 |
| C | ≧0.1 | 0.35 |
| D | 0.4 | 0.13 |
| E | ≧0.1 | 0.2 |

Each of the aforementioned colored images was evaluated as follows. “4” and “3” in the following criteria indicate satisfactory curability without practical problem.

<Ink Curability>

Ink curability was evaluated for printing image according to the following criteria.

4: Tackiness was not noted even if touched immediately after termination of exposure.

3: The image was slightly tacky if touched immediately after exposure, and exhibited satisfactory curability without practical problem.

2: The image was slightly tacky if touched immediately after exposure. Tackiness disappears in one minute.

1: Tackiness still remains one minute after exposure.

<Adhesiveness to Substrate>

A cellophane adhesive tape (being Cellotape: trademark) having a width of 25 mm was adhered onto the solid image and pressure bonding was conducted. Then the tape was quickly pealed at a separation angle of 90°, and the status of the image after pealing was visually observed.

Adhesiveness to the substrate was evaluated according to the following criteria. The grade “3” in the following criteria indicated no practical problem.
3: No image separation by tape pealing was noted.
2: Partial image separation by tape pealing was noted.
1: Complete image separation by tape pealing was noted.
   <Resistance to Image Bleeding>

A 6-point MS Ming type letter was inspected by a magnifier, and the status of adjacent dots was observed.

According to the following criteria, the resistance to image bleeding was evaluated. The grade “3” in the following criteria indicated no practical problem.
3: Almost no bleeding between adjacent dots was noted.
2: Slight bleeding between adjacent dots was noted.
1: Serious bleeding between adjacent dots was noted.
   <Color Reproducibility>

Color reproducibility was evaluated only for the yellow and cyan solid image portions. The status of the image on the solid image was visually observed, and the color reproducibility was evaluated according to the following criteria.
2: No color contamination in the yellow or cyan solid image portion was noted.
1: Color contamination was clearly visible in the yellow or cyan solid image portion.
   <Glossiness in Solid Image Portion>

Glossiness was evaluated only for the yellow and cyan solid image portions in the following sensory test procedure. The glossiness in the solid image portion was evaluated by ten observers who visually checked the solid image surface by directly facing the surface, and by viewing the surface at an angle of 45°. Evaluation was made to determine if both the yellow and cyan solid images were adequately glossy when viewed at an angle, and identification between yellow and cyan colors was achieved. Grades “4” and “3” indicated no practical problem.
4: Satisfactory glossiness for both yellow and cyan was noted, according to nine or more observers.
3: Satisfactory glossiness for both yellow and cyan was noted, according to six or more observers.
2: Satisfactory glossiness for both yellow and cyan was noted, according to five or less observers
1: Satisfactory glossiness for both yellow and cyan was noted, according to one or less observer.

Table 3 shows the test results.

TABLE 3

| Ink | | | | Evaluation result | | | | | |
|---|---|---|---|---|---|---|---|---|---|
| set | Ink | Ink | | Ink | Adhesiveness | | Color | | Re- |
| No. | No. | color | * 1 | curability | to substrate | * 2 | reproducibility | * 3 | marks |
| A | 1001 | C | No | 2 | 2 | 2 | — | — | Comp. |
| | 1002 | M | No | 1 | 1 | 1 | — | — | Comp. |
| | 1003 | Y | No | 1 | 1 | 1 | — | — | Comp. |
| B | 1011 | C | No | 2 | 2 | 2 | — | — | Comp. |
| | 1012 | M | No | 2 | 2 | 2 | — | — | Comp. |
| | 1013 | Y | No | 1 | 1 | 1 | — | — | Comp. |
| A | 1001 | C | Yes | 2 | 2 | 2 | — | — | Comp. |
| | 1002 | M | Yes | 1 | 1 | 1 | — | — | Comp. |
| | 1003 | Y | Yes | 1 | 1 | 1 | — | — | Comp. |
| B | 1011 | C | Yes | 2 | 2 | 2 | — | — | Comp. |
| | 1012 | M | Yes | 2 | 2 | 2 | — | — | Comp. |
| | 1013 | Y | Yes | 1 | 1 | 1 | — | — | Comp. |
| C | 1021 | C | Yes | 3 | 3 | 3 | 2 | 3 | Comp. |
| | 1022 | M | Yes | 3 | 3 | 3 | — | — | Comp. |
| | 1023 | Y | Yes | 3 | 3 | 3 | 1 | 1 | Comp. |
| D | 1031 | C | Yes | 4 | 3 | 3 | 2 | 3 | Comp. |
| | 1032 | M | Yes | 4 | 3 | 3 | — | — | Comp. |
| | 1033 | Y | Yes | 4 | 3 | 3 | 1 | 1 | Comp. |
| E | 1041 | C | Yes | 3 | 3 | 3 | 1 | 1 | Comp. |
| | 1042 | M | Yes | 3 | 3 | 3 | — | — | Comp. |
| | 1043 | Y | Yes | 3 | 3 | 3 | 2 | 3 | Comp. |
| F | 1051 | C | Yes | 4 | 3 | 3 | 1 | 1 | Comp. |
| | 1052 | M | Yes | 4 | 3 | 3 | — | — | Comp. |
| | 1053 | Y | Yes | 4 | 3 | 3 | 2 | 3 | Comp. |
| G | 1061 | C | Yes | 3 | 3 | 3 | 2 | 3 | Inv. |
| | 1062 | M | Yes | 3 | 3 | 3 | — | — | Inv. |
| | 1063 | Y | Yes | 3 | 3 | 3 | 2 | 3 | Inv. |
| H | 1071 | C | Yes | 4 | 3 | 3 | 2 | 4 | Inv. |
| | 1072 | M | Yes | 4 | 3 | 3 | — | — | Inv. |
| | 1073 | Y | Yes | 4 | 3 | 3 | 2 | 4 | Inv. |
| I | 1081 | C | No | 3 | 3 | 3 | 2 | 3 | Inv. |
| | 1082 | M | No | 3 | 3 | 3 | — | — | Inv. |
| | 1083 | Y | No | 3 | 3 | 3 | 2 | 4 | Inv. |
| J | 1091 | C | No | 4 | 3 | 3 | 2 | 4 | Inv. |
| | 1092 | M | No | 4 | 3 | 3 | — | — | Inv. |
| | 1093 | Y | No | 4 | 3 | 3 | 2 | 4 | Inv. |
| K | 1101 | C | Yes | 4 | 3 | 3 | 2 | 4 | Inv. |
| | 1102 | M | Yes | 4 | 3 | 3 | | — | Inv. |
| | 1103 | Y | Yes | 4 | 3 | 3 | 2 | 4 | Inv. |
| L | 1111 | C | Yes | 4 | 3 | 3 | 2 | 4 | Inv. |
| | 1112 | M | Yes | 4 | 3 | 3 | — | — | Inv. |
| | 1113 | Y | Yes | 4 | 3 | 3 | 2 | 4 | Inv. |
| M | 1121 | C | Yes | 4 | 3 | 3 | 2 | 4 | Inv. |
| | 1122 | M | Yes | 4 | 3 | 3 | — | — | Inv. |
| | 1123 | Y | Yes | 4 | 3 | 3 | 2 | 4 | Inv. |
| N | 1131 | C | Yes | 4 | 3 | 3 | 2 | 4 | Inv. |
| | 1132 | M | Yes | 4 | 3 | 3 | — | — | Inv. |
| | 1133 | Y | Yes | 4 | 3 | 3 | 2 | 4 | Inv. |
| O | 1141 | C | Yes | 4 | 3 | 3 | 2 | 4 | Inv. |
| | 1142 | M | Yes | 4 | 3 | 3 | — | — | Inv. |
| | 1143 | Y | Yes | 4 | 3 | 3 | 2 | 4 | Inv. |
| P | 1151 | C | Yes | 4 | 3 | 3 | 2 | 4 | Inv. |
| | 1152 | M | Yes | 4 | 3 | 3 | — | — | Inv. |
| | 1153 | Y | Yes | 4 | 3 | 3 | 2 | 4 | Inv. |
| Q | 1161 | C | Yes | 4 | 3 | 3 | 2 | 4 | Inv. |
| | 1162 | M | Yes | 4 | 3 | 3 | — | — | Inv. |
| | 1163 | Y | Yes | 4 | 3 | 3 | 2 | 4 | Inv. |

* 1: Infrared rays applied,
* 2: Resistance to image bleeding
* 3: Glossiness of solid image portion
Comp.: Comparative example,
Inv.: Present invention

As is clear from Table 3, the ink sets of the present invention ensure a substantial improvement of a big variation in the curability and degree of adhesion of the substrate for each ink color, and provides compatibility between the color reproducibility and excellent ink curability and a high degree of adhesiveness to the substrate, whereby a bleeding-free and high-definition image characterized by superb glossiness of both the yellow and cyan solid images can be produced.

### Example 2

An ink set and an image sample were prepared according to the same procedure as that of the Example 1, except that an image was recorded using the substrate shown in Table 4 instead of the substrate PET for recording in Example 1, and the same test was conducted. Table 4 shows the results.

TABLE 4

| | | | | | Evaluation result | | | | | |
|---|---|---|---|---|---|---|---|---|---|---|
| | | | | | | | | | Glossiness | |
| Ink | | | | | Ink | Adhesion | Resistance | Color | of solid | |
| set | Ink | Ink | | sub- | cur- | of | to image | repro- | image | Re- |
| No. | No. | color | * 1 | strate | ability | substrate | bleeding | ducibility | portion | marks |
| D | 1031 | C | Yes | * 2 | 4 | 3 | 3 | 2 | 3 | Comp. |
| | 1032 | M | Yes | * 2 | 4 | 3 | 3 | — | — | Comp. |
| | 1033 | Y | Yes | * 2 | 4 | 3 | 3 | 1 | 1 | Comp. |
| D | 1031 | C | Yes | Glass | 4 | 3 | 3 | 2 | 3 | Comp. |
| | 1032 | M | Yes | Glass | 4 | 3 | 3 | — | — | Comp. |
| | 1033 | Y | Yes | Glass | 4 | 3 | 3 | 1 | 1 | Comp. |
| D | 1031 | C | Yes | * 3 | 4 | 3 | 3 | 2 | 3 | Comp. |
| | 1032 | M | Yes | * 3 | 4 | 3 | 3 | — | — | Comp. |
| | 1033 | Y | Yes | * 3 | 4 | 3 | 3 | 1 | 1 | Comp. |
| F | 1051 | C | Yes | * 2 | 4 | 3 | 3 | 1 | 1 | Comp. |
| | 1052 | M | Yes | * 2 | 4 | 3 | 3 | — | — | Comp. |
| | 1053 | Y | Yes | * 2 | 4 | 3 | 3 | 2 | 3 | Comp. |
| F | 1051 | C | Yes | Glass | 4 | 3 | 3 | 1 | 1 | Comp. |
| | 1052 | M | Yes | Glass | 4 | 3 | 3 | — | — | Comp. |
| | 1053 | Y | Yes | Glass | 4 | 3 | 3 | 2 | 3 | Comp. |
| F | 1051 | C | Yes | * 3 | 4 | 3 | 3 | 1 | 1 | Comp. |
| | 1052 | M | Yes | * 3 | 4 | 3 | 3 | — | — | Comp. |
| | 1053 | Y | Yes | * 3 | 4 | 3 | 3 | 2 | 3 | Comp. |
| H | 1071 | C | Yes | * 2 | 4 | 3 | 3 | 2 | 4 | Inv. |
| | 1072 | M | Yes | * 2 | 4 | 3 | 3 | — | — | Inv. |
| | 1073 | Y | Yes | * 2 | 4 | 3 | 3 | 2 | 4 | Inv. |
| H | 1071 | C | Yes | Glass | 4 | 3 | 3 | 2 | 4 | Inv. |
| | 1072 | M | Yes | Glass | 4 | 3 | 3 | — | — | Inv. |
| | 1073 | Y | Yes | Glass | 4 | 3 | 3 | 2 | 4 | Inv. |
| H | 1071 | C | Yes | * 3 | 4 | 3 | 3 | 2 | 4 | Inv. |
| | 1072 | M | Yes | * 3 | 4 | 3 | 3 | — | — | Inv. |
| | 1073 | Y | Yes | * 3 | 4 | 3 | 3 | 2 | 4 | Inv. |
| J | 1091 | C | Yes | * 2 | 4 | 3 | 3 | 2 | 4 | Inv. |
| | 1092 | M | Yes | * 2 | 4 | 3 | 3 | — | — | Inv. |
| | 1093 | Y | Yes | * 2 | 4 | 3 | 3 | 2 | 4 | Inv. |
| J | 1091 | C | Yes | Glass | 4 | 3 | 3 | 2 | 4 | Inv. |
| | 1092 | M | Yes | Glass | 4 | 3 | 3 | — | — | Inv. |
| | 1093 | Y | Yes | Glass | 4 | 3 | 3 | 2 | 4 | Inv. |
| J | 1091 | C | Yes | * 3 | 4 | 3 | 3 | 2 | 4 | Inv. |
| | 1092 | M | Yes | * 3 | 4 | 3 | 3 | | | Inv. |
| | 1093 | Y | Yes | * 3 | 4 | 3 | 3 | 2 | 4 | Inv. |
| K | 1101 | C | Yes | * 2 | 4 | 3 | 3 | 2 | 4 | Inv. |
| | 1102 | M | Yes | * 2 | 4 | 3 | 3 | — | — | Inv. |
| | 1103 | Y | Yes | * 2 | 4 | 3 | 3 | 2 | 4 | Inv. |
| K | 1101 | C | Yes | Glass | 4 | 3 | 3 | 2 | 4 | Inv. |
| | 1102 | M | Yes | Glass | 4 | 3 | 3 | — | — | Inv. |
| | 1103 | Y | Yes | Glass | 4 | 3 | 3 | 2 | 4 | Inv. |
| K | 1101 | C | Yes | * 3 | 4 | 3 | 3 | 2 | 4 | Inv. |
| | 1102 | M | Yes | * 3 | 4 | 3 | 3 | — | — | Inv. |
| | 1103 | Y | Yes | * 3 | 4 | 3 | 3 | 2 | 4 | Inv. |

* 1: Infrared rays applied,
* 2: Plain paper,
* 3: Aluminum plate
Comp.: Comparative example,
Inv.: Present invention

As is clear from Table 4, the ink sets of the present invention provide excellent ink curability and excellent degree of adhesiveness to the substrate, whereby a bleeding-free and high-definition image characterized by superb glossiness of both the yellow and cyan solid images can be produced, even when various forms of substrates are used.

### INDUSTRIAL APPLICABILITY

The present invention provides an ink set for ink-jet recording, a method for polymerizing the ink set for ink-jet recording and an image forming method using the ink set for ink-jet recording, wherein high-dimensional compatibility between the color reproducibility of each ink composition for ink-jet recording and ink curability are ensured to provide an excellent bleeding-free and high-definition image characterized by a high degree of adhesiveness to the substrate and superb glossiness of the solid image.

1. An ink set for ink-jet recording comprising a yellow ink composition for ink-jet recording containing one or more types of yellow color materials, a magenta ink composition for ink-jet recording containing one or more types of magenta color materials, and a cyan ink composition for ink-jet recording containing one or more types of cyan color materials,
wherein each ink composition contains one or more of a), b) and c), and further, the infrared absorbing agent contained in the yellow ink composition for ink-jet recording differs from the infrared absorbing agent contained in the cyan ink composition for ink-jet recording:
a) a compound having one or more polymerizable groups,
b) an infrared absorbing agent, and
c) a polymerization initiator.

2. The ink set for ink-jet recording described in claim 1, wherein the compound having one or more polymerizable groups exhibits cation-polymerizing capability.

3. The ink set for ink-jet recording described in claim 1,
wherein the polymerization initiator is a polymerization initiator to generate active species by irradiation of active rays.

4. The ink set for ink-jet recording described in claim 1,
wherein viscosity at 30° C. of each ink composition for ink-jet recording is within the range of 10-500 mPa·s.

5. The ink set for ink-jet recording described in claim 1,
wherein the infrared absorbing agent has an maximum absorption wavelength in 760-1,500 nm.

6. The ink set for ink-jet recording described in claim 1,
wherein the infrared absorbing agent contained in the yellow ink composition for ink-jet recording is the infrared absorbing agent which has at most an absorbance of 0.15 in 630-690 nm assuming that an absorbance of this infrared absorbing agent at a maximum absorption wavelength in the ink is 1, and the infrared absorbing agent contained in the cyan ink composition for ink-jet recording is an infrared absorbing agent which has at most an absorbance of 0.15 in 410-460 nm assuming that an absorbance of this infrared absorbing agent at a maximum absorption wavelength in the ink is 1.

7. An image forming method comprising the steps of: (a) ejecting the ink compositions for ink-jet recording of the ink set for ink-jet recording described in claim 1 on a recording medium using a recording head having one or more nozzles, each capable of controlling ejection of the ink droplets on a selective basis, and
(b) curing the deposited ink by irradiation of infrared and ultraviolet rays after the ink droplets landed on the recording medium.

8. The image forming method described in claim 7,
wherein the inks are cured by simultaneous irradiation of infrared and ultraviolet rays.
